(19) United States
(12) Patent Application Publication
(10) Pub. No.: US 2020/0269315 A1
(43) Pub. Date: Aug. 27, 2020

(54) METAL-CONTAINING PARTICLE, CONNECTION MATERIAL, CONNECTION STRUCTURE, METHOD FOR MANUFACTURING CONNECTION STRUCTURE, CONDUCTION INSPECTION MEMBER, AND CONDUCTION INSPECTION DEVICE

(71) Applicant: SEKISUI CHEMICAL CO., LTD., Osaka-city, Osaka (JP)

(72) Inventors: Yuto DOBASHI, Kouka-city (JP); Masao SASADAIRA, Kouka-city (JP)

(73) Assignee: SEKISUI CHEMICAL CO., LTD., Osaka-city, Osaka (JP)

(21) Appl. No.: 16/648,762

(22) PCT Filed: Sep. 20, 2018
(86) PCT No.: PCT/JP2018/034768

§ 371 Date: Mar. 19, 2020

(30) Foreign Application Priority Data
Sep. 20, 2017 (JP) 2017-180095

(51) Int. Cl. B22F 1/02; H01B 1/22; H01R 11/01

(52) U.S. Cl. CPC B22F 1/02; H01R 11/01; H01B 1/22

(57) ABSTRACT

Provided is a metal-containing particle which can be bonded to another particle or another member by melting a tip of a protrusion in the metal-containing particle at a relatively low temperature and solidifying the melt after melting, enhance connection reliability, suppress an ion migration phenomenon, and enhance insulation reliability. The metal-containing particle according to the present invention is a metal-containing particle, an outer surface of which has a plurality of protrusions, in which the metal-containing particle includes a base particle, a metal section which is disposed on a surface of the base particle, an outer surface of the metal section having a plurality of protrusions, and a metal film covering the outer surface of the metal section, and a tip of the protrusion in the metal-containing particle is meltable at 400° C. or less.

### TECHNICAL FIELD

The present invention relates to a metal-containing particle which includes a base particle and a metal section and in which an outer surface of the metal section has protrusions. The present invention also relates to a connection material, a connection structure, a method for manufacturing the connection structure, a conduction inspection member, and a conduction inspection device in which the metal-containing particle is used.

In electronic parts and the like, connection materials containing metal particles are used to form a connection section connecting two connection target members to each other in some cases.

It is known that the ratio of surface area to volume of particle sharply increases and the melting point or sintering temperature greatly drops as compared with that in a bulk state when the particle diameter of metal particle decreases to a size of 100 nm or less and the number of constituent atoms decreases. A method is known in which this low-temperature sintering function is utilized, metal particles having a particle diameter of 100 nm or less are used as a connection material, and the metal particles are sintered by heating to perform connection. In this connection method, the metal particles after connection are converted to bulk metal and connection by metallic bonding is attained at the connection interface at the same time, and thus heat resistance, connection reliability, and heat dissipation significantly increase.

A connection material for performing such connection is disclosed, for example, in Patent Document 1 below.

The connection material described in Patent Document contains nano-sized composite silver particles, nano-sized silver particles, and a resin. The composite silver particles are particles in which an organic covering layer is formed around a silver core which is an aggregate of silver atoms. The organic covering layer is formed of one or more alcohol components of an alcohol molecule residue having 10 or 12 carbon atoms, an alcohol molecule derivative (here, the alcohol molecule derivative is limited to carboxylic acid and/or aldehyde), and/or an alcohol molecule.

In addition, Patent Document 2 below discloses a connection material containing nano-sized metal-containing particles and conductive particles.

In addition, anisotropic conductive materials such as an anisotropic conductive paste and an anisotropic conductive film are widely known. In these anisotropic conductive materials, conductive particles are dispersed in a binder resin.

The anisotropic conductive material is used to obtain various connection structures. Examples of the connection structures include connection (FOG (Film on Glass)) between a flexible printed substrate and a glass substrate, connection (COF (Chip on Film)) between a semiconductor chip and a flexible printed substrate, connection (COG (Chip on Glass)) between a semiconductor chip and a glass substrate, and connection (FOB (Film on Board)) between a flexible printed substrate and a glass epoxy substrate.

As an example of the conductive particles, Patent Document 3 below discloses conductive particles having a ternary alloy film of tin, silver, and copper. Patent Document 3 describes that the connection resistance is low, the current capacity at the time of connection is great, and migration is prevented.

Patent Document 4 below discloses conductive particles having protrusions composed of a particle linked body in which a plurality of metal or alloy particles are linked in a row.

### RELATED ART DOCUMENT

### Patent Documents

Patent Document 1: JP 5256281 B1

Patent Document 2: JP 2013-55046 A

Patent Document 3: WO 2006/080289 A1

Patent Document 4: JP 2012-113850 A

### SUMMARY OF THE INVENTION

### Problems to be Solved by the Invention

Metal particles such as nano-sized silver particles are melt-bonded by a heat treatment at the time of connection to form a bulk. When a bulk is formed, the melting point increases, and there is a problem that the heating temperature increases. In addition, gaps are generated between the nano-sized particles in the formed bulk. As a result, connection reliability decreases.

In addition, miniaturization and high density wiring of electronic devices are in progress. For this reason, metals such as silver (Ag), lead (Pb), copper (Cu), tin (Sn), and zinc (An) sometimes causes ion migration phenomenon that ionized metals migrate between electrodes and a short circuit occurs when a voltage is applied under severe environmental conditions in which the moisture content (humidity) is high, and the insulation reliability sometimes deteriorates.

In addition, in recent years, when a connection structure is obtained using an anisotropic conductive material, connection at a lower pressure than in the prior art, namely, so-called low-pressure mounting is performed in the step of connecting electrodes. For example, when the semiconductor chip for driving is directly mounted on a supple flexible printed substrate, it is required to perform mounting at a low pressure in order to suppress deformation of the flexible printed substrate.

However, in low-pressure mounting, sufficient conduction properties are not sometimes attained because of insufficient physical contact between the conductive particles and the electrode. In addition, after mounting, desired conduction properties are not sometimes attained under environmental conditions of high temperature and high humidity because of contraction of the binder resin in the anisotropic conductive material.

An object of the present invention is to provide a metal-containing particle which can be bonded to another particle or another member by melting tips of protrusions in the metal-containing particle at a relatively low temperature and solidifying the melt after melting, enhance connection reliability, suppress an ion migration phenomenon, and enhance insulation reliability. In addition, an object of the present invention is to provide a metal-containing particle which can be bonded to another particle or another member by metal-diffusing or melt-deforming a component of the protrusions of a metal section in the metal-containing particle at a relatively low temperature, and enhance insulation reliability. In addition, an object of the present invention is to provide a connection material, a connection structure, a method for manufacturing the connection structure, a conduction inspection member, and a conduction inspection device in which the metal-containing particle is used.

### Means for Solving the Problems

According to a broad aspect of the present invention, there is provided a metal-containing particle, an outer surface of which has a plurality of protrusions, in which the metal-containing particle includes a base particle, a metal section which is disposed on a surface of the base particle, an outer surface of the metal section having a plurality of protrusions, and a metal film covering the outer surface of the metal section, and each of the protrusions in the metal-containing particle has a tip meltable at 400° C. or less.

In a specific aspect of the metal-containing particle according to the present invention, the metal film covers the tips of the protrusions of the metal section.

In a specific aspect of the metal-containing particle according to the present invention, a portion covering the tips of the protrusions of the metal section in the metal film is meltable at 400° C. or less.

In a specific aspect of the metal-containing particle according to the present invention, a thickness of the metal film is 0.1 nm or more and 50 nm or less.

In a specific aspect of the metal-containing particle according to the present invention, a material of the metal film contains gold, palladium, platinum, rhodium, ruthenium, or iridium.

In a specific aspect of the metal-containing particle according to the present invention, the outer surface of the metal-containing particle has a plurality of convexes, and an outer surface of the convexes of the metal-containing particle has the protrusions.

In a specific aspect of the metal-containing particle according to the present invention, a ratio of an average height of the convexes to an average height of the protrusions in the metal-containing particle is 5 or more and 1,000 or less.

In a specific aspect of the metal-containing particle according to the present invention, an average diameter of bases of the convexes is 3 nm or more and 5,000 nm or less.

In a specific aspect of the metal-containing particle according to the present invention, a proportion of a surface area of a portion having the convexes is 10% or more in 100% of a surface area of the outer surface of the metal-containing particle.

In a specific aspect of the metal-containing particle according to the present invention, a shape of each of the convexes is a needle shape or a shape of a part of a sphere.

In a specific aspect of the metal-containing particle according to the present invention, a material of the plurality of protrusions in the metal-containing particle contains silver, copper, gold, palladium, tin, indium, or zinc.

In a specific aspect of the metal-containing particle according to the present invention, a material of the metal section is not solder.

According to a broad aspect of the present invention, there is provided a metal-containing particle including a base particle and a metal section disposed on a surface of the base particle, in which an outer surface of the metal section has a plurality of protrusions, the plurality of protrusions of the metal section contain a component capable of metal-diffusing at 400° C. or less or is melt-deformable at 400° C. or less, and a melting point of a portion not having the protrusions in the metal section is more than 400° C.

In a specific aspect of the metal-containing particle according to the present invention, the protrusions of the metal section contain a component capable of metal-diffusing at 400° C. or less.

In a specific aspect of the metal-containing particle according to the present invention, the protrusions of the metal section are melt-deformable at 400° C. or less.

In a specific aspect of the metal-containing particle according to the present invention, the protrusions of the metal section contain solder.

In a specific aspect of the metal-containing particle according to the present invention, a content of solder in the protrusions of the metal section is 50% by weight or more.

In a specific aspect of the metal-containing particle according to the present invention, a portion not having the protrusions in the metal section does not contain solder or contains solder at 40% by weight or less.

In a specific aspect of the metal-containing particle according to the present invention, a surface area of a portion having the protrusions is 10% or more in 100% of an entire surface area of an outer surface of the metal section.

In a specific aspect of the metal-containing particle according to the present invention, an average of vertical angles of the protrusions in the metal-containing particle is 10° or more and 60° or less.

In a specific aspect of the metal-containing particle according to the present invention, an average height of the protrusions in the metal-containing particle is 3 nm or more and 5,000 nm or less.

In a specific aspect of the metal-containing particle according to the present invention, an average diameter of bases of the protrusions in the metal-containing particle is 3 nm or more and 1,000 nm or less.

In a specific aspect of the metal-containing particle according to the present invention, a ratio of an average height of the protrusions in the metal-containing particle to an average diameter of bases of the protrusions in the metal-containing particle is 0.5 or more and 10 or less.

In a specific aspect of the metal-containing particle according to the present invention, a shape of each of the protrusions in the metal-containing particle is a needle shape or a shape of a part of a sphere.

In a specific aspect of the metal-containing particle according to the present invention, a material of the metal section contains silver, copper, gold, palladium, tin, indium, zinc, nickel, cobalt, iron, tungsten, molybdenum, ruthenium, platinum, rhodium, iridium, phosphorus, or boron.

In a specific aspect of the metal-containing particle according to the present invention, a compressive elastic modulus is 100 N/mm² or more and 25,000 N/mm² or less when the metal-containing particle is compressed by 10%.

According to a broad aspect of the present invention, there is provided a connection material containing the metal-containing particle described above and a resin.

According to a broad aspect of the present invention, there is provided a connection structure including a first connection target member, a second connection target member, and a connection section connecting the first connection target member and the second connection target member to each other,

a material of the connection section being the metal-containing particle described above or a connection material containing the metal-containing particle and a resin.

According to a broad aspect of the present invention, there is provided a method for manufacturing a connection structure, which includes a step of disposing the metal-containing particle described above or a connection material containing the metal-containing particle and a resin between a first connection target member and a second connection target member and a step of heating the metal-containing particle to melt tips of the protrusions of the metal section, solidifying the melt after melting, and forming a connection section connecting the first connection target member and the second connection target member to each other through the metal-containing particle or the connection material or a step of heating the metal-containing particle to metal-diffuse or melt-deform a component of the protrusions of the metal section and forming a connection section connecting the first connection target member and the second connection target member to each other through the metal-containing particle or the connection material.

According to a broad aspect of the present invention, there is provided a conduction inspection member including a base body having a through hole and a conductive section, in which a plurality of the through holes is disposed in the base body, the conductive section is disposed in the through holes, and a material of the conductive section contains the metal-containing particle described above.

According to a broad aspect of the present invention, there is provided a conduction inspection device including an ammeter and the conduction inspection member described above.

### Effect of the Invention

The metal-containing particle according to the present invention is a metal-containing particle, an outer surface of which has a plurality of protrusions. The metal-containing particle according to the present invention includes a base particle, a metal section which is disposed on a surface of the base particle, an outer surface of the metal section having a plurality of protrusions, and a metal film covering the outer surface of the metal section. In the metal-containing particle according to the present invention, each of the protrusions in the metal-containing particle has a tip meltable at 400° C. or less. The metal-containing particle according to the present invention is equipped with the above configuration and thus can be bonded to another particle or another member by melting the tips of the protrusions in the metal-containing particle at a relatively low temperature and solidifying the melt after melting, enhance the connection reliability, suppress the ion migration phenomenon, and enhance the insulation reliability.

The metal-containing particle according to the present invention includes a base particle and a metal section disposed on a surface of the base particle. In the metal-containing particle according to the present invention, the outer surface of the metal section has a plurality of protrusions. In the metal-containing particle according to the present invention, the protrusions of the metal section contain a component capable of metal-diffusing at 400° C. or less or is melt-deformable at 400° C. or less. In the metal-containing particle according to the present invention, the melting point of the portion not having the protrusions in the metal section is more than 400° C. The metal-containing particle according to the present invention is equipped with the above configuration and thus can be bonded to another particle or another member by metal-diffusing or melt-deforming a component of the protrusions of the metal section in the metal-containing particle at a relatively low temperature, and enhance the insulation reliability.

### BRIEF DESCRIPTION OF DRAWINGS

FIG. 1 is a cross-sectional view schematically illustrating a metal-containing particle according to a first embodiment of the present invention.

FIG. 2 is a cross-sectional view schematically illustrating a metal-containing particle according to a second embodiment of the present invention.

FIG. 3 is a cross-sectional view schematically illustrating a metal-containing particle according to a third embodiment of the present invention.

FIG. 4 is a cross-sectional view schematically illustrating a metal-containing particle according to a fourth embodiment of the present invention.

FIG. 5 is a cross-sectional view schematically illustrating a metal-containing particle according to a fifth embodiment of the present invention.

FIG. 6 is a cross-sectional view schematically illustrating a metal-containing particle according to a sixth embodiment of the present invention.

FIG. 7 is a cross-sectional view schematically illustrating a metal-containing particle according to a seventh embodiment of the present invention.

FIG. 8 is a cross-sectional view schematically illustrating a metal-containing particle according to an eighth embodiment of the present invention.

FIG. 9 is a cross-sectional view schematically illustrating a metal-containing particle according to a ninth embodiment of the present invention.

FIG. 10 is a cross-sectional view schematically illustrating a metal-containing particle according to a tenth embodiment of the present invention.

FIG. 11 is a cross-sectional view schematically illustrating a metal-containing particle according to an eleventh embodiment of the present invention.

FIG. 12 is a cross-sectional view schematically illustrating a metal-containing particle according to a twelfth embodiment of the present invention.

FIG. 13 is a cross-sectional view schematically illustrating a metal-containing particle according to a thirteenth embodiment of the present invention.

FIG. 14 is a cross-sectional view schematically illustrating a metal-containing particle according to a fourteenth embodiment of the present invention.

FIG. 15 is a cross-sectional view schematically illustrating a connection structure in which a metal-containing particle according to a first embodiment of the present invention is used.

FIG. 16 is a cross-sectional view schematically illustrating a modification of a connection structure in which a metal-containing particle according to a first embodiment of the present invention is used.

FIG. 17 is a view illustrating an image of a metal-containing particle before being subjected to the formation of a metal film.

FIG. 18 is a view illustrating an image of a metal-containing particle before being subjected to the formation of a metal film.

FIG. 19 is a view illustrating an image of a metal-containing particle before being subjected to the formation of a metal film.

FIG. 20 is a view illustrating an image of a metal-containing particle before being subjected to the formation of a metal film.

FIG. 21 is a view for explaining a protrusion portion of a metal section.

FIG. 22 is a view for explaining a portion having protrusions of a metal section.

FIG. 23 is a view for explaining a portion not having protrusions of a metal section.

FIGS. 24(a) and 24(b) are a plan view and a cross-sectional view which illustrate an example of a conduction inspection member.

FIGS. 25(a) to 25(c) are views schematically illustrating a situation in which the electrical properties of an electronic circuit device are inspected using a conduction inspection device.

### MODE(S) FOR CARRYING OUT THE INVENTION

Hereinafter, the present invention will be described in detail.

### (Metal-Containing Particle)

The metal-containing particle according to the present invention is a metal-containing particle, an outer surface of which has a plurality of protrusions. The metal-containing particle according to the present invention includes a base particle, a metal section, and a metal film. In the metal-containing particle according to the present invention, the metal section is disposed on a surface of the base particle and an outer surface of the metal section has a plurality of protrusions. In the metal-containing particle according to the present invention, the metal film covers the outer surface of the metal section. In the metal-containing particle according to the present invention, each of the protrusions in the metal-containing particle has a tip meltable at 400° C. or less.

In the present invention, the tip of the protrusion in the metal-containing particle is meltable at a relatively low temperature since the metal-containing particle is equipped with the above configuration. For this reason, the metal-containing particles can be bonded to another particle or another member by melting the tip of the protrusions in the metal-containing particle at a relatively low temperature and solidifying the melt after melting. In addition, a plurality of metal-containing particles can be melt-bonded. Moreover, the metal-containing particle can be melt-bonded to a connection target member. Furthermore, the metal-containing particle can be melt-bonded to an electrode. In addition, in the present invention, it is possible to suppress the ion migration phenomenon and to improve the insulation reliability since the metal-containing particle is equipped with the above configuration.

It is known that the ratio of surface area to volume of particle sharply increases and the melting point or sintering temperature greatly drops as compared with that in a bulk state when the particle diameter of metal particle decreases to a size of 100 nm or less and the number of constituent atoms decreases. The present inventors have found out that the melting temperature of the tip of the protrusion in the metal-containing particle can be lowered by decreasing a diameter of the tip of the protrusion in the metal-containing particle in the same manner as a case of using a nano-sized metal particle.

The protrusions in the metal-containing particle are preferably formed of a metal and are preferably metal protrusions. In this case, the tip of the protrusion formed of a metal and the tip of the metal protrusion is meltable at 400° C. or less. In order to lower the melting temperature of the tip of the protrusion in the metal-containing particle, the shape of the protrusion section may be tapered in a needle shape. In order to lower the melting temperature of the tip of the protrusion in the metal-containing particle, the outer surface of the metal-containing particle may have a plurality of small protrusions. In the metal-containing particle according to the present invention, in order to lower the melting temperature of the tip of the plurality of protrusions in the metal-containing particle, it is preferable that an outer surface of the metal-containing particle has a plurality of convexes (first protrusions) and an outer surface of the plurality of convexes has a plurality of protrusions (second protrusions). It is preferable that the convexes are larger than the protrusions in the metal-containing particle. The connection reliability is still further enhanced by the presence of the convexes, which are larger than the protrusions, in addition to the protrusions in the metal-containing particle. The convexes and the protrusions may be integrated, or the protrusions may be attached onto each of the convexes. Each of the protrusions in the metal-containing particle may be composed of a particle. In the present specification, when the convexes and the protrusions coexist, the outer surface of a protruding portion having the protrusions on the outer surface thereof is called a convex in distinction from the protrusions in the metal-containing particle. Tips of the convexes may not be meltable at 400° C. or less. The convexes in the metal-containing particle are preferably formed of a metal and are preferably metal convexes.

The melting temperature can be lowered by decreasing the diameter of the tip of the protrusion in this manner. In addition, the material of the metal section can be selected in order to lower the melting temperature. It is preferable to select the shape of the protrusions and the material of the metal section in order to set the melting temperature of the tip of the protrusion in the metal-containing particle to 400° C. or less.

The melting temperature of the tip of the protrusion in the metal-containing particle is evaluated as follows.

The melting temperature of the tip of the protrusion in the metal-containing particle can be measured using a differential scanning calorimeter (“DSC-6300” manufactured by Yamato Scientific Co., Ltd.). The measurement is performed using 15 g of metal-containing particles under measurement conditions of a range of temperature rise of 30° C. to 500° C., a rate of temperature rise of 5° C./min, and a nitrogen purge rate of 5 ml/min.

Next, it is confirmed that the tip of the protrusion in the metal-containing particle is melted at the melting temperature attained by the measurement. The metal-containing particle is placed in a container by 1 g and the container is placed in an electric furnace. The temperature in the electric furnace is set to the same temperature as the melting temperature attained by the measurement, and heating is performed for 10 minutes in a nitrogen atmosphere. Thereafter, the heated metal-containing particle is taken out from the electric furnace, and the melted state (or the solidified state after melting) of the tip of the protrusion is confirmed using a scanning electron microscope.

It is preferable that the shape of the protrusions in the metal-containing particle is a tapered needle shape from the viewpoint of effectively lowering the melting temperature of the tip of the protrusion and effectively enhancing the connection reliability. In this metal-containing particle, a new effect is exerted when the shape of the protrusions that the outer surface of the metal-containing particle has is different from the conventional shape and is a tapered needle shape.

The metal-containing particle according to the present invention can be used for the connection of two connection target members since the tip of the protrusion in the metal-containing particle can be melt-bonded at a relatively low temperature. By melt-bonding two connection target members to each other at the tip of the protrusion in the metal-containing particle, it is possible to form a connection section exerting firm connection and to enhance the connection reliability.

The metal-containing particle according to the present invention may also be used for conductive connection. Furthermore, the metal-containing particle according to the present invention can also be used as a gap control material (spacer).

The metal-containing particle according to the present invention includes a metal film which covers the outer surface of the metal section. As the metal-containing particle includes the metal film, the ion migration phenomenon can be suppressed and the insulation reliability can be enhanced when the metal-containing particle is used for conductive connection. Moreover, as the metal-containing particle includes the metal film, oxidation or sulfurization of the metal section can be effectively suppressed. As a result, the connection reliability can be effectively enhanced.

The metal film may cover at least a part of the outer surface of the metal section but may not cover the entire outer surface. It is preferable that the metal film covers the tips of the protrusions of the metal section from the viewpoint of suppressing the ion migration phenomenon and enhancing the insulation reliability and from the viewpoint of still further effectively enhancing the connection reliability. As the metal film covers the tips of the protrusions of the metal section, the ion migration phenomenon can be still further suppressed and the insulation reliability can be still further enhanced. Moreover, oxidation or sulfurization of the tip of the protrusion can be effectively suppressed and the melting temperature of the tip of the protrusion can be effectively lowered.

It is preferable that the portion covering the tips of the protrusions of the metal section of the metal film is meltable at 400° C. or less from the viewpoint of suppressing the ion migration phenomenon and enhancing the insulation reliability and from the viewpoint of still further effectively enhancing the connection reliability. It is preferable to appropriately select the thickness of the metal film, the material of the metal film, and the like in order to set the melting temperature of the portion covering the tips of the protrusions of the metal section of the metal film to 400° C. or less. It is preferable that the metal film and the tip of the protrusion of the metal section are alloyed when the tip of the protrusion of the metal section is melted at 400° C. or less.

The melting temperature of the portion covering the tips of the protrusions of the metal section of the metal film can be measured in the same manner as the melting temperature of the tip of the protrusion in the metal-containing particle.

The metal-containing particle according to the present invention includes a base particle and a metal section. The metal section is disposed on the surface of the base particle. In the metal-containing particle according to the present invention, the outer surface of the metal section has a plurality of protrusions. In the metal-containing particle according to the present invention, each of the plurality of protrusions of the metal section contains a component capable of metal-diffusing at 400° C. or less or is melt-deformable at 400° C. or less. In the metal-containing particle according to the present invention, the protrusions of the metal section may contain a component capable of metal-diffusing at 400° C. or less or may be melt-deformable at 400° C. or less. In the metal-containing particle according to the present invention, the protrusions of the metal section may contain a component capable of metal-diffusing at 400° C. or less and be melt-deformable at 400° C. or less. In the metal-containing particle according to the present invention, the melting point of the portion not having the protrusions in the metal section is more than 400° C.

Incidentally, metal diffusion in the present invention refers to that a metal atom diffuses in a metal section or a bonding section by heat, pressure, deformation and the like.

Incidentally, melt-deformation in the present invention refers to a state in which a part or the whole of the components is melted and easily deformed by external pressure.

In the present invention, the component contained in the protrusions can metal-diffuse or be melt-deformed at a relatively low temperature and form a metallic bond with the bonding section since the metal-containing particle is equipped with the above configuration. Thus, the metal-containing particle can be solidified after being melted and thus bonded to another particle or another member. In addition, a plurality of metal-containing particles can be melt-bonded. Moreover, the metal-containing particle can be melt-bonded to a connection target member. Furthermore, the metal-containing particle can be melt-bonded to an electrode. Particularly when the metal-containing particle is bonded to an electrode, a metallic bond can be formed between the electrode and the conductive particle and thus conduction properties dramatically superior to those by the conventional physical contact can be attained.

In addition, in the present invention, as heating is performed to a temperature equal to or more than the temperature at which the metal diffusion or melt-deformation of the protrusions of the metal section is possible, and equal to or less than the melting point of the portion not having the protrusions in the metal section, excessive melt-deformation of the portion not having the protrusions in the metal section can be prevented and the thickness of the portion not having the protrusions in the metal section can be secured, and the connection reliability can be thus enhanced since the metal-containing particle is equipped with the above configuration.

The temperature at which the component of the protrusion of the metal section can diffuse and the melt-deformation temperature of the protrusions of the metal section can be achieved by selecting the material of the protrusion. For example, by containing solder in the protrusions or using a solder alloy, it is easy to set the temperature at which the component of the protrusions of the metal section can diffuse and the melt-deformation temperature of the protrusions of the metal section to 400° C. or less.

In order to effectively lower the melt-deformation temperature of the protrusions of the metal section, the metal section may have a portion having a melting point of 400° C. or less at the tip of the protrusion, a portion having a melting point of 400° C. or less on the surface of the protrusions, or a portion having a melting point of 400° C. or less inside the protrusions.

From the viewpoint of maintaining the protruding shape at the time of conductive connection and effectively enhancing the connection reliability, it is preferable that the metal section has a portion having a melting point of 400° C. or less inside the protrusions and the melting point of the material of the outer surface of the protrusions may be more than 400° C. When the metal section has a portion having a melting point of 400° C. or less inside the protrusions, it is preferable that a portion having a melting point of more than 400° C. is present outside the portion having a melting point of 400° C. or less and the thickness of the portion having a melting point of more than 400° C. is 200 nm or less (preferably 100 nm or less).

It is preferable that the protrusions of the metal section contain solder from the viewpoint of still further enhancing the melt-bonding property due to the protrusions and effectively enhancing the connection reliability.

It is preferable that the content of solder in the protrusions of the metal section is 50% by weight or more from the viewpoint of still further enhancing the melt-bonding property due to the protrusions and effectively enhancing the connection reliability.

It is preferable that the portion not having the protrusions in the metal section does not contain solder or contains solder at 40% by weight or less (preferably 10% by weight or less) from the viewpoint of still further enhancing the melt-bonding property due to the protrusions and effectively enhancing the connection reliability. It is more preferable as the content of solder in the portion not having the protrusions in the metal section is lower.

It is preferable that the inner portion (the portion excluding the protrusions of the portion having the protrusions) of the raised portion of the metal section does not contain solder or contains solder at 40% by weight or less (preferably 10% by weight or less) from the viewpoint of still further enhancing the melt-bonding property due to the protrusions and effectively enhancing the connection reliability. It is more preferable as the content of solder in the portion not having the protrusions in the metal section is lower.

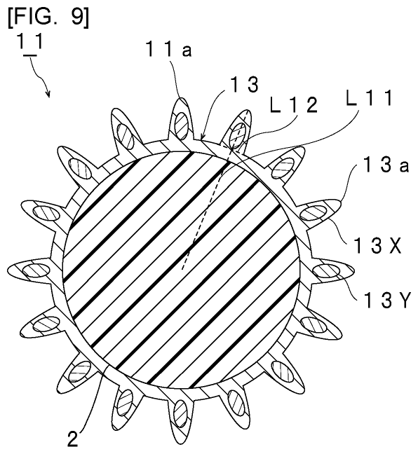

Incidentally, the protrusions in the present specification mean a raised portion of the metal section (hatched portion in FIG. 21 corresponding to FIG. 9).

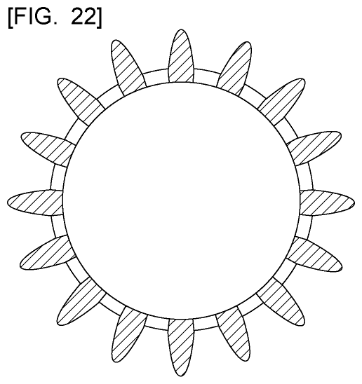

In the present specification, the portion having protrusions means a raised portion of the metal section and the inner portion of the raised portion of the metal section (hatched portion in FIG. 22 corresponding to FIG. 9). The straight line joining the boundary point between the raised portion of the metal section and the non-raised portion of the metal section with the center of the conductive particle is the boundary line between the portion having the protrusions and the portion not having the protrusions.

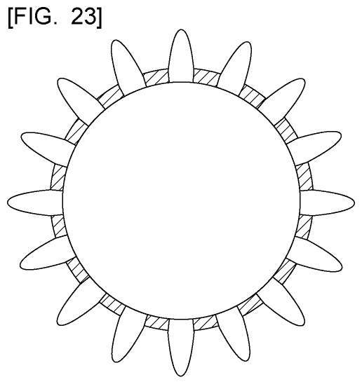

In the present specification, the portion not having protrusions is the portion excluding the portion not having protrusions of the metal section (hatched portion in FIG. 23 corresponding to FIG. 9). The straight line joining the boundary point between the raised portion of the metal section and the non-raised portion of the metal section with the center of the conductive particle is the boundary line between the portion having the protrusions and the portion not having the protrusions.

It is preferable that 5% by volume or more of the protrusions is meltable, it is more preferable that 10% by volume or more of the protrusions is meltable, it is still more preferable that 20% by volume or more of the protrusions is meltable, it is particularly preferable that 30% by volume or more of the protrusions is meltable, it is most preferable that 50% by volume or more of the protrusions is meltable in 100% by volume of the entire volume of the protrusions at the time of heating at 400° C. When the volume of the protrusions meltable at the time of heating at 400° C. is in the above preferable range, the melt-bonding property due to the protrusion can be still further enhanced and the connection reliability can be effectively enhanced. The protrusions can be more effectively melt-deformed as the volume of the protrusions meltable at the time of heating at 400° C. is greater.

The metal diffusion state of the protrusion component of the metal section is evaluated as follows.

A conductive paste having a content of metal-containing particle of 10% by weight is prepared.

A transparent glass substrate having a copper electrode on the upper surface is prepared. In addition, a semiconductor chip having a gold electrode on the lower surface is prepared.

A conductive paste is applied on the transparent glass substrate to form a conductive paste layer. Next, the semiconductor chip is layered on the conductive paste layer so that the electrodes face each other. Thereafter, the pressure heating head is placed on the upper surface of the semiconductor chip while adjusting the temperature of the head so that the temperature of the conductive paste layer is 250° C., a pressure of 0.5 MPa is applied thereto, the conductive paste layer is cured at 250° C., and a connection structure is thus obtained.

The connection structure is mechanically polished so as to pass near the center of the connection structure, and a cross section of the metal-containing particle is cut out using an ion milling device. Incidentally, in order to facilitate mechanical polishing of the connection structure, the connection structure may be embedded in a resin and the connection structure embedded in the resin may be mechanically polished.

Subsequently, the diffusion state of metal is observed by line analysis or elemental mapping of the contact portion between the metal-containing particle and the copper electrode and gold electrode using a field emission transmission electron microscope FE-TEM and an energy dispersive X-ray analyzer (EDS).

It can be confirmed that the outer periphery of the metal-containing particle is metal-diffused to the copper electrode and the gold electrode by observing the diffusion state of metal.

In addition, the contact proportion between the outer periphery of the metal-containing particle and the copper electrode and gold electrode can be calculated by mapping of the diffusion state of metal, and the quantitative determination can also be thus performed.

The melt-deformation temperature of the protrusions of the metal section is evaluated as follows.

The melt-deformation temperature of the protrusions of the metal section can be measured using a differential scanning calorimeter (“DSC-6300” manufactured by Yamato Scientific Co., Ltd.). The measurement is performed using 15 g of metal-containing particles under measurement conditions of a range of temperature rise of 30° C. to 500° C., a rate of temperature rise of 5° C./min, and a nitrogen purge rate of 5 ml/min.

Next, it is confirmed that the protrusions of the metal section is melted at the melting temperature attained by the measurement. The metal-containing particle is placed in a container by 1 g and the container is placed in an electric furnace. The temperature in the electric furnace is set to the same temperature as the melting temperature attained by the measurement, and heating is performed for 10 minutes in a nitrogen atmosphere. Thereafter, the heated metal-containing particle is taken out from the electric furnace, and the melted state (or the solidified state after melting) of the protrusions is confirmed using a scanning electron microscope. Incidentally, the protrusions may be melt-deformed by melting a partial region of the protrusions such as the tips of the protrusions, the surface of the protrusions, or the inside of the protrusions.

The metal-containing particle according to the present invention can be used for the connection of two connection target members since the protrusions of the metal section can be melt-bonded at a relatively low temperature. By making a melt-bond between the two connection target members through the protrusions of the metal section in the metal-containing particle, it is possible to form a connection section exerting firm connection and to enhance the connection reliability.

The average (a) of vertical angles of the plurality of protrusions in the metal-containing particle is preferably 10° or more, more preferably 20° or more and preferably 60° or less, more preferably 45° or less. The protrusion is hardly excessively broken when the average (a) of the vertical angles is the lower limit or more. The melting temperature or the melt-deformation temperature is still further lowered when the average (a) of the vertical angles is the upper limit or less. Incidentally, the broken protrusion sometimes increases the connection resistance between the electrodes at the time of conductive connection.

The average (a) of the vertical angles of the protrusions is determined by averaging the vertical angles of the respective protrusions contained in one metal-containing particle.

The average height (b) of the plurality of protrusions in the metal-containing particles is preferably 3 nm or more, more preferably 5 nm or more, still more preferably 50 nm or more and preferably 5,000 nm or less, more preferably 1,000 nm or less, still more preferably 800 nm or less. The melting temperature or the melt-deformation temperature is still further lowered when the average height (b) of the protrusions is the lower limit or more. The protrusion is hardly excessively broken when the average height (b) of the protrusions is the upper limit or less.

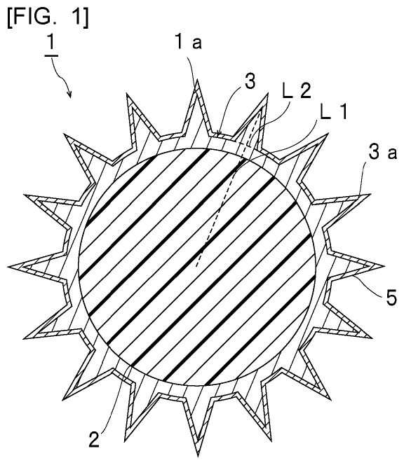

The average height (b) of the protrusions is an average height of the protrusions contained in one metal-containing particle. When the metal-containing particle does not have the convexes but has the protrusions, the height of the protrusion denotes the distance from the imaginary line (broken line L2 illustrated in FIG. 1) of the metal-containing particle when it is assumed that there is no protrusion (from the outer surface of a spherical metal-containing particle when it is assumed that there is no protrusion) to the tip of the protrusion on a line (broken line L1 illustrated in FIG. 1) joining the center of the metal-containing particle with the tip of the protrusion. When the metal-containing particle does not have the convexes but has the protrusions, the height of the protrusion denotes the distance from the imaginary line (broken line L12 illustrated in FIG. 9) of the metal-containing particle when it is assumed that there is no protrusion (from the outer surface of a spherical metal-containing particle when it is assumed that there is no protrusion) to the tip of the protrusion on a line (broken line L11 illustrated in FIG. 9) joining the center of the metal-containing particle with the tip of the protrusion. In other words, the height of the protrusion denotes the distance from the intersection of the broken line L1 and the broken line L2 to the tip of the protrusion in FIG. 1. The height of the protrusion denotes the distance from the intersection of the broken line L11 and the broken line L12 to the tip of the protrusion in FIG. 9. Incidentally, when the metal-containing particle has the convexes and the protrusions, that is, when the metal-containing particle has the protrusions on the convexes, the height of the protrusion denotes the distance from the imaginary line of the metal-containing particle (convex) when it is assumed that there is no protrusion to the tip of the protrusion. Each of the protrusions may be an aggregate of a plurality of particulate substances. For example, each of the protrusions may be formed by linking a plurality of particles which constitute the protrusions. In this case, the height of protrusion may be the height of protrusion when an aggregate of a plurality of particulate substances or linked particles are regarded as a whole.

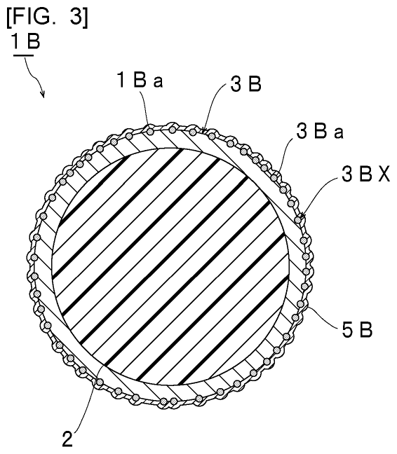

In FIG. 3 as well, the heights of protrusions 1Ba and 3Ba denote the distance from the imaginary line of the metal-containing particle when it is assumed that there are no protrusions to the tip of the protrusion. However, when the protrusions 1Ba and 3Ba are formed by stacking a plurality of particles, the average height for one of the plurality of particles is taken as the height of protrusion.

The average diameter (c) of bases of the plurality of protrusions in the metal-containing particle is preferably 3 nm or more, more preferably 5 nm or more, still more preferably 50 nm or more and preferably 1,000 nm or less, more preferably 800 nm or less. The protrusion is hardly excessively broken when the average diameter (c) is the lower limit or more. The connection reliability is still further enhanced when the average diameter (c) is the upper limit or less.

The average diameter (c) of the bases of the protrusions is an average of the diameters of the bases of the protrusions contained in one metal-containing particle. The diameter of the base is the maximum diameter of each of the bases of the protrusions. When the metal-containing particle has the convexes and the protrusions, that is, when the metal-containing particle has the protrusions on the convexes, the end of the imaginary line portion of the metal-containing particle when it is assumed that there is no protrusion on a line joining the center of the metal-containing particle with the tip of the protrusion is the base of the protrusions. Moreover, the distance between the ends of the imaginary line portion (the distance between the ends joined by a straight line) is the diameter of base.

The ratio (average height (b)/average diameter (c)) of the average height (b) of the plurality of protrusions to the average diameter (c) of the bases of the plurality of protrusions is preferably 0.5 or more, more preferably 1.5 or more and preferably 10 or less, more preferably 5 or less. The connection reliability is still further enhanced when the ratio (average height (b)/average diameter (c)) is the lower limit or more. The protrusion is hardly excessively broken when the ratio (average height (b)/average diameter (c)) is the upper limit or less.

The ratio (average diameter (d)/average diameter (c)) of the average diameter (d) at the central position of the heights of the plurality of protrusions to the average diameter (c) of the bases of the plurality of protrusions is preferably ⅕ or more, more preferably ¼ or more, still more preferably ⅓ or more and preferably ⅘ or less, more preferably ¾ or less, still more preferably ⅔ or less. The protrusion is hardly excessively broken when the ratio (average diameter (d)/average diameter (c)) is the lower limit or more. The connection reliability is still further enhanced when the ratio (average diameter (d)/average diameter (c)) is the upper limit or less.

The average diameter (d) at the central position of the heights of the protrusions in the metal-containing particles is the average of the diameters at the central position of the heights of the protrusions contained in one metal-containing particle. The diameter at the central position of the height of the protrusion is the maximum diameter at the central position of the height of each of the protrusions.

It is preferable that the shape of each of the plurality of protrusions in the metal-containing particle is a needle shape or a shape of a part of a sphere from the viewpoint of suppressing excessive breakage of the protrusions, still further enhancing the melt-bonding property due to the protrusions, and effectively enhancing the connection reliability. The needle shape is preferably a pyramidal shape, a conical shape, or a shape of paraboloid of revolution, more preferably a conical shape or a shape of paraboloid of revolution, and still more preferably a conical shape. The shape of the protrusions in the metal-containing particle may be a pyramidal shape, a conical shape, or a shape of paraboloid of revolution. In the present invention, a shape of paraboloid of revolution is also included in the tapered needle shape. The protrusion in a shape of paraboloid of revolution is tapered from the base to the tip.

The number of protrusions that the outer surface per one metal-containing particle has is preferably 3 or more and more preferably 5 or more. The upper limit of the number of protrusions is not particularly limited. The upper limit of the number of protrusions can be appropriately selected in consideration of the particle diameter and the like of the metal-containing particle.

Incidentally, each of the protrusions contained in the metal-containing particle may not have a tapered needle shape and it is not required that all of the protrusions contained in the metal-containing particle have a tapered needle shape.

The proportion of the number of protrusions having a tapered needle shape in the number of protrusions contained per one metal-containing particle is preferably 30% or more, more preferably 50% or more, still more preferably 60% or more, particularly preferably 70% or more, and most preferably 80% or more. The effect by the needle-shaped protrusions is still further effectively attained as the proportion of the number of needle-shaped protrusions is higher.

The proportion (x) of the surface area of the portion having the protrusions in 100% of the surface area of the outer surface of the metal-containing particle is preferably 10% or more, more preferably 20% or more, still more preferably 30% or more and preferably 90% or less, more preferably 80% or less, still more preferably 70% or less. The effect by the protrusions is still further effectively attained as the proportion of the surface area of the portion having the protrusions is higher.

The proportion of the surface area of the portion having the needle-shaped protrusions in 100% of the surface area of the outer surface of the metal-containing particle is preferably 10% or more, more preferably 20% or more, still more preferably 30% or more and preferably 90% or less, more preferably 80% or less, still more preferably 70% or less from the viewpoint of effectively enhancing the connection reliability. The effect by the protrusions is still further effectively attained as the proportion of the surface area of the portion having the needle-shaped protrusions is higher.

The average (A) of vertical angles of the plurality of convexes is preferably 10° or more, more preferably 20° or more and preferably 60° or less, more preferably 45° or less. The convex is hardly excessively broken when the average (A) of the vertical angles is the lower limit or more. The melting temperature is still further lowered when the average (A) of the vertical angles is the upper limit or less. Incidentally, the broken convex sometimes increases the connection resistance between the electrodes at the time of conductive connection.

The average (A) of the vertical angles of the convexes is determined by averaging the vertical angles of the respective convexes contained in one metal-containing particle.

The average height (B) of the plurality of convexes is preferably 5 nm or more, more preferably 50 nm or more and preferably 5,000 nm or less, more preferably 1,000 nm or less, still more preferably 800 nm or less. The melting temperature is still further lowered when the average height (B) of the convexes is the lower limit or more. The convex is hardly excessively broken when the average height (B) of the convexes is the upper limit or less.

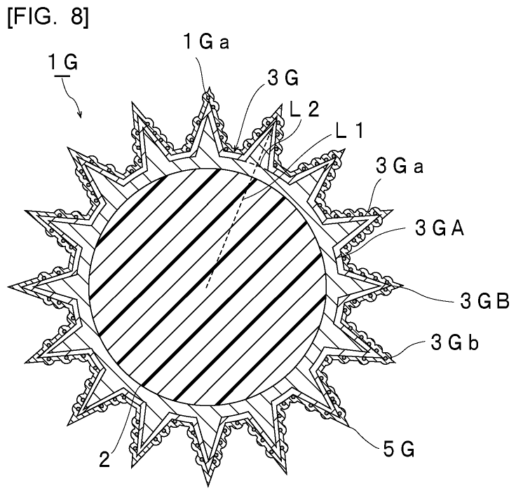

The average height (B) of the convexes is an average of the heights of the convexes contained in one metal-containing particle. The height of the convex denotes the distance from the imaginary line (broken line L2 illustrated in FIG. 8) of the metal-containing particle when it is assumed that there is no convex (from the outer surface of a spherical metal-containing particle when it is assumed that there is no convex) to the tip of the convex on a line (broken line L1 illustrated in FIG. 8) joining the center of the metal-containing particle with the tip of the convex. In other words, the height of the convex denotes the distance from the intersection of the broken line L1 and the broken line L2 to the tip of the convex in FIG. 8.

The average diameter (C) of bases of the plurality of convexes is preferably 3 nm or more, more preferably 5 nm or more, still more preferably 50 nm or more and preferably 5,000 nm or less, more preferably 1,000 nm or less, still more preferably 800 nm or less. The convex is hardly excessively broken when the average diameter (C) is the lower limit or more. The connection reliability is still further enhanced when the average diameter (C) is the upper limit or less.

The average diameter (C) of the bases of the convexes is an average of the diameters of the bases of the convexes contained in one metal-containing particle. The diameter of the base is the maximum diameter of each of the bases of the convexes. The end of the imaginary line portion (broken line L2 illustrated in FIG. 8) of the metal-containing particle when it is assumed that there is no convex on a line (broken line L1 illustrated in FIG. 8) joining the center of the metal-containing particle with the tip of the convex is the base of the convex. The distance between the ends of the imaginary line portion (the distance between the ends joined by a straight line) is the diameter of base.

The ratio (average diameter (D)/average diameter (C)) of the average diameter (D) at the central position of the heights of the plurality of convexes to the average diameter (C) of the bases of the plurality of convexes is preferably ⅕ or more, more preferably ¼ or more, still more preferably ⅓ or more and preferably ⅘ or less, more preferably ¾ or less, still more preferably ⅔ or less. The convex is hardly excessively broken when the ratio (average diameter (D)/average diameter (C)) is the lower limit or more. The connection reliability is still further enhanced when the ratio (average diameter (D)/average diameter (C)) is the upper limit or less.

The average diameter (D) at the central position of the height of the convex is the average of the diameters at the central position of the height of the convex contained in one metal-containing particle. The diameter at the central position of the height of the convex is the maximum diameter at the central position of each of the heights of the convexes.

It is preferable that the shape of the plurality of convexes is a needle shape or a shape of a part of a sphere from the viewpoint of suppressing excessive breakage of the convex, still further enhancing the melt-bonding property due to the convex, and effectively enhancing the connection reliability. The needle shape is preferably a pyramidal shape, a conical shape, or a shape of paraboloid of revolution, more preferably a conical shape or a shape of paraboloid of revolution, and still more preferably a conical shape. The shape of the convex may be a pyramidal shape, a conical shape, or a shape of paraboloid of revolution. In the present invention, a shape of paraboloid of revolution is also included in the tapered needle shape. The convex in a shape of paraboloid of revolution is tapered from the base to the tip.

The number of convexes that the outer surface per one metal-containing particle has is preferably 3 or more and more preferably 5 or more. The upper limit of the number of convexes is not particularly limited. The upper limit of the number of convexes can be appropriately selected in consideration of the particle diameter and the like of the metal-containing particle. Incidentally, the convexes contained in the metal-containing particle may not have a tapered needle shape and it is not required that all of the convexes contained in the metal-containing particle have a tapered needle shape.

The proportion of the number of convexes having a tapered needle shape in the number of convexes contained per one metal-containing particle is preferably 30% or more, more preferably 50% or more, still more preferably 60% or more, particularly preferably 70% or more, and most preferably 80% or more. The effect by the needle-shaped convexes is still further effectively attained as the proportion of the number of needle-shaped convexes is higher.

The proportion (X) of the surface area of the portion having the convexes in 100% of the surface area of the metal-containing particle is preferably 10% or more, more preferably 20% or more, still more preferably 30% or more and preferably 90% or less, more preferably 80% or less, still more preferably 70% or less. The effect by the protrusions on the convexes is still further effectively attained as the proportion of the surface area of the portion having the convexes is higher.

The proportion of the surface area of the portion having the convexes in 100% of the surface area of the outer surface of the metal-containing particle is preferably 10% or more, more preferably 20% or more, still more preferably 30% or more and preferably 90% or less, more preferably 80% or less, still more preferably 70% or less from the viewpoint of effectively enhancing the connection reliability. The effect by the protrusions on the convexes is still further effectively attained as the proportion of the surface area of the portion having the needle-shaped convexes is higher.

The ratio (average height (B)/average height (b)) of the average height (B) of the plurality of convexes to the average height (b) of the plurality of protrusions in the metal-containing particle is preferably 5 or more, more preferably 10 or more and preferably 1,000 or less, more preferably 800 or less. The connection reliability is still further enhanced when the ratio (average height (B)/average height (b)) is the lower limit or more. The convex is hardly excessively broken when the ratio (average height (B)/average height (b)) is the upper limit or less.

It is preferable that the metal section having the plurality of protrusions is formed by the crystal orientation of a metal or an alloy. Incidentally, in Example to be described later, the metal section is formed by the crystal orientation of a metal or an alloy.

From the viewpoint of effectively enhancing the connection reliability, the compressive elastic modulus (10% K value) when the metal-containing particle is compressed by 10% is preferably 100 N/mm² or more, more preferably 1,000 N/mm² or more and preferably 25,000 N/mm² or less, more preferably 10,000 N/mm² or less, still more preferably 8,000 N/mm² or less.

The compressive elastic modulus (10% K value) of the metal-containing particle can be measured as follows.

Metal-containing particle is compressed on the smooth indenter end face of a cylinder (diameter: 100 μm, made of diamond) under the conditions of 25° C., a compression rate of 0.3 mN/s, and a maximum test load of 20 mN using a micro compression testing machine. The load value (N) and compression displacement (mm) at this time are measured. The compressive elastic modulus can be determined from the measured value thus attained by the following equation. As the micro compression testing machine, for example, “Fisher Scope H-100” manufactured by Helmut Fisher GmbH is used.

10% K value (N/mm²)=(3/2^{1/2})19 F·S^{-3/2}·R^{-1/2}

F: Load value when metal-containing particle undergoes 10% compression deformation (N)

S: Compression displacement when metal-containing particle undergoes 10% compression deformation (mm)

R: Radius of metal-containing particle (mm)

The proportion of the (111) plane in the X-ray diffraction of the protrusions is preferably 50% or more. The connection reliability can be still further effectively enhanced when the proportion of the (111) plane in the X-ray diffraction of the protrusions is the lower limit or more.

Hereinafter, specific embodiments of the present invention will be described with reference to the drawings.

FIG. 1 is a cross-sectional view schematically illustrating a metal-containing particle according to a first embodiment of the present invention.

A metal-containing particle 1 includes a base particle 2, a metal section 3, and a metal film 5 as illustrated in FIG. 1.

The metal section 3 is disposed on the surface of the base particle 2. The metal-containing particle 1 is a covered particle in which the surface of the base particle 2 is covered with the metal section 3. The metal section 3 is a continuous film.

The metal film 5 covers the metal section 3. The metal-containing particle 1 is a covered particle in which the outer surface of the metal section 3 is covered with the metal film 5. The metal film may completely cover the surface of the metal section or may not completely cover the surface of the metal section. The metal-containing particle may have a portion in which the surface of the metal section is not covered with the metal film.

The metal-containing particle 1 has a plurality of protrusions 1a that the outer surface of the metal section 3 has. The outer surface of the metal section 3 has a plurality of protrusions 3a. The shape of the plurality of protrusions 1a and 3a is a tapered needle shape and is a conical shape in the present embodiment. In the present embodiment, the tips of the protrusions 1a and 3a are meltable at 400° C. or less. The metal section 3 has a first portion and a second portion having a thicker thickness than the first portion. The portion excluding the plurality of protrusions 1a and 3a is the first portion of the metal section 3. The plurality of protrusions 1a and 3a are the second portion having a thick thickness of the metal section 3. In the present embodiment, the outer surfaces of the plurality of protrusions 1a and 3a are covered with the metal film 5.

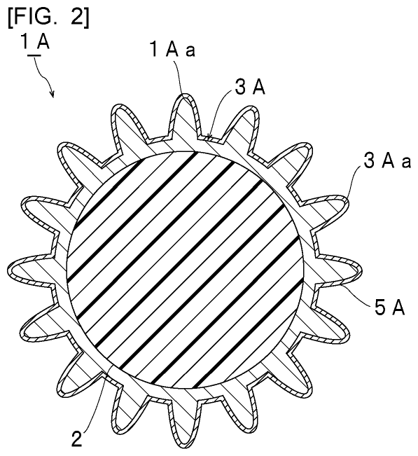

FIG. 2 is a cross-sectional view schematically illustrating a metal-containing particle according to a second embodiment of the present invention.

A metal-containing particle 1A includes a base particle 2, a metal section 3A, and a metal film 5A as illustrated in FIG. 2.

The metal section 3A is disposed on the surface of the base particle 2. The metal-containing particle 1A has a plurality of protrusions lAa that the outer surface of the metal section 3A has. The outer surface of the metal section 3A has a plurality of protrusions 3Aa. The shape of the plurality of protrusions 1Aa and 3Aa is a tapered needle shape and is a shape of paraboloid of revolution in the present embodiment. In the present embodiment, the tips of the protrusions 1Aa and 3Aa are meltable at 400° C. or less.

The metal film 5A covers the metal section 3A. The metal-containing particle 1A is a covered particle in which the outer surface of the metal section 3A is covered with the metal film 5A. The metal film may completely cover the surface of the metal section or may not completely cover the surface of the metal section. The metal-containing particle may have a portion in which the surface of the metal section is not covered with the metal film. In the present embodiment, the outer surfaces of the plurality of protrusions 1Aa and 3Aa are covered with the metal film 5A.

As in the metal-containing particles 1 and 1A, the shape of the plurality of protrusions in the metal-containing particle is preferably a tapered needle shape and may be a conical shape or a shape of paraboloid of revolution.

FIG. 3 is a cross-sectional view schematically illustrating a metal-containing particle according to a third embodiment of the present invention.

A metal-containing particle 1B includes a base particle 2, a metal section 3B, and a metal film 5B as illustrated in FIG. 3.

The metal section 3B is disposed on the surface of the base particle 2. The metal-containing particle 1B has a plurality of protrusions 1Ba that the outer surface of the metal section 3B has. The outer surface of the metal section 3B has a plurality of protrusions 3Ba. The shape of the plurality of protrusions 1Ba and 3Ba is a shape of a part of a sphere. The metal section 3B has metal particles 3BX embedded so that a part thereof is exposed on the outer surface. The exposed portions of the metal particles 3BX constitute the protrusions 1Ba and 3Ba. In the present embodiment, the tips of the protrusions 1Ba and 3Ba are meltable at 400° C. or less.

The metal film 5B covers the metal section 3B. The metal-containing particle 1B is a covered particle in which the outer surface of the metal section 3B is covered with the metal film 5B. The metal film may completely cover the surface of the metal section or may not completely cover the surface of the metal section. The metal-containing particle may have a portion in which the surface of the metal section is not covered with the metal film. In the present embodiment, the exposed portion of the metal particle 3BX is covered with the metal film 5B and the outer surfaces of the plurality of protrusions 1Ba and 3Ba are covered with the metal film 5B.

As in the metal-containing particle 1B, the shape of each of the protrusions may not be a tapered needle shape and may be, for example, a shape of a part of a sphere so that the size of the protrusions decreases.

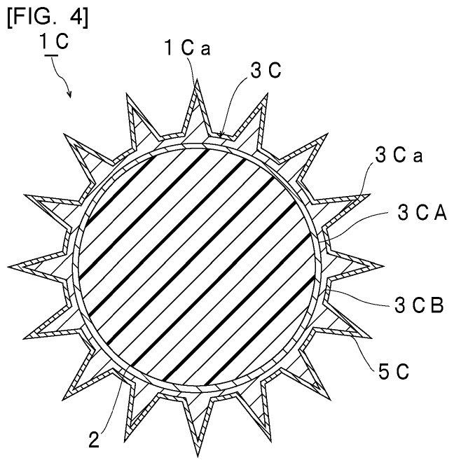

FIG. 4 is a cross-sectional view schematically illustrating a metal-containing particle according to a fourth embodiment of the present invention.

A metal-containing particle 10 includes a base particle 2, a metal section 3C, and a metal film 5C as illustrated in FIG. 4.

The metal-containing particle 1 and the metal-containing particle 10 are different from each other only in the metal section. In other words, the metal section 3 having a single-layer structure is formed in the metal-containing particle 1 but the metal section 3C having a two-layer structure is formed in the metal-containing particle 10.

The metal section 3C has a first metal section 3CA and a second metal section 3CB. The first and second metal sections 3CA and 3CB are disposed on the surface of the base particle 2. The first metal section 3CA is disposed between the base particle 2 and the second metal section 3CB. Hence, the first metal section 3CA is disposed on the surface of the base particle 2, and the second metal section 3CB is disposed on the outer surface of the first metal section 3CA. The outer shape of the first metal section 3CA is a spherical shape. The metal-containing particle 10 has a plurality of protrusions 1Ca that the outer surface of the metal section 3C has. The outer surface of the metal section 3C has a plurality of protrusions 3Ca. The outer surface of the second metal section 3CB has a plurality of protrusions. The shape of the plurality of protrusions 1Ca and 3Ca is a tapered needle shape and is a conical shape in the present embodiment. In the present embodiment, the tips of the protrusions 1Ca and 3Ca are meltable at 400° C. or less. The outer surface of the inner first metal section may have a plurality of protrusions.

The metal film 5C covers the metal section 3C. The metal-containing particle 10 is a covered particle in which the outer surface of the metal section 3C is covered with the metal film 5C. The metal film may completely cover the surface of the metal section or may not completely cover the surface of the metal section. The metal-containing particle may have a portion in which the surface of the metal section is not covered with the metal film. In the present embodiment, the outer surfaces of the plurality of protrusions 10a and 3Ca are covered with the metal film 5C.

FIG. 5 is a cross-sectional view schematically illustrating a metal-containing particle according to a fifth embodiment of the present invention.

A metal-containing particle 1D includes a base particle 2, a metal section 3D, and a metal film 5D as illustrated in FIG. 5.

The metal section 3D is disposed on the surface of the base particle 2. The metal-containing particle 1D has a plurality of protrusions 1Da that the outer surface of the metal section 3D has. The metal-containing particle 1D has a plurality of convexes (first protrusions) 3Da that the outer surface of the metal section 3D has. The outer surface of the metal section 3D has a plurality of convexes (first protrusions) 3Da. The metal section 3D has a protrusion 3Db (second protrusion) that the outer surface of the convex (first protrusion) 3Da has, the protrusion 3Db (second protrusion) being smaller than the convex (first protrusion) 3Da. The convex (first protrusion) 3Da and the protrusion 3Db (second protrusion) are integrated and are linked. In the present embodiment, the tip diameter of the protrusion 3Db (second protrusion) is small and the tip of the protrusion 3Db (second protrusion) is meltable at 400° C. or less.

The metal film 5D covers the metal section 3D. The metal-containing particle 1D is a covered particle in which the outer surface of the metal section 3D is covered with the metal film 5D. The metal film may completely cover the surface of the metal section or may not completely cover the surface of the metal section. The metal-containing particle may have a portion in which the surface of the metal section is not covered with the metal film. In the present embodiment, the outer surfaces of the plurality of protrusions 1Da, convexes (first protrusions) 3Da, and protrusions 3Db (second protrusions) are covered with the metal film 5D.

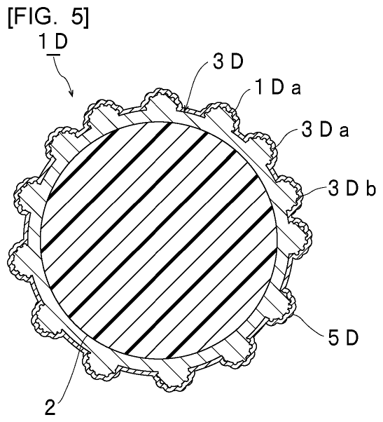

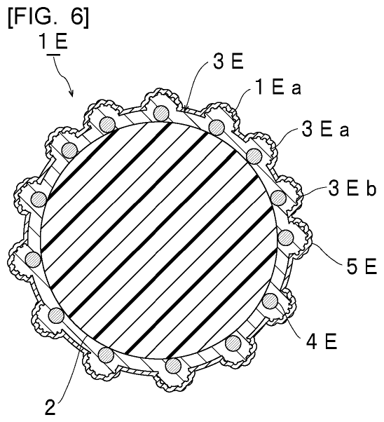

FIG. 6 is a cross-sectional view schematically illustrating a metal-containing particle according to a sixth embodiment of the present invention.

A metal-containing particle 1E includes a base particle 2, a metal section 3E, a core substance 4E, and a metal film 5E as illustrated in FIG. 6.

The metal section 3E is disposed on the surface of the base particle 2. The metal-containing particle 1E has a plurality of protrusions lEa that the outer surface of the metal section 3E has. The metal-containing particle 1E has a plurality of convexes (first protrusions) 3Ea that the outer surface of the metal section 3E has. The outer surface of the metal section 3E has a plurality of convexes (first protrusions) 3Ea. The metal section 3E has a protrusion 3Eb (second protrusion) that the outer surface of the convex (first protrusion) 3Ea has, the protrusion 3Eb (second protrusion) being smaller than the convex (first protrusion) 3Ea. The convex (first protrusion) 3Ea and the protrusion 3Eb (second protrusion) are integrated and are linked. In the present embodiment, the tip diameter of the protrusion 3Eb (second protrusion) is small and the tip of the protrusion 3Eb (second protrusion) is meltable at 400° C. or less.

The metal film 5E covers the metal section 3E. The metal-containing particle 1E is a covered particle in which the outer surface of the metal section 3E is covered with the metal film 5E. The metal film may completely cover the surface of the metal section or may not completely cover the surface of the metal section. The metal-containing particle may have a portion in which the surface of the metal section is not covered with the metal film. In the present embodiment, the outer surfaces of the plurality of protrusions lEa, convexes (first protrusions) 3Ea, and protrusions 3Eb (second protrusions) are covered with the metal film 5E.

In the metal-containing particles 1E, a plurality of core substances 4E are disposed on the outer surface of the base particle 2. The plurality of core substances 4E are disposed in the interior of the metal section 3E. The plurality of core substances 4E are embedded in the interior of the metal section 3E. The core substance 4E is disposed in the interior of the convex 3Ea. The metal section 3E covers the plurality of core substances 4E. The outer surface of the metal section 3E is raised and the convex 3Ea is formed by the plurality of core substances 4E.

As the metal-containing particles 1E, the metal-containing particles may include a plurality of core substances which raise the outer surface of the metal-containing particle or metal section.

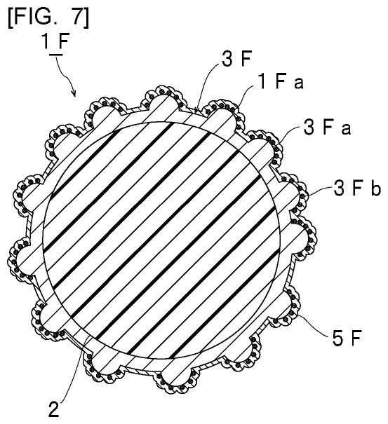

FIG. 7 is a cross-sectional view schematically illustrating a metal-containing particle according to a seventh embodiment of the present invention.

A metal-containing particle 1F includes a base particle 2, a metal section 3F, and a metal film 5F as illustrated in FIG. 7.

The metal section 3F is disposed on the surface of the base particle 2. The metal-containing particle 1F has a plurality of protrusions 1Fa that the outer surface of the metal section 3F has. The metal-containing particle 1F has a plurality of convexes (first protrusions) 3Fa that the outer surface of the metal section 3F has. The outer surface of the metal section 3F has a plurality of convexes (first protrusions) 3Fa. The metal section 3F has a protrusion 3Fb (second protrusion) that the outer surface of the convex (first protrusion) 3Fa has, the protrusion 3Fb (second protrusion) being smaller than the convex (first protrusion) 3Fa. The convex (first protrusion) 3Fa and the protrusion 3Fb (second protrusion) are not integrated. In the present embodiment, the tip diameter of the protrusion 3Fb (second protrusion) is small and the tip of the protrusion 3Fb (second protrusion) is meltable at 400° C. or less.

The metal film 5F covers the metal section 3F. The metal-containing particle 1F is a covered particle in which the outer surface of the metal section 3F is covered with the metal film 5F. The metal film may completely cover the surface of the metal section or may not completely cover the surface of the metal section. The metal-containing particle may have a portion in which the surface of the metal section is not covered with the metal film. In the present embodiment, the outer surfaces of the plurality of protrusions 1Fa, convexes (first protrusions) 3Fa, and protrusions 3Fb (second protrusions) are covered with the metal film 5F.

FIG. 8 is a cross-sectional view schematically illustrating a metal-containing particle according to an eighth embodiment of the present invention.

A metal-containing particle 1G includes a base particle 2, a metal section 3G, and a metal film 5G as illustrated in FIG. 8.

The metal section 3G has a first metal section 3GA and a second metal section 3GB. The first and second metal sections 3GA and 3GB are disposed on the surface of the base particle 2. The first metal section 3GA is disposed between the base particle 2 and the second metal section 3GB. Hence, the first metal section 3GA is disposed on the surface of the base particle 2, and the second metal section 3GB is disposed on the outer surface of the first metal section 3GA.

The metal section 3G is disposed on the surface of the base particle 2. The metal-containing particle 1G has a plurality of protrusions 1Ga that the outer surface of the metal section 3G has. The metal-containing particle 1G has a plurality of convexes (first protrusions) 3Ga that the outer surface of the metal section 3G has. The metal section 3G has a protrusion 3Gb (second protrusion) that the outer surface of the convex (first protrusion) 3Ga has, the protrusion 3Gb (second protrusion) being smaller than the convex (first protrusion) 3Ga. There is an interface between the convex (first protrusion) 3Ga and the protrusion 3Gb (second protrusion). In the present embodiment, the tip diameter of the protrusion 3Gb (second protrusion) is small and the tip of the protrusion 3Gb (second protrusion) is meltable at 400° C. or less.

The metal film 5G covers the metal section 3G. The metal-containing particle 1G is a covered particle in which the outer surface (second metal section 3GB) of the metal section 3G is covered with the metal film 5G. The metal film may completely cover the surface of the metal section or may not completely cover the surface of the metal section. The metal-containing particle may have a portion in which the surface of the metal section is not covered with the metal film. In the present embodiment, the outer surfaces of the plurality of protrusions 1Ga, convexes (first protrusions) 3Ga, and protrusions 3Gb (second protrusions) are covered with the metal film 5G.

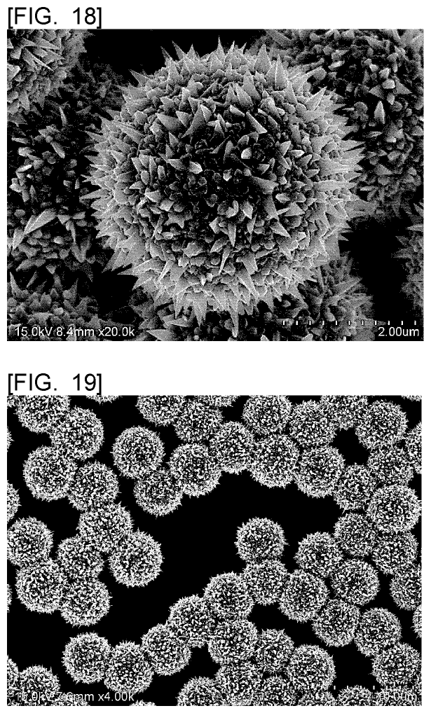

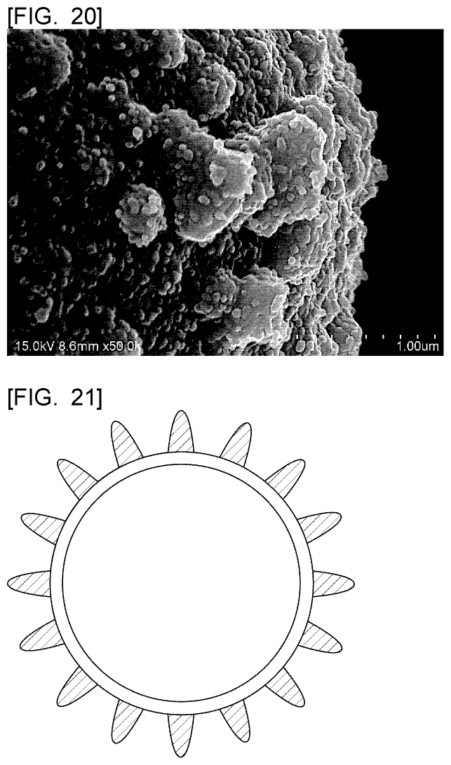

In addition, the images of metal-containing particles which are actually manufactured but are not yet subjected to the formation of a metal film are illustrated in FIGS. 17 to 20. The metal-containing particles illustrated in FIGS. 17 to 20 include a metal section, the outer surface of which has protrusions. The tips of the plurality of protrusions of the metal section are meltable at 400° C. or less. In the metal-containing particle illustrated in FIG. 20, the outer surface of the metal section has a plurality of convexes and the outer surface of the convexes has protrusions smaller than the convexes. The metal-containing particles according to the present invention are obtained by covering the metal sections of the metal-containing particles illustrated in FIGS. 17 to 20 with a metal film.

FIG. 9 is a cross-sectional view schematically illustrating a metal-containing particle according to a ninth embodiment of the present invention.

A metal-containing particle 11 includes a base particle 2 and a metal section 13 as illustrated in FIG. 9.

The metal section 13 is disposed on the surface of the base particle 2. The metal-containing particle 11 is a covered particle in which the surface of the base particle 2 is covered with the metal section 13. The metal section 13 is a continuous film covering the entire surface of the base particle 2.

The metal-containing particle 11 has a plurality of protrusions 11a that the outer surface of the metal section 13 has. The outer surface of the metal section 13 has a plurality of protrusions 13a. The shape of the plurality of protrusions 11a and 13a is a tapered needle shape and is a shape of paraboloid of revolution in the present embodiment.

The metal section 13 has a first metal section 13X and a second metal section 13Y. The second metal section 13Y is a particle and is, for example, solder. The first metal section 13X is a portion excluding the second metal section 13Y of the metal section 13. The second metal section 13Y is melt-deformable at 400° C. or less. The melting point of the first metal section 13X is more than 400° C. The first metal section 13X is not melt-deformed at 400° C.

One second metal section 13Y is disposed inside one protrusion 11a and inside one protrusion 13a respectively. In the present embodiment, the protrusions 11a and 13a include the second metal section 13Y capable of metal-diffusing at 400° C. or less. In addition, by the presence of the second metal section 13Y, in the protrusions 11a and 13a, metal diffusion occurs between the second metal section 13Y and the first metal section 13X at 400° C. or less and a protrusion melt-deformable at 400° C. or less is formed. Alternatively, the protrusions 11a and 13a are melt-deformable at 400° C. or less by the second metal section 13Y. The metal section 13 has a first portion and a second portion having a thicker thickness than the first portion. The portion excluding the plurality of protrusions 11a and 13a is the first portion of the metal section 13. The plurality of protrusions 11a and 13a are the second portion having a thick thickness of the metal section 13. The second metal section 13Y is not present at the first portion, thus a portion melt-deformable by metal diffusion is not formed even at the time of mounting, and the thickness can be secured.

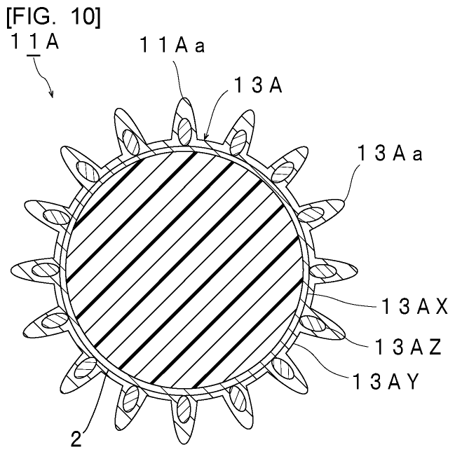

FIG. 10 is a cross-sectional view schematically illustrating a metal-containing particle according to a tenth embodiment of the present invention.

A metal-containing particle 11A includes a base particle 2 and a metal section 13A as illustrated in FIG. 10.

The metal-containing particle 11 and the metal-containing particle 11A are different from each other only in the metal section. In other words, the metal section 13 having a single-layer structure is formed in the metal-containing particle 11 but the metal section 13A having a two-layer structure is formed in the metal-containing particle 11A.

The metal section 13A has a first metal section 13AX, a second metal section 13AY, and a third metal section 13AZ. The first, second, and third metal sections 13AX, 13AY, and 13AZ are disposed on the surface of the base particle 2.

The first metal section 13AX is an inner layer. The second metal section 13AY is an outer layer. The first metal section 13AX is disposed between the base particle 2 and the second metal section 13AY. Hence, the first metal section 13AX is disposed on the surface of the base particle 2 and the second metal section 13AY is disposed on the outer surface of the first metal section 13AX. The outer shape of the first metal section 13AX is a spherical shape. The metal-containing particle 11A has a plurality of protrusions 11Aa that the outer surface of the metal section 13A has. The outer surface of the metal section 13A has a plurality of protrusions 13Aa. The outer surface of the second metal section 13AY has a plurality of protrusions. The shape of the plurality of protrusions 11Aa and 13Aa is a tapered needle shape and is a shape of paraboloid of revolution in the present embodiment.

The third metal section 13AZ is a particle and is, for example, solder. The third metal section 13AZ is melt-deformable at 400° C. or less. The melting points of the first and second metal sections 13AX and 13AY are more than 400° C. The first and second metal sections 13AX and 13AY are not melt-deformed at 400° C.

One third metal section 13AZ is disposed inside one protrusion 11Aa and inside one protrusion 13Aa. In the present embodiment, the protrusions 11Aa and 13Aa include the third metal section 13AZ capable of metal-diffusing at 400° C. or less. In addition, by the presence of the third metal section 13AZ, in the protrusions 11Aa and 13Aa, metal diffusion occurs between the second metal section 13AY and the third metal section 13AZ and a protrusion melt-deformable at 400° C. or less is formed. Alternatively, the protrusions 11Aa and 13Aa are melt-deformable at 400° C. or less by the third metal section 13AZ.

The third metal section 13AZ is disposed inside the second metal section 13AY. The third metal section 13AZ is not disposed inside the first metal section 13AX. The third metal section 13AZ is disposed on the outer surface of the first metal section 13AX. The third metal section 13AZ is in contact with the first metal section 13AX. The third metal section 13AZ may not be in contact with the first metal section 13AX.

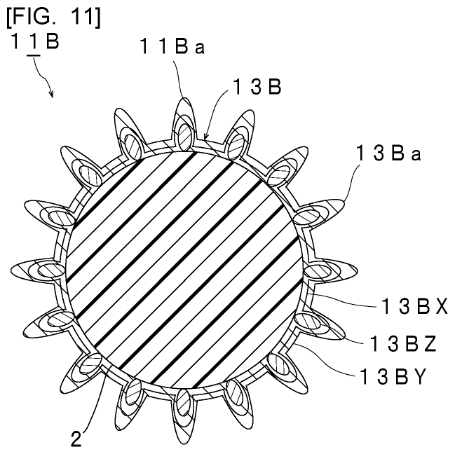

FIG. 11 is a cross-sectional view schematically illustrating a metal-containing particle according to an eleventh embodiment of the present invention.

A metal-containing particle 11B includes a base particle 2 and a metal section 13B as illustrated in FIG. 11.

The metal-containing particle 11 and the metal-containing particle 11B are different from each other only in the metal section.

The metal section 13B has a first metal section 13BX, a second metal section 13BY, and a third metal section 13BZ. The first, second, and third metal sections 13BX, 13BY, and 13BZ are disposed on the surface of the base particle 2.

The first metal section 13BX is an inner layer. The second metal section 13BY is an outer layer. The first metal section 13BX is disposed between the base particle 2 and the second metal section 13BY. Hence, the first metal section 13BX is disposed on the surface of the base particle 2 and the second metal section 13BY is disposed on the outer surface of the first metal section 13BX. The metal-containing particle 11B has a plurality of protrusions 11Ba that the outer surface of the metal section 13B has. The outer surface of the metal section 13B has a plurality of protrusions 13Ba. The outer surface of the first metal section 13BX has a plurality of protrusions. The outer surface of the second metal section 13BY has a plurality of protrusions. The shape of the plurality of protrusions 11Ba and 13Ba is a tapered needle shape and is a shape of paraboloid of revolution in the present embodiment.

The third metal section 13BZ is a particle and is, for example, solder. The third metal section 13BZ is melt-deformable at 400° C. or less. The melting points of the first and second metal sections 13BX and 13BY are more than 400° C. The first and second metal sections 13BX and 13BY are not melt-deformed at 400° C.

The third metal section 13BZ is disposed inside the protrusions 11Ba and 13Ba. One third metal section 13BZ is disposed inside one protrusion 11Ba and inside one protrusion 13Ba. In the present embodiment, the protrusions 11Ba and 13Ba include the third metal section 13BZ capable of metal-diffusing at 400° C. or less. In addition, by the presence of the third metal section 13BZ, in the protrusions 11Ba and 13Ba, metal diffusion occurs between the first metal section 13BX and the third metal section 13BZ and a protrusion melt-deformable at 400° C. or less is formed. Alternatively, the protrusions 11Ba and 13Ba are melt-deformable at 400° C. or less by the third metal section 13BZ.

A partial region of the third metal section 13BZ is disposed inside the first metal section 13BX. A partial region of the third metal section 13BZ is disposed inside the second metal section 13BY. The third metal section 13BZ is disposed on the surface of the base particle 2. The third metal section 13BZ is in contact with the base particle 2. The third metal section 13BZ may not be in contact with the base particle 2.

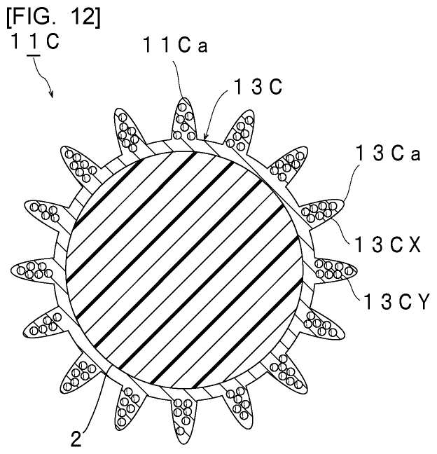

FIG. 12 is a cross-sectional view schematically illustrating a metal-containing particle according to a twelfth embodiment of the present invention.

A metal-containing particle 11C includes a base particle 2 and a metal section 13C as illustrated in FIG. 12.

The metal-containing particle 11 and the metal-containing particle 11C are different from each other only in the metal section.

The metal section 13C has a first metal section 13CX and a second metal section 13CY. The metal-containing particle 11C has a plurality of protrusions 11Ca that the outer surface of the metal section 13C has. The outer surface of the metal section 13C has a plurality of protrusions 13Ca. The shape of the plurality of protrusions 11Ca and 13Ca is a tapered needle shape and is a shape of paraboloid of revolution in the present embodiment.

The second metal section 13CY is a particle and is, for example, solder. The first metal section 13CX is a portion excluding the second metal section 13CY of the metal section 13C. The second metal section 13CY is melt-deformable at 400° C. or less. The melting point of the first metal section 13CX is more than 400° C. The first metal section 13CX is not melt-deformed at 400° C.

A plurality of second metal sections 13CY are disposed inside one protrusion 11Ca and inside one protrusion 13Ca. In the present embodiment, the protrusions 11Ca and 13Ca include the second metal section 13CY capable of metal-diffusing at 400° C. or less. In addition, by the presence of the second metal section 13CY, in the protrusions 11Ca and 13Ca, metal diffusion occurs between the second metal section 13CY and the first metal section 13CX and a protrusion melt-deformable at 400° C. or less is formed. Alternatively, the protrusions 11Ca and 13Ca are melt-deformable at 400° C. or less by the second metal section 13CY.

As in the metal-containing particle 11C, a plurality of regions melt-deformable at 400° C. or less may be formed in one protrusion in order that the protrusion is melt-deformable.

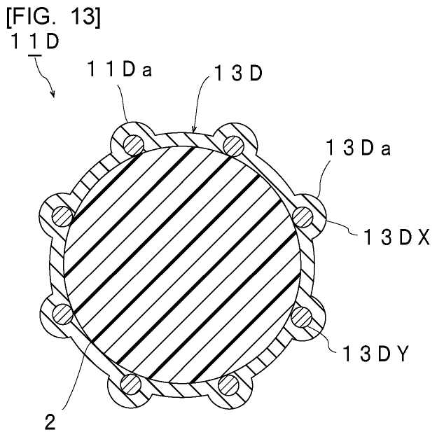

FIG. 13 is a cross-sectional view schematically illustrating a metal-containing particle according to a thirteenth embodiment of the present invention.

A metal-containing particle 11D includes a base particle 2 and a metal section 13D as illustrated in FIG. 13.

The metal-containing particle 11 and the metal-containing particle 11D are different from each other only in the metal section.

The metal section 13D has a first metal section 13DX and a second metal section 13DY. The metal-containing particle 11D has a plurality of protrusions 11Da that the outer surface of the metal section 13D has. The outer surface of the metal section 13D has a plurality of protrusions 13Da. The outer surface of the second metal section 13DY has a plurality of protrusions. The shape of the plurality of protrusions 11Da and 13Da is a shape of a part of a sphere and is a hemispherical shape in the present embodiment.

The second metal section 13DY is a particle and is, for example, solder. The first metal section 13DX is a portion excluding the second metal section 13DY of the metal section 13D. The second metal section 13DY is melt-deformable at 400° C. or less. The melting point of the first metal section 13DX is more than 400° C. The first metal section 13DX is not melt-deformed at 400° C.

The second metal section 13DY is disposed inside the protrusions 11Da and 13Da. One second metal section 13DY is disposed inside one protrusion 11Da and inside one protrusion 13Da. In the present embodiment, the protrusions 11Da and 13Da include the second metal section 13DY capable of metal-diffusing at 400° C. or less. In addition, by the presence of the second metal section 13DY, in the protrusions 11Da and 13Da, metal diffusion occurs between the second metal section 13DY and the first metal section 13DX and a protrusion melt-deformable at 400° C. or less is formed. Alternatively, the protrusions 11Da and 13Da are melt-deformable at 400° C. or less by the second metal section 13DY.

As in the metal-containing particles 11 and 11D, the shape of each of the plurality of protrusions can be appropriately changed and the tip of each of the plurality of protrusions may not be sharp.

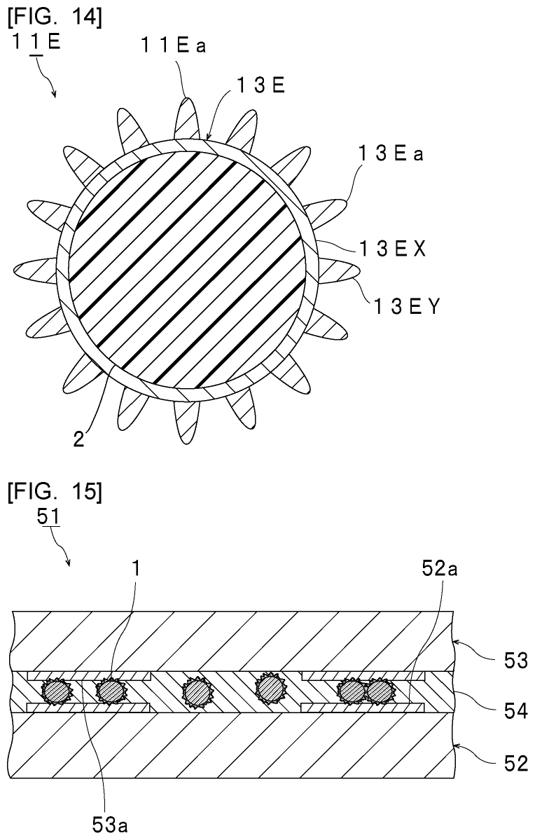

FIG. 14 is a cross-sectional view schematically illustrating a metal-containing particle according to a fourteenth embodiment of the present invention.

A metal-containing particle 11E includes a base particle 2 and a metal section 13E as illustrated in FIG. 14.

The metal-containing particle 11 and the metal-containing particle 11E are different from each other only in the metal section.

The metal section 13E has a first metal section 13EX and a second metal section 13EY. The first and second metal sections 13EX and 13EY are disposed on the surface of the base particle 2.

The first metal section 13EX is disposed between the base particle 2 and the second metal section 13EY. Hence, the first metal section 13EX is disposed on the surface of the base particle 2 and the second metal section 13EY is disposed on the outer surface of the first metal section 13EX. The outer shape of the first metal section 13EX is a spherical shape. The metal-containing particle 11E has a plurality of protrusions 11Ea that the outer surface of the metal section 13E has. The outer surface of the metal section 13E has a plurality of protrusions 13Ea. A plurality of second metal sections 13EY are disposed in a partial region on the outer surface of the first metal section 13EX. The second metal section 13EY itself is a protrusion. The shape of the plurality of protrusions 11Ea and 13Ea is a tapered needle shape and is a shape of paraboloid of revolution in the present embodiment.

The second metal section 13EY is a particle having a shape of paraboloid of revolution and is, for example, solder or a solder alloy. The second metal section 13EY is melt-deformable at 400° C. or less. The melting point of the first metal section 13EX is more than 400° C. The first metal section 13EX is not melt-deformed at 400° C.

In the present embodiment, the protrusions 11Ea and 13Ea include the second metal section 13EY capable of metal-diffusing at 400° C. or less. Alternatively, the protrusions 11Ea and 13Ea are melt-deformable at 400° C. or less by the second metal section 13EY.

As in the metal-containing particle 11E, a metal section meltable at 400° C. or less may be located on the outer surface of the metal section in order that the protrusions are melt-deformable.

Hereinafter, the metal-containing particles will be described in more detail. Incidentally, in the following description, “(meth)acrylic” means either or both of “acrylic” and “methacrylic” and “(meth)acryloxy” means either or both of “acryloxy” and “methacryloxy”. In addition, “(meth)acrylo” means either or both of “acrylo” and “methacrylo”, and “(meth)acrylate” means either or both of “acrylate” and “methacrylate”.

### [Base Particle]

Examples of the base particle include resin particles, inorganic particles excluding metal particles, organic-inorganic hybrid particles, and metal particles. The base particle may have a core and a shell disposed on the surface of the core or may be a core-shell particle. The base particle is preferably base particles excluding metal particles and more preferably resin particles, inorganic particles excluding metal particles, or organic-inorganic hybrid particles.

The base particles are still more preferably resin particles or organic-inorganic hybrid particles and may be resin particles or organic-inorganic hybrid particles. Metal-containing particles suitable for an application for connecting two connection target members are obtained by the use of these preferred base particles.

When the base particle is resin particles or organic-inorganic hybrid particles, the metal-containing particle is likely to be deformed and the flexibility of the metal-containing particle is enhanced. For this reason, shock absorption is enhanced after connection.

Various organic substances are suitably used as the resin for forming the resin particles. Examples of the resin for forming the resin particles include polyolefin resins such as polyethylene, polypropylene, polystyrene, polyvinyl chloride, polyvinylidene chloride, polyisobutylene, and polybutadiene; acrylic resins such as polymethyl methacrylate, and polymethyl acrylate; polyalkylene terephthalate, polycarbonate, polyamide, a phenol formaldehyde resin, a melamine formaldehyde resin, a benzoguanamine formaldehyde resin, a urea formaldehyde resin, a phenol resin, a melamine resin, a benzoguanamine resin, a urea resin, an epoxy resin, an unsaturated polyester resin, a saturated polyester resin, polysulfone, polyphenylene oxide, polyacetal, polyimide, polyamideimide, polyether ether ketone, polyether sulfone, and a polymer obtained by polymerizing one or two or more of various polymerizable monomers having an ethylenically unsaturated group. It is preferable that the resin for forming the resin particles is a polymer obtained by polymerizing one or two or more polymerizable monomers having a plurality of ethylenically unsaturated groups since resin particles exhibiting physical properties at the time of arbitrary compression suitable for an application for connecting two connection target members can be designed and synthesized and the hardness of base particle can be easily controlled to a suitable range.

When the resin particle is obtained by polymerizing a polymerizable monomer having an ethylenically unsaturated group, the polymerizable monomer having an ethylenically unsaturated group includes a non-crosslinkable monomer and a crosslinkable monomer.

Examples of the non-crosslinkable monomer include styrene-based monomers such as styrene and α-methylstyrene; carboxyl group-containing monomers such as (meth)acrylic acid, maleic acid, and maleic anhydride; alkyl (meth)acrylate compounds such as methyl (meth)acrylate, ethyl (meth)acrylate, propyl (meth)acrylate, butyl (meth) acrylate, 2-ethylhexyl (meth) acrylate, lauryl (meth)acrylate, cetyl (meth)acrylate, stearyl (meth)acrylate, cyclohexyl (meth)acrylate, and isobornyl (meth)acrylate; oxygen atom-containing (meth)acrylate compounds such as 2-hydroxyethyl (meth)acrylate, glycerol (meth) acrylate, polyoxyethylene (meth) acrylate, and glycidyl (meth)acrylate; nitrile-containing monomers such as (meth)acrylonitrile; vinyl ether compounds such as methyl vinyl ether, ethyl vinyl ether, and propyl vinyl ether; acid vinyl ester compounds such as vinyl acetate, vinyl butyrate, vinyl laurate, and vinyl stearate; unsaturated hydrocarbons such as ethylene, propylene, isoprene, and butadiene; and halogen-containing monomers such as trifluoromethyl (meth)acrylate, pentafluoroethyl (meth)acrylate, vinyl chloride, vinyl fluoride, and chlorostyrene.

Examples of the crosslinkable monomer include polyfunctional (meth)acrylate compounds such as tetramethylolmethane tetra(meth)acrylate, tetramethylolmethane tri(meth)acrylate, tetramethylolmethane di(meth)acrylate, trimethylolpropane tri(meth)acrylate, dipentaerythritol hexa(meth)acrylate, dipentaerythritol penta(meth)acrylate, glycerol tri(meth)acrylate, glycerol di(meth)acrylate, (poly)ethylene glycol di(meth)acrylate, (poly) propylene glycol di(meth)acrylate, (poly)tetramethylene glycol di(meth)acrylate, and 1,4-butanediol di(meth)acrylate; silane-containing monomers such as triallyl (iso)cyanurate, triallyl trimellitate, divinyl benzene, diallyl phthalate, diallyl acrylamide, diallyl ether, γ-(meth) acryloxypropyltrimethoxysilane, trimethoxysilylstyrene, and vinyltrimethoxysilane.

The resin particle can be obtained by polymerizing the polymerizable monomer having an ethylenically unsaturated group by known methods. Examples of this method include a method in which suspension polymerization is performed in the presence of a radical polymerization initiator and a method in which a monomer is swelled and polymerized together with a radical polymerization initiator using a non-crosslinked seed particle.

When the base particle is inorganic particles excluding metal particles or organic-inorganic hybrid particles, examples of the inorganic substance for forming the base particle include silica, alumina, barium titanate, zirconia, and carbon black. It is preferable that the inorganic substance is not a metal. The particle formed of silica is not particularly limited, but examples thereof include particles obtained by hydrolyzing a silicon compound having two or more hydrolyzable alkoxysilyl groups to form crosslinked polymer particles and then, if necessary, performing firing. Examples of the organic-inorganic hybrid particle include organic-inorganic hybrid particles formed of crosslinked alkoxysilyl polymer and an acrylic resin.

The organic-inorganic hybrid particle is preferably a core-shell type organic-inorganic hybrid particle having a core and a shell disposed on the surface of the core. It is preferable that the core is an organic core. It is preferable that the shell is an inorganic shell. The base particle is preferably an organic-inorganic hybrid particle having an organic core and an inorganic shell disposed on the surface of the organic core from the viewpoint of effectively enhancing the connection reliability.

Examples of a material for forming the inorganic shell include the inorganic substance for forming the base particle described above. The material for forming the inorganic shell is preferably silica. The inorganic shell is preferably formed by forming a metal alkoxide into a shell-shaped substance on the surface of the core by a sol-gel method and then firing the shell-shaped substance. The metal alkoxide is preferably a silane alkoxide. The inorganic shell is preferably formed of a silane alkoxide.

The particle diameter of the core is preferably 0.5 μm or more, more preferably 1 μm or more and preferably 500 μm or less, more preferably 100 μm or less, still more preferably 50 μm or less, particularly preferably 20 μm or less, most preferably 10 μm or less. When the particle diameter of the core is the lower limit or more and the upper limit or less, the metal-containing particle can be suitably used for an application for connecting two connection target members. For example, when the particle diameter of the core is the lower limit or more and the upper limit or less, the contact area between the metal-containing particles and the connection target member is sufficiently large when two connection target members are connected using the metal-containing particles and the metal-containing particles aggregated when forming the metal section are less likely to be formed. Moreover, the space between two connection target members connected via the metal-containing particle is not too large and the metal section hardly peels off from the surface of the base particle.

The particle diameter of the core means the diameter when the core is a perfect spherical shape and means the maximum diameter when the core is in a shape other than a perfect spherical shape. In addition, the particle diameter of the core means the average particle diameter of the core measured using an arbitrary particle diameter measuring apparatus. For example, a particle size distribution measuring machine using principles such as laser light scattering, change in electric resistance value, and image analysis after imaging can be utilized.

The thickness of the shell is preferably 100 nm or more, more preferably 200 nm or more and preferably 5 μm or less, more preferably 3 μm or less. When the particle diameter of the shell is the lower limit or more and the upper limit or less, the metal-containing particle can be suitably used for an application for connecting two connection target members. The thickness of the shell is an average thickness per one base particle. The thickness of the shell can be controlled by controlling the sol-gel method.

When the base particle is a metal particle, examples of the metal for forming the metal particle include silver, copper, nickel, silicon, gold, and titanium. However, it is preferable that the base particle is not a metal particle.

The particle diameter of the base particles is preferably 0.1 μm or more, more preferably 0.5 μm or more, still more preferably 1 μm or more, still more preferably 1.5 μm or more, and particularly preferably 2 μm or more. The particle diameter of the base particles is preferably 1,000 μm or less, more preferably 500 μm or less, still more preferably 400 μm or less, yet more preferably 100 μm or less, yet more preferably 50 μm or less, yet still more preferably 30 μm or less, particularly preferably 5 μm or less, and most preferably 3 μm or less. The connection reliability is still further enhanced when the particle diameter of the base particle is the lower limit or more. Furthermore, the metal-containing particles hardly aggregate and aggregated metal-containing particles are hardly formed when a metal section is formed on the surface of the base particles by electroless plating. When the average particle diameter of the base particles is the upper limit or less, the metal-containing particles are likely to be sufficiently compressed and the connection reliability is still further enhanced.

The particle diameter of the base particle denotes the diameter when the base particle has a perfect spherical shape and denotes the maximum diameter when the base particle does not have a perfect spherical shape.

The base particle is preferably a particle (silicone particle) containing a silicone resin from the viewpoint of still further suppressing the occurrence of cracking or peeling off of the connection section in the heat cycle test for connection reliability and still further suppressing the occurrence of cracking at the time of stress loading. The material of the base particle preferably contains a silicone resin.

The material of the silicone particles is preferably a silane compound having a radically polymerizable group and a silane compound having a hydrophobic group having 5 or more carbon atoms, a silane compound having a radically polymerizable group and a hydrophobic group having 5 or more carbon atoms, or a silane compound having a radically polymerizable group at both terminals. A siloxane bond is formed when these materials are reacted. In the silicone particles obtained, the radically polymerizable group and the hydrophobic group having 5 or more carbon atoms generally remain. By using such a material, silicone particles having a primary particle diameter of 0.1 μm or more and 500 μm or less can be easily obtained, moreover, the chemical resistance of the silicone particles can be enhanced, and the moisture permeability can be diminished.

In the silane compound having a radically polymerizable group, the radically polymerizable group is preferably directly bound to a silicon atom. Only one silane compound having a radically polymerizable group may be used, or two or more silane compounds having a radically polymerizable group may be used concurrently.

The silane compound having a radically polymerizable group is preferably an alkoxysilane compound. Examples of the silane compound having a radically polymerizable group include vinyltrimethoxysilane, vinyltriethoxysilane, dimethoxymethylvinylsilane, diethoxymethylvinylsilane, divinylmethoxyvinylsilane, divinylethoxyvinylsilane, divinyldimethoxysilane, divinyldiethoxysilane, and 1,3-divinyltetramethyldisiloxane.

In the silane compound having a hydrophobic group having 5 or more carbon atoms, the hydrophobic group having 5 or more carbon atoms is preferably directly bound to a silicon atom. Only one silane compound having a hydrophobic group having 5 or more carbon atoms may be used, or two or more silane compounds having a hydrophobic group having 5 or more carbon atoms may be used concurrently.

The silane compound having a hydrophobic group having 5 or more carbon atoms is preferably an alkoxysilane compound. Examples of the silane compound having a hydrophobic group having 5 or more carbon atoms include phenyltrimethoxysilane, dimethoxymethylphenylsilane, diethoxymethylphenylsilane, dimethylmethoxyphenylsilane, dimethylethoxyphenylsilane, hexaphenyldisiloxane, 1,3,3,5-tetramethyl-1,1,5,5-tetrapenyltrisiloxane, 1,1,3,5,5-pentaphenyl-1,3,5-trimethyltrisiloxane, hexaphenylcyclotrisiloxane, phenyltris(trimethylsiloxy)silane, and octaphenylcyclotetrasiloxane.

In the silane compound having a radically polymerizable group and a hydrophobic group having 5 or more carbon atoms, the radically polymerizable group is preferably directly bound to a silicon atom and the hydrophobic group having 5 or more carbon atoms is preferably directly bound to a silicon atom. Only one silane compound having a radically polymerizable group and a hydrophobic group having 5 or more carbon atoms may be used, or two or more silane compounds having a radically polymerizable group and a hydrophobic group having 5 or more carbon atoms may be used concurrently.

Examples of the silane compound having a radically polymerizable group and a hydrophobic group having 5 or more carbon atoms include phenylvinyldimethoxysilane, phenylvinyldiethoxysilane, phenylmethylvinylmethoxysilane, phenylmethylvinylethoxysilane, diphenylvinylmethoxysilane, diphenylvinylethoxysilane, phenyldivinylmethoxysilane, phenyldivinylethoxysilane, and 1,1,3,3-tetraphenyl-1,3-divinyldisiloxane.

When the silane compound having a radically polymerizable group and the silane compound having a hydrophobic group having 5 or more carbon atoms are used in order to obtain silicone particles, the silane compound having a radically polymerizable group and the silane compound having a hydrophobic group having 5 or more carbon atoms are used preferably at a weight ratio of 1:1 to 1:20 and more preferably at a weight ratio 1:5 to 1:15.

In the entire silane compound for obtaining silicone particles, the number of radically polymerizable groups and the number of hydrophobic groups having 5 or more carbon atoms are preferably 1:0.5 to 1:20 and more preferably 1:1 to 1:15.

From the viewpoint of effectively enhancing the chemical resistance, effectively diminishing the moisture permeability, and controlling the 10% K value in the preferred range, the silicone particles preferably have a dimethylsiloxane skeleton in which two methyl groups are bound to one silicon atom and the material of the silicone particles preferably contains a silane compound in which two methyl groups are bound to one silicon atom.

From the viewpoint of effectively enhancing the chemical resistance, effectively diminishing the moisture permeability, and controlling the 10% K value in a suitable range, it is preferable that the silane compound is reacted with a radical polymerization initiator and a siloxane bond is formed in the silicone particles. In general, it is difficult to obtain silicone particles having a primary particle diameter of 0.1 μm or more and 500 μm or less and it is particularly difficult to obtain silicone particles having a primary particle diameter of 100 μm or less using a radical polymerization initiator. In contrast, even when a radical polymerization initiator is used, it is possible to obtain silicone particles having a primary particle diameter of 0.1 μm or more and 500 μm or less and to obtain silicone particles having a primary particle diameter of 100 μm or less by use of the above-mentioned silane compounds.

A silane compound having a hydrogen atom bound to a silicon atom may not be used in order to obtain the silicone particles. In this case, the silane compound can be polymerized using a radical polymerization initiator without using a metal catalyst. As a result, the silicone particles can be free of metal catalyst, the content of metal catalyst in the silicone particles can be decreased, further the chemical resistance can be effectively enhanced, the moisture permeability can be effectively diminished, and the 10% K value can be controlled in a suitable range.

As a specific method for manufacturing the silicone particles, there is a method in which silicone particles are fabricated by performing the polymerization reaction of a silane compound by a suspension polymerization method, a dispersion polymerization method, a mini-emulsion polymerization method, an emulsion polymerization method or the like. Silicone particles are fabricated by advancing the polymerization of a silane compound to obtain an oligomer and then performing the polymerization reaction of the silane compound which is a polymer (oligomer or the like) by a suspension polymerization method, a dispersion polymerization method, a mini-emulsion polymerization method, an emulsion polymerization method or the like. For example, a silane compound having a vinyl group may be polymerized to obtain a silane compound having a vinyl group bound to a silicon atom at a terminal. A silane compound having a phenyl group may be polymerized to obtain a silane compound having a phenyl group bound to a silicon atom in a side chain as a polymer (oligomer or the like). A silane compound having a vinyl group and a silane compound having a phenyl group may be polymerized to obtain a silane compound having a vinyl group bound to a silicon atom at a terminal and a phenyl group bound to a silicon atom in a side chain as a polymer (oligomer or the like).

The outer surface of the silicone particle may have a plurality of particles. In this case, the silicone particle may include a silicone particle body and a plurality of particles disposed on the surface of the silicone particle body. Examples of the plurality of particles include silicone particles and spherical silica. The aggregation of silicone particles can be suppressed by the presence of the plurality of particles.

### [Metal Section]

The tip of the protrusion in the metal-containing particle is meltable at 400° C. or less. The tip of the protrusion in the metal-containing particle is more preferably meltable at 350° C. or less, more preferably meltable at 300° C. or less, still more preferably meltable at 250° C. or less, and particularly preferably meltable at 200° C. or less. It is preferable that the tip of the protrusion of the metal section is meltable at 400° C. or less. The tip of the protrusion of the metal section is preferably meltable at 350° C. or less, more preferably meltable at 300° C. or less, still more preferably meltable at 250° C. or less, and particularly preferably meltable at 200° C. or less. As the tip of the protrusion of the metal section satisfies the preferred aspect, the energy consumption at the time of heating can be suppressed, and further, the thermal degradation of the connection target member and the like can be suppressed. The melting temperature of the tip of the protrusion can be controlled by the kind of metal of the tip and the shape of the tip of the protrusion. The melting point at the base of the convex, the central position of the height of the protrusion in the metal-containing particle, the base of the protrusion in the metal-containing particle, and the central position of the height of the protrusion in the metal-containing particle may be more than 200° C. The melting point may be more than 250° C., more than 300° C., more than 350° C., or more than 400° C. The metal section, the convexes, and the protrusions may have a portion having a melting point of more than 200° C., a portion having a melting point of more than 250° C., a portion having a melting point of more than 300° C., a portion having a melting point of more than 350° C., or a portion having a melting point of more than 400° C.

Each of the plurality of protrusions of the metal section contains a component capable of metal-diffusing at 400° C. or less or is melt-deformable at 400° C. or less. It is possible to form a metallic bond between the bonding portions by lowering the temperature at which the metal can diffuse. For this reason, the temperature at which the metal can diffuse is preferably 350° C. or less, more preferably 300° C. or less, still more preferably 250° C. or less, and particularly preferably 200° C. or less. The temperature at which the metal can diffuse can be controlled by the kind of metal.

Alternatively, it is preferable that the protrusions of the metal section are melt-deformable at 400° C. or less.

The protrusions of the metal section are preferably melt-deformable at 350° C. or less, more preferably melt-deformable at 300° C. or less, still more preferably melt-deformable at 250° C. or less, and particularly preferably melt-deformable at 200° C. or less. When the melt-deformation temperature of the protrusions of the metal section is in the above preferred range, the melt-deformation temperature can be lowered, the energy consumption at the time of heating can be suppressed, and further, the thermal degradation of the connection target member and the like can be suppressed. The melt-deformation temperature of the protrusions can be controlled by the kind of metal of the protrusions. The metal section and the protrusions may have a portion having a melt-deformation temperature of more than 200° C., a portion having a melt-deformation temperature of more than 250° C., a portion having a melt-deformation temperature of more than 300° C., a portion having a melt-deformation temperature of more than 350° C., or a portion having a melt-deformation temperature of more than 400° C.

The material of the metal section is not particularly limited. The material of the metal section preferably contains a metal. Examples of the metal include gold, silver, palladium, rhodium, iridium, lithium, copper, platinum, zinc, iron, tin, lead, ruthenium, aluminum, cobalt, indium, nickel, chromium, titanium, antimony, bismuth, thallium, germanium, cadmium, silicon, and alloys thereof. Moreover, examples of the metal include a tin-doped indium oxide (ITO).

In the present invention, the material of the metal section is selected so that the tip of the protrusion in the metal-containing particle is meltable at 400° C. or less.

In the present invention, it is preferable that the material of the metal section is selected so that the protrusions of the metal section are melt-deformable at 400° C. or less. The metal section preferably contains solder.

It is preferable that the material of the protrusions in the metal-containing particles contains silver, copper, gold, palladium, tin, indium, or zinc from the viewpoint of effectively enhancing the connection reliability. The material of the protrusions is preferably contained in the protrusions of the metal section. The material of the protrusions in the metal-containing particle may not contain tin.

It is preferable that the material of the metal section is not solder. As the material of the metal section is not solder, excessive melting of the entire metal sections can be suppressed. The material of the metal section may not contain tin.

The material of the metal section preferably contains silver, copper, gold, palladium, tin, indium, zinc, nickel, cobalt, iron, tungsten, molybdenum, ruthenium, platinum, rhodium, iridium, phosphorus, or boron, more preferably contains silver, copper, gold, palladium, tin, indium, or zinc, and still more preferably contains silver. When the material of the metal section is the preferred materials, the connection reliability can be still further effectively enhanced. As the material of the metal section, only one material may be used or two or more materials may be used concurrently. The silver may be contained as silver simple substance or as silver oxide from the viewpoint of effectively enhancing the connection reliability. Examples of silver oxide include Ag₂O and AgO.

The content of silver in 100% by weight of the metal section containing silver is preferably 0.1% by weight or more, more preferably 1% by weight or more, preferably 100% by weight or less, more preferably 90% by weight or less, and may be 80% by weight or less, 60% by weight or less, 40% by weight or less, 20% by weight or less, or 10% by weight or less. The bonding strength increases and the connection reliability is still further enhanced when the content of silver is the lower limit or more and the upper limit or less.

The copper may be contained as copper simple substance or as copper oxide.

The content of copper in 100% by weight of the metal section containing copper is preferably 0.1% by weight or more, more preferably 1% by weight or more, preferably 100% by weight or less, more preferably 90% by weight or less, and may be 80% by weight or less, 60% by weight or less, 40% by weight or less, 20% by weight or less, or 10% by weight or less. The bonding strength increases and the connection reliability is still further enhanced when the content of copper is the lower limit or more and the upper limit or less.

The nickel may be contained as nickel simple substance or as nickel oxide.

The content of nickel is preferably 0.1% by weight or more and more preferably 1% by weight or more in 100% by weight of the metal section containing nickel. The content of nickel in 100% by weight of the metal section containing nickel is preferably 100% by weight or less, more preferably 90% by weight or less and may be 80% by weight or less, 60% by weight or less, 40% by weight or less, 20% by weight or less, or 10% by weight or less. The bonding strength increases and the connection reliability is still further enhanced when the content of nickel is the lower limit or more and the upper limit or less.

It is preferable that the solder is a metal (low melting point metal) having a melting point of 450° C. or less. The low melting point metal means a metal having a melting point of 450° C. or less. The melting point of the low melting point metal is preferably 300° C. or less and more preferably 160° C. or less. In addition, the solder contains tin. The content of tin in 100% by weight of the metals contained in the solder is preferably 30% by weight or more, more preferably 40% by weight or more, still more preferably 70% by weight or more, and particularly preferably 90% by weight or more. The connection reliability is still further enhanced when the content of tin in the solder is the lower limit or more.

Incidentally, the content of tin can be measured using a high-frequency inductively coupled plasma atomic emission spectrometer (“ICP-AES” manufactured by HORIBA, Ltd.) or an X-ray fluorescence spectrometer (“EDX-800HS” manufactured by Shimadzu Corporation).

As the solder is used, the solder melts and bonds to the electrodes and the solder conducts between the electrodes. For example, the solder and the electrode are likely to be in surface contact rather than point contact, and thus the connection resistance is lowered. Moreover, the bonding strength between the solder and the electrode increases by the use of solder, as a result, peeling off between the solder and the electrode still further hardly occurs and the conduction reliability and the connection reliability are effectively enhanced.

The low melting point metal constituting the solder is not particularly limited. The low melting point metal is preferably tin or an alloy containing tin. Examples of the alloy include a tin-silver alloy, a tin-copper alloy, a tin-silver-copper alloy, a tin-bismuth alloy, a tin-zinc alloy, and a tin-indium alloy. The low melting point metal is preferably tin, a tin-silver alloy, a tin-silver-copper alloy, a tin-bismuth alloy, and a tin-indium alloy because of excellent wettability to the electrode. The low melting point metal is more preferably a tin-bismuth alloy and a tin-indium alloy.

It is preferable that the solder is a filler material having a liquidus line of 450° C. or less based on JISZ3001: welding term. Examples of the composition of the solder include metal compositions containing zinc, gold, silver, lead, copper, tin, bismuth, indium and the like. A tin-indium-based alloy (eutectic at 117° C.) or tin-bismuth-based alloy (eutectic at 139° C.) which has a low melting point and is free of lead is preferable. In other words, the solder preferably does not contain lead but preferably contains tin and indium or tin and bismuth.

In order to still further increase the connection strength, the solder may contain metals such as nickel, copper, antimony, aluminum, zinc, iron, gold, titanium, phosphorus, germanium, tellurium, cobalt, bismuth, manganese, chromium, molybdenum, and palladium. In addition, the solder preferably contains nickel, copper, antimony, aluminum, or zinc from the viewpoint of still further enhancing the connection strength. The content of these metals for enhancing the bonding strength is preferably 0.0001% by weight or more and preferably 1% by weight or less in 100% by weight of the solder from the viewpoint of still further enhancing the connection strength.

The metal section may be formed of one layer. The metal section may be formed of a plurality of layers.

The outer surface of the metal section may be rustproofed. The metal-containing particle may have a rustproof film on the outer surface of the metal section. Examples of the rustproofing treatment include a method in which a rust preventive agent is disposed on the outer surface of metal section, a method in which the outer surface of metal section is alloyed to improve the corrosion resistance, and a method in which the outer surface of metal section is coated with a highly corrosion resistant metal film. Examples of the rust preventive agent include nitrogen-containing heterocyclic compounds such as benzotriazole compounds and imidazole compounds; sulfur-containing compounds such as mercaptan compounds, thiazole compounds, and organic disulfide compounds; and phosphorus-containing compounds such as organic phosphoric acid compounds.

[Metal Film]

The metal film covers the outer surface of the metal section. The portion of the metal film covering the tip of the protrusion of the metal section is preferably meltable at 400° C. or less, preferably meltable at 350° C. or less, more preferably meltable at 300° C. or less, still more preferably meltable at 250° C. or less, and particularly preferably meltable at 200° C. or less. As the portion covering the tip of the protrusion of the metal section of the metal film satisfies the preferred aspect, the energy consumption at the time of heating can be suppressed, and further, the thermal degradation of the connection target member and the like can be suppressed. The melting temperature of the portion covering the tip of the protrusion of the metal section of the metal film can be controlled by the raw materials, thickness and the like of the metal film. The melting point of a portion other than the portion covering the tip of the protrusion of the metal section of the metal film may be more than 200° C., more than 250° C., more than 300° C., more than 350° C., or more than 400° C. The metal film may have a portion having a melting point of more than 200° C., a portion having a melting point of more than 250° C., a portion having a melting point of more than 300° C., a portion having a melting point of more than 350° C., or a portion having a melting point of more than 400° C.

The material of the metal film is not particularly limited. The material of the metal film preferably contains a metal. Examples of the metal include gold, silver, palladium, rhodium, iridium, lithium, copper, platinum, zinc, iron, tin, lead, ruthenium, aluminum, cobalt, indium, nickel, chromium, titanium, antimony, bismuth, thallium, germanium, cadmium, silicon, and alloys thereof. Moreover, examples of the metal include a tin-doped indium oxide (ITO).

The material of the metal film is appropriately selected so that the effects of the present invention can be effectively exerted.

The material of the metal film preferably contains gold, palladium, platinum, rhodium, ruthenium, or iridium and more preferably contains gold from the viewpoint of effectively enhancing the connection reliability.

Oxidation or sulfurization of the metal section can be effectively suppressed when the material of the metal film is the preferred materials. As a result, the connection reliability can be effectively enhanced. In addition, when a voltage is applied to the connection member under environmental conditions in which the moisture content (humidity) is high, ion migration phenomenon that ionized metals migrate between electrodes and a short circuit occurs is sometimes caused, and this causes deterioration in the insulation reliability. When the material of the metal film is the preferred materials, the ion migration phenomenon can be suppressed and the insulation reliability can be enhanced. As the material of the metal film, only one material may be used or two or more materials may be used concurrently.

The content of gold in 100% by weight of the metal film containing gold is preferably 0.1% by weight or more, more preferably 0.5% by weight or more, preferably 100% by weight or less, more preferably 90% by weight or less, and may be 80% by weight or less, 60% by weight or less, 40% by weight or less, 20% by weight or less, or 10% by weight or less. The bonding strength increases and the connection reliability is still further enhanced when the content of gold is the lower limit or more and the upper limit or less. In addition, the ion migration phenomenon can be suppressed and the insulation reliability can be enhanced when the content of gold is the lower limit or more and the upper limit or less.

The metal film may be formed of one layer. The metal film may be formed of a plurality of layers.

The outer surface of the metal film may be rustproofed. The metal-containing particle may have a rustproof film on the outer surface of the metal film. Examples of the rustproofing treatment include a method in which a rust preventive agent is disposed on the outer surface of metal film, a method in which the outer surface of metal film is alloyed to improve the corrosion resistance, and a method in which the outer surface of metal film is coated with a highly corrosion resistant metal film. Examples of the rust preventive agent include nitrogen-containing heterocyclic compounds such as benzotriazole compounds and imidazole compounds; sulfur-containing compounds such as mercaptan compounds, thiazole compounds, and organic disulfide compounds; and phosphorus-containing compounds such as organic phosphoric acid compounds.

[Rustproofing Treatment]

It is preferable that the outer surface of the metal section or metal film is subjected to a rustproofing treatment or anti-sulfurization treatment in order to suppress the corrosion of the metal-containing particles and to lower the connection resistance between the electrodes.

Examples of the anti-sulfurization agent, rust preventive agent, and anti-tarnish agent include nitrogen-containing heterocyclic compounds such as benzotriazole compounds and imidazole compounds; sulfur-containing compounds such as mercaptan compounds, thiazole compounds, and organic disulfide compounds; and phosphorus-containing compounds such as organic phosphoric acid compounds.

It is preferable that the outer surface of the metal section or metal film is rustproofed with a compound having an alkyl group having 6 to 22 carbon atoms from the viewpoint of still further enhancing the conduction reliability. The surface of the metal section or metal film may be rustproofed with a compound which does not contain phosphorus or rustproofed with a compound which has an alkyl group of 6 to 22 carbon atoms but does not contain phosphorus. It is preferable that the outer surface of the metal section or metal film is rustproofed with an alkyl phosphate compound or an alkyl thiol from the viewpoint of still further enhancing the conduction reliability. A rustproof film can be formed on the outer surface of the metal section or metal film by the rustproofing treatment.

The rustproof film is preferably formed of a compound having an alkyl group having 6 to 22 carbon atoms (hereinafter also referred to as compound A). It is preferable that the outer surface of the metal section or metal film is subjected to a surface treatment using the compound A. Rusting is further less likely to occur in the entire metal sections or the entire metal films when the number of carbon atoms of the alkyl group is 6 or more. The electrical conductivity of metal-containing particle is enhanced when the number of carbon atoms of the alkyl group is 22 or less. The number of carbon atoms of the alkyl group in the compound A is preferably 16 or less from the viewpoint of still further enhancing the electrical conductivity of the metal-containing particle. The alkyl group may have a linear structure or a branched structure. The alkyl group preferably has a linear structure.

The compound A is not particularly limited as long as it has an alkyl group having 6 to 22 carbon atoms. The compound A is preferably a phosphoric acid ester having an alkyl group having 6 to 22 carbon atoms or a salt thereof, a phosphorous acid ester having an alkyl group having 6 to 22 carbon atoms or a salt thereof, an alkoxysilane having an alkyl group having 6 to 22 carbon atoms, and an alkylthiol having an alkyl group having 6 to 22 carbon atoms. The compound A is also preferably a dialkyl disulfide having an alkyl group having 6 to 22 carbon atoms. In other words, the compound A having an alkyl group having 6 to 22 carbon atoms is preferably a phosphoric acid ester or a salt thereof, a phosphorous acid ester or a salt thereof, an alkoxysilane, an alkylthiol, or a dialkyl disulfide. Rusting of the metal section or the metal film can be still further prevented by the use of these preferred compounds A. From the viewpoint of still further preventing rusting, the compound A is preferably the phosphoric acid ester or a salt thereof, the phosphorous acid ester or a salt thereof, or the alkylthiol and more preferably the phosphoric acid ester or a salt thereof or the phosphorous acid ester or a salt thereof. As the compound A, only one compound may be used or two or more compounds may be used concurrently.

It is preferable that the compound A has a reactive functional group capable of reacting with the outer surface of the metal section or metal film. It is preferable to have a reactive functional group capable of reacting with the outer surface of nickel of the metal section when the metal section contains nickel and it is preferable to have a reactive functional group capable of reacting with the outer surface of gold of the metal film when the metal film contains gold. When the metal-containing particle contains an insulating substance disposed on the outer surface of the metal section or metal film, the compound A preferably has a reactive functional group capable of reacting with the insulating substance. The rustproof film is preferably chemically bound to the metal section or the metal film. The rustproof film is preferably chemically bound to the insulating substance. The rustproof film is more preferably chemically bound to the metal section or the metal film and the insulating substance. By the presence of the reactive functional group and the chemical binding, the rustproof film is less likely to peel off, and as a result, the metal section or the metal film is further less likely to rust, and the insulating substance is further less likely to be unintentionally detached from the surface of the metal-containing particle.

Examples of the phosphoric acid ester having an alkyl group having 6 to 22 carbon atoms or a salt thereof include phosphoric acid hexyl ester, phosphoric acid heptyl ester, phosphoric acid monooctyl ester, phosphoric acid monononyl ester, phosphoric acid monodecyl ester, phosphoric acid monoundecyl ester, phosphoric acid monododecyl ester, phosphoric acid monotridecyl ester, phosphoric acid monotetradecyl ester, phosphoric acid monopentadecyl ester, phosphoric acid monohexyl ester monosodium salt, phosphoric acid monoheptyl ester monosodium salt, phosphoric acid monooctyl ester monosodium salt, phosphoric acid monononyl ester monosodium salt, phosphoric acid monodecyl ester monosodium salt, phosphoric acid monoundecyl ester monosodium salt, phosphoric acid monododecyl ester monosodium salt, phosphoric acid monotridecyl ester monosodium salt, phosphoric acid monotetradecyl ester monosodium salt, and phosphoric acid monopentadecyl ester monosodium salt. Potassium salts of the phosphoric acid esters may be used.

Examples of the phosphorous acid ester having an alkyl group having 6 to 22 carbon atoms or a salt thereof include phosphorous acid hexyl ester, phosphorous acid heptyl ester, phosphorous acid monooctyl ester, phosphorous acid monononyl ester, phosphorous acid monodecyl ester, phosphorous acid monoundecyl ester, phosphorous acid monododecyl ester, phosphorous acid monotridecyl ester, phosphorous acid monotetradecyl ester, phosphorous acid monopentadecyl ester, phosphorous acid monohexyl ester monosodium salt, phosphorous acid monoheptyl ester monosodium salt, phosphorous acid monooctyl ester monosodium salt, phosphorous acid monononyl ester monosodium salt, phosphorous acid monodecyl ester monosodium salt, phosphorous acid monoundecyl ester monosodium salt, phosphorous acid monododecyl ester monosodium salt, phosphorous acid monotridecyl ester monosodium salt, phosphorous acid monotetradecyl ester monosodium salt, and phosphorous acid monopentadecyl ester monosodium salt. Potassium salts of the phosphorous acid esters may be used.

Examples of the alkoxysilane having an alkyl group having 6 to 22 carbon atoms include hexyltrimethoxysilane, hexyltriethoxysilane, and heptyltrimethoxysilane, heptyltriethoxysilane, octyltrimethoxysilane, octyltriethoxysilane, nonyltrimethoxysilane, nonyltriethoxysilane, decyltrimethoxysilane, decyltriethoxysilane, undecyltrimethoxysilane, undecyltriethoxysilane, dodecyltrimethoxysilane, dodecyltriethoxysilane, tridecyltrimethoxysilane, tridecyltriethoxysilane, tetradecyltrimethoxysilane, tetradecyltriethoxysilane, pentadecyltrimethoxysilane, and pentadecyltriethoxysilane.

Examples of the alkylthiol having an alkyl group having 6 to 22 carbon atoms include hexylthiol, heptylthiol, octylthiol, nonylthiol, decylthiol, undecylthiol, dodecylthiol, tridecylthiol, tetradecylthiol, pentadecylthiol, and hexadecylthiol. The alkyl thiol preferably has a thiol group at the terminal of the alkyl chain.

Examples of the dialkyl disulfide having an alkyl group having 6 to 22 carbon atoms include dihexyl disulfide, diheptyl disulfide, dioctyl disulfide, dinonyl disulfide, didecyl disulfide, diundecyl disulfide, didodecyl disulfide, ditridecyl disulfide, ditetradecyl disulfide, dipentadecyl disulfide, and dihexadecyl disulfide.

From the viewpoint of still further enhancing the conduction reliability, it is preferable that the outer surface of the metal section or metal film is subjected to an anti-sulfurization treatment by a layer formed using any of a sulfur-containing compound containing a sulfide compound or a thiol compound as a main component, a benzotriazole compound, or a polyoxyethylene ether surfactant. A rustproofing film can be formed on the outer surface of the metal section or metal film by the anti-sulfurization treatment.

Examples of the sulfide compound include linear or branched dialkyl sulfides (alkyl sulfides) having about 6 to 40 carbon atoms (preferably about 10 to 40 carbon atoms) such as dihexyl sulfide, diheptyl sulfide, dioctyl sulfide, didecyl sulfide, didodecyl sulfide, ditetradecyl sulfide, dihexadecyl sulfide, and dioctadecyl sulfide; aromatic sulfides having about 12 to 30 carbon atoms such as diphenyl sulfide, phenyl-p-tolyl sulfide, and 4,4-thiobisbenzenethiol; and thiodicarboxylic acids such as 3,3′-thiodipropionic acid and 4,4′-thiodibutanoic acid. The sulfide compound is particularly preferably a dialkyl sulfide.

Examples of the thiol compound include linear or branched alkylthiols having about 4 to 40 (more preferably about 6 to 20) carbon atoms such as 2-mercaptobenzothiazole, 2-mercaptobenzoxazole, 2-mercaptobenzimidazole, 2-methyl-2-propanethiol, and octadecylthiol. Moreover, examples thereof include compounds in which the hydrogen atoms bound to the carbon group of these compounds are substituted with fluorine.

Examples of the benzotriazole compound include benzotriazole, benzotriazole salts, methylbenzotriazole, carboxybenzotriazole, and benzotriazole derivatives.

Moreover, examples of the anti-tarnish agent (anti-tarnish agent for silver) include “AC-20”, “AC-70”, and “AC-80” trade names manufactured by Kitaike Sangyo Co., Ltd., “ENTEC CU-56” trade name manufactured by Meltex Inc., “New Dain Silver” and “New Dain Silver S-1” trade names manufactured by Daiwa Fine Chemicals Co., Ltd., “B-1057” trade name manufactured by Chiyoda Chemicals Co., Ltd., and “B-1009 NS” trade name manufactured by Chiyoda Chemicals Co., Ltd.

The method for forming the metal section and the metal film on the surface of the base particle is not particularly limited. Examples of the method for forming the metal section and the metal film include a method by electroless plating, a method by electroplating, a method by physical vapor deposition, and a method in which the surface of base particle is coated with a paste containing a metal powder or a metal powder and a binder. A method by electroless plating is preferable since the formation of the metal section and the metal film is simple. Examples of the method by physical vapor deposition include methods such as vacuum deposition, ion plating, and ion sputtering.

Examples of the method for forming a protrusion having a tapered needle shape that the outer surface of the metal section has include the following methods.

Method by electroless highly pure nickel plating using hydrazine as a reducing agent. Method by electroless palladium-nickel alloying using hydrazine as a reducing agent. Method by electroless CoNiP alloy plating using a hypophosphorous acid compound as a reducing agent. Method by electroless silver plating using hydrazine as a reducing agent. Method by electroless copper-nickel-phosphorus alloy plating using hypophosphorous acid compound as a reducing agent.

In the method for forming a protrusion by electroless plating, a catalyzing step and an electroless plating step are generally performed. Hereinafter, an example of a method for forming an alloy-plated layer containing copper and nickel and a protrusion having a tapered needle shape that the outer surface of a metal section has on the surface of a resin particle by electroless plating will be described.

In the catalyzing step, a catalyst serving as a starting point for forming a plated layer by electroless plating is formed on the surface of a resin particle.

Examples of the method for forming a catalyst on the surface of a resin particle include the following methods.

Method in which resin particles are added to a solution containing palladium chloride and tin chloride and then the surface of the resin particle is activated by an acid solution or an alkaline solution to deposit palladium on the surface of the resin particles. Method in which resin particles are added to a solution containing palladium sulfate and aminopyridine and then the surface of the resin particle is activated by a solution containing a reducing agent to deposit palladium on the surface of the resin particles.

A phosphorus-containing reducing agent is used as the reducing agent. Moreover, a metal section containing phosphorus can be formed as a phosphorus-containing reducing agent is used as the reducing agent.

In the electroless plating step, it is preferable to use a copper-nickel-phosphorus alloy plating solution containing a hypophosphorous acid compound as a reducing agent, a nickel-containing compound as a metal catalyst for initiating the reaction of the reducing agent, and a nonionic surfactant in the method by electroless copper-nickel-phosphorus alloy plating using a plating solution containing a copper-containing compound, a complexing agent, and a reducing agent.

By immersing the resin particles in a copper-nickel-phosphorus alloy plating bath, it is possible to deposit a copper-nickel-phosphorus alloy on the surface on which a catalyst is formed of the resin particles and to form a metal section containing copper, nickel, and phosphorus.

Examples of the copper-containing compound include copper sulfate, cupric chloride, and copper nitrate. The copper-containing compound is preferably copper sulfate.

Examples of the nickel-containing compound include nickel sulfate, nickel chloride, nickel carbonate, nickel sulfamate, and nickel nitrate. The nickel-containing compound is preferably nickel sulfate.

Examples of the phosphorus-containing reducing agent include hypophosphorous acid and sodium hypophosphite. In addition to the phosphorus-containing reducing agent, a boron-containing reducing agent may be used. Examples of the boron-containing reducing agent include dimethylamine borane, sodium borohydride, and potassium borohydride.

Examples of the complexing agent include monocarboxylic acid complexing agents such as sodium acetate and sodium propionate, dicarboxylic acid complexing agents such as disodium malonate, tricarboxylic acid complexing agents such as disodium succinate, hydroxy acid complexing agents such as lactic acid, DL-malic acid, Rochelle salt, sodium citrate, and sodium gluconate, amino acid complexing agents such as glycine and EDTA, amine complexing agents such as ethylenediamine, organic acid complexing agents such as maleic acid, and salts thereof. The complexing agent is preferably the monocarboxylic acid complexing agent, dicarboxylic acid complexing agent, tricarboxylic acid complexing agent, hydroxy acid complexing agent, amino acid complexing agent, amine complexing agent, organic acid complexing agent, and salts thereof. Only one of these preferred complexing agents may be used, or two or more thereof may be used concurrently.

Examples of the surfactant include anionic surfactants, cationic surfactants, nonionic surfactants, and amphoteric surfactants. In particular, nonionic surfactants are suitable. Preferred nonionic surfactants are polyethers containing an ether oxygen atom. Examples of the preferred nonionic surfactants include polyoxyethylene lauryl ether, polyethylene glycol, polypropylene glycol, polyoxyethylene alkyl ether, polyoxyethylene polyoxypropylene glycol, polyoxyethylene nonylphenyl ether, polyoxyethylene polyoxypropylene alkylamine, and polyoxyalkylene adduct of ethylenediamine. The surfactant is preferably polyoxyethylene monoalkyl ethers such as polyoxyethylene monobutyl ether, polyoxypropylene monobutyl ether, and polyoxyethylene polyoxypropylene glycol monobutyl ether, polyethylene glycol, or phenol ethoxylate. As the surfactant, only one surfactant may be used or two or more surfactants may be used concurrently. Polyethylene glycol having a molecular weight of about 1,000 (for example, 500 or more and 2,000 or less) is particularly preferable.

It is desirable to control the molar ratio of the copper compound to the nickel compound in order to form a protrusion having a tapered needle shape that the outer surface of the metal section has. The amount of the copper compound used is preferably 2-fold to 100-fold as a molar ratio with respect to the nickel compound.

Moreover, a protrusion having a needle shape is obtained even without using the nonionic surfactant and the like. It is preferable to use a nonionic surfactant and it is particularly preferable to use polyethylene glycol having a molecular weight of about 1,000 (for example, 500 or more and 2,000 or less) in order to form a protrusion having a shape of which the vertical angle is more sharply tapered.

The ratio (average height (b)/average diameter (c)) of the average height (b) of the plurality of protrusions to the average diameter (c) of the bases of the plurality of protrusions depends on the thickness of the metal section and can be controlled by the immersion time in the plating bath. The plating temperature is preferably 30° C. or more, preferably 100° C. or less, and the immersion time in the plating bath is preferably 5 minutes or more.

Next, an example of a method for forming silver-plated layer and a protrusion having a tapered needle shape that the outer surface of a metal section has on the surface of a resin particle by electroless plating will be described.

In the catalyzing step, a catalyst serving as a starting point for forming a plated layer by electroless plating is formed on the surface of a resin particle.

Examples of the method for forming a catalyst on the surface of a resin particle include the following methods.

Method in which resin particles are added to a solution containing palladium chloride and tin chloride and then the surface of the resin particle is activated by an acid solution or an alkaline solution to deposit palladium on the surface of the resin particles. Method in which resin particles are added to a solution containing palladium sulfate and aminopyridine and then the surface of the resin particle is activated by a solution containing a reducing agent to deposit palladium on the surface of the resin particles.

A phosphorus-containing reducing agent is used as the reducing agent. Moreover, a metal section containing phosphorus can be formed as a phosphorus-containing reducing agent is used as the reducing agent.

In the electroless plating step, it is preferable to use a silver plating solution containing hydrazine as a reducing agent, a nonionic surfactant, and a sulfur-containing organic compound in the method by electroless silver plating using a plating solution containing a silver-containing compound, a complexing agent, and a reducing agent.

By immersing the resin particles in a silver plating bath, it is possible to deposit silver on the surface on which a catalyst is formed of the resin particles and to form a metal section containing silver.

As the silver-containing compound, silver potassium cyanide, silver nitrate, silver sodium thiosulfate, silver gluconate, a silver-cysteine complex, and silver methanesulfonate are preferable.

Examples of the reducing agent include hydrazine, sodium hypophosphite, dimethylamine borane, sodium borohydride and potassium borohydride, formalin, and glucose.

As a reducing agent for forming a protrusion having a needle shape, hydrazine monohydrate, hydrazine hydrochloride, and hydrazine sulfate are preferable.

Examples of the complexing agent include monocarboxylic acid-based complexing agents such as sodium acetate and sodium propionate, dicarboxylic acid-based complexing agents such as disodium malonate, tricarboxylic acid-based complexing agents such as disodium succinate, hydroxy acid-based complexing agents such as lactic acid, DL-malic acid, Rochelle salt, sodium citrate, and sodium gluconate, amino acid-based complexing agents such as glycine and EDTA, amine-based complexing agents such as ethylenediamine, organic acid-based complexing agents such as maleic acid, or salts thereof. The complexing agent is preferably a monocarboxylic acid-based complexing agent, a dicarboxylic acid-based complexing agent, a tricarboxylic acid-based complexing agent, a hydroxy acid-based complexing agent, an amino acid-based complexing agent, an amine-based complexing agent, an organic acid-based complexing agent, or salts thereof. Only one of these preferred complexing agents may be used, or two or more thereof may be used concurrently.

Examples of the surfactant include anionic surfactants, cationic surfactants, nonionic surfactants, and amphoteric surfactants. In particular, nonionic surfactants are suitable. Preferred nonionic surfactants are polyethers containing an ether oxygen atom. Examples of the preferred nonionic surfactants include polyoxyethylene lauryl ether, polyethylene glycol, polypropylene glycol, polyoxyethylene alkyl ether, polyoxyethylene polyoxypropylene glycol, polyoxyethylene nonylphenyl ether, polyoxyethylene polyoxypropylene alkylamine, and polyoxyalkylene adduct of ethylenediamine. The surfactant is preferably polyoxyethylene monoalkyl ethers such as polyoxyethylene monobutyl ether, polyoxypropylene monobutyl ether, and polyoxyethylene polyoxypropylene glycol monobutyl ether, polyethylene glycol, or phenol ethoxylate. As the surfactant, only one surfactant may be used or two or more surfactants may be used concurrently. Polyethylene glycol having a molecular weight of about 1,000 (for example, 500 or more and 2,000 or less) is particularly preferable.

Moreover, a protrusion having a needle shape is obtained even without using the nonionic surfactant and the like. It is preferable to use a nonionic surfactant and it is particularly preferable to use polyethylene glycol having a molecular weight of about 1,000 (for example, 500 or more and 2,000 or less) in order to form a protrusion having a shape of which the vertical angle is more sharply tapered.

Examples of the sulfur-containing organic compound include an organic compound having a sulfide or a sulfonic acid group, a thiourea compound, and a benzothiazole compound. Examples of the organic compound having a sulfide or a sulfonic acid group include N,N-dimethyl-dithiocarbamic acid (3-sulfopropyl) ester, 3-mercapto-propylsulfonic acid (3-sulfopropyl) ester, 3-mercapto-propylsulfonic acid sodium salt, 3-mercapto-1-propanesulfonic acid potassium salt, carbonic acid dithio-o-ethyl ester, bissulfopropyl disulfide, bis-(3-sulfopropyl) disulfide disodium salt, 3-(benzothiazolyl-s-thio)propylsulfonic acid sodium salt, pyridinium propyl sulfobetaine, 1-sodium 3-mercaptopropane-1-sulfonate, N,N-dimethyl-dithiocarbamic acid (3-sulfoethyl) ester, 3-mercapto-ethylpropylsulfonic acid (3-sulfoethyl) ester, 3-mercapto-ethylsulfonic acid sodium salt, 3-mercapto-1-ethanesulfonic acid potassium salt, carbonic acid-dithio-o-ethyl ester-s-ester, bissulfoethyl disulfide, 3-(benzothiazolyl-s-thio)ethyl sulfonic acid sodium salt, pyridinium ethyl sulfobetaine, 1-sodium 3-mercaptoethane-1-sulfonate, and thiourea compounds. Examples of the thiourea compound include thiourea, 1,3-dimethylthiourea, trimethylthiourea, diethylthiourea, and allylthiourea.

Moreover, a protrusion having a needle shape is obtained even without using the sulfur-containing organic compound and the like. It is preferable to use a sulfur-containing organic compound and it is particularly preferable to use thiourea in order to form a protrusion having a shape of which the vertical angle is more sharply tapered.

The ratio (average height (b)/average diameter (c)) of the average height (b) of the plurality of protrusions to the average diameter (c) of the bases of the plurality of protrusions depends on the thickness of the metal section and can be controlled by the immersion time in the plating bath. The plating temperature is preferably 30° C. or more, preferably 100° C. or less, and the immersion time in the plating bath is preferably 5 minutes or more.

Next, an example of a method for forming a highly pure nickel-plated layer and a protrusion having a tapered needle shape that the outer surface of a metal section has on the surface of a resin particle by electroless plating will be described.

In the catalyzing step, a catalyst serving as a starting point for forming a plated layer by electroless plating is formed on the surface of a resin particle.

Examples of the method for forming a catalyst on the surface of a resin particle include the following methods.

Method in which resin particles are added to a solution containing palladium chloride and tin chloride and then the surface of the resin particle is activated by an acid solution or an alkaline solution to deposit palladium on the surface of the resin particles. Method in which resin particles are added to a solution containing palladium sulfate and aminopyridine and then the surface of the resin particle is activated by a solution containing a reducing agent to deposit palladium on the surface of the resin particles.

A phosphorus-containing reducing agent is used as the reducing agent. Moreover, a metal section containing phosphorus can be formed as a phosphorus-containing reducing agent is used as the reducing agent.

In the electroless plating step, a highly pure nickel plating solution containing hydrazine as a reducing agent is suitably used in the method by electroless highly pure nickel plating using a plating solution containing a nickel-containing compound, a complexing agent, and a reducing agent.

By immersing the resin particles in a highly pure nickel plating bath, it is possible to deposit a highly pure nickel on the surface on which a catalyst is formed of the resin particles and to form a metal section containing highly pure nickel.

Examples of the nickel-containing compound include nickel sulfate, nickel chloride, nickel carbonate, nickel sulfamate, and nickel nitrate. The nickel-containing compound is preferably nickel chloride.

Examples of the reducing agent include hydrazine monohydrate, hydrazine hydrochloride, and hydrazine sulfate. The reducing agent is preferably hydrazine monohydrate.

Examples of the complexing agent include monocarboxylic acid-based complexing agents such as sodium acetate and sodium propionate, dicarboxylic acid-based complexing agents such as disodium malonate, tricarboxylic acid-based complexing agents such as disodium succinate, hydroxy acid-based complexing agents such as lactic acid, DL-malic acid, Rochelle salt, sodium citrate, and sodium gluconate, amino acid-based complexing agents such as glycine and EDTA, amine-based complexing agents such as ethylenediamine, and organic acid-based complexing agents such as maleic acid. The complexing agent is preferably glycine which is an amino acid-based complexing agent.

It is preferable to adjust the pH of the plating solution to 8.0 or more in order to form a protrusion having a tapered needle shape that the outer surface of the metal section has. In an electroless plating solution containing hydrazine as a reducing agent, the pH rapidly drops when nickel is reduced by the oxidation reaction of hydrazine. In order to suppress the rapid drop in pH, it is preferable to use a buffer such as phosphoric acid, boric acid, or carbonic acid. The buffer is preferably boric acid having an effect of buffering the pH at 8.0 or more.

The ratio (average height (b)/average diameter (c)) of the average height (b) of the plurality of protrusions to the average diameter (c) of the bases of the plurality of protrusions depends on the thickness of the metal section and can be controlled by the immersion time in the plating bath. The plating temperature is preferably 30° C. or more, preferably 100° C. or less, and the immersion time in the plating bath is preferably 5 minutes or more.

Next, an example of a method for forming a palladium-nickel alloy-plated layer and a protrusion having a tapered needle shape that the outer surface of a metal section has on the surface of a resin particle by electroless plating will be described.

In the catalyzing step, a catalyst serving as a starting point for forming a plated layer by electroless plating is formed on the surface of a resin particle.

Examples of the method for forming a catalyst on the surface of a resin particle include the following methods.

Method in which resin particles are added to a solution containing palladium chloride and tin chloride and then the surface of the resin particle is activated by an acid solution or an alkaline solution to deposit palladium on the surface of the resin particles. Method in which resin particles are added to a solution containing palladium sulfate and aminopyridine and then the surface of the resin particle is activated by a solution containing a reducing agent to deposit palladium on the surface of the resin particles.

A phosphorus-containing reducing agent is used as the reducing agent. Moreover, a metal section containing phosphorus can be formed as a phosphorus-containing reducing agent is used as the reducing agent.

In the electroless plating step, a palladium-nickel alloy plating solution containing hydrazine as a reducing agent is suitably used in the method by electroless palladium-nickel plating using a plating solution containing a nickel-containing compound, a palladium compound, a stabilizer, a complexing agent, and a reducing agent.

By immersing the resin particles in a palladium-nickel alloy plating bath, it is possible to deposit palladium-nickel alloy plating on the surface on which a catalyst is formed of the resin particles and to form a metal section of palladium-nickel.

Examples of the nickel-containing compound include nickel sulfate, nickel chloride, nickel carbonate, nickel sulfamate, and nickel nitrate. The nickel-containing compound is preferably nickel sulfate.

Examples of the palladium-containing compound include dichloroethylenediaminepalladium(II), palladium chloride, dichlorodiamminepalladium(II), dinitrodiamminepalladium(II), tetraamminepalladium(II) nitrate, tetraamminepalladium(II) sulfate, oxalatodiamminepalladium(II), tetraamminepalladium(II) oxalate, and tetraamminepalladium(II) chloride. The palladium-containing compound is preferably palladium chloride.

Examples of the stabilizer include a lead compound, a bismuth compound, and a thallium compound. Specific examples of these compounds include sulfates, carbonates, acetates, nitrates, and hydrochlorides of metals (lead, bismuth, thallium) constituting the compounds. In consideration of environmental impact, bismuth compounds or thallium compounds are preferable. Only one of these preferred stabilizers may be used, or two or more thereof may be used concurrently.

Examples of the reducing agent include hydrazine monohydrate, hydrazine hydrochloride, and hydrazine sulfate. The reducing agent is preferably hydrazine monohydrate.

Examples of the complexing agent include monocarboxylic acid-based complexing agents such as sodium acetate and sodium propionate, dicarboxylic acid-based complexing agents such as disodium malonate, tricarboxylic acid-based complexing agents such as disodium succinate, hydroxy acid-based complexing agents such as lactic acid, DL-malic acid, Rochelle salt, sodium citrate, and sodium gluconate, amino acid-based complexing agents such as glycine and EDTA, amine-based complexing agents such as ethylenediamine, and organic acid-based complexing agents such as maleic acid. The complexing agent is preferably ethylenediamine which is an amino acid-based complexing agent.

It is preferable to adjust the pH of the plating solution to from 8.0 to 10.0 in order to form a protrusion having a tapered needle shape that the outer surface of the metal section has. It is preferable to adjust the pH to 8.0 or more since the stability of the plating solution decreases and the decomposition thereof in the bath occurs at a pH of 7.5 or less.

The ratio (average height (b)/average diameter (c)) of the average height (b) of the plurality of protrusions to the average diameter (c) of the bases of the plurality of protrusions depends on the thickness of the metal section and can be controlled by the immersion time in the plating bath. The plating temperature is preferably 30° C. or more, preferably 100° C. or less, and the immersion time in the plating bath is preferably 5 minutes or more.

Next, an example of a method for forming an alloy-plated layer containing cobalt and nickel and a protrusion having a tapered needle shape that the outer surface of a metal section has on the surface of a resin particle by electroless plating will be described.

In the catalyzing step, a catalyst serving as a starting point for forming a plated layer by electroless plating is formed on the surface of a resin particle.

Examples of the method for forming a catalyst on the surface of a resin particle include the following methods.

Method in which resin particles are added to a solution containing palladium chloride and tin chloride and then the surface of the resin particle is activated by an acid solution or an alkaline solution to deposit palladium on the surface of the resin particles. Method in which resin particles are added to a solution containing palladium sulfate and aminopyridine and then the surface of the resin particle is activated by a solution containing a reducing agent to deposit palladium on the surface of the resin particles.

A phosphorus-containing reducing agent is used as the reducing agent. Moreover, a metal section containing phosphorus can be formed as a phosphorus-containing reducing agent is used as the reducing agent.

In the electroless plating step, a cobalt-nickel-phosphorus alloy plating solution containing a hypophosphorous acid compound as a reducing agent and a cobalt-containing compound as a metal catalyst for initiating the reaction of the reducing agent is suitably used in the method by electroless cobalt-nickel-phosphorus alloy plating using a plating solution containing a cobalt-containing compound, an inorganic additive, a complexing agent, and a reducing agent.

By immersing the resin particles in a cobalt-nickel-phosphorus alloy plating bath, it is possible to deposit a cobalt-nickel-phosphorus alloy on the surface on which a catalyst is formed of the resin particles and to form a metal section containing cobalt, nickel, and phosphorus.

The cobalt-containing compound is preferably cobalt sulfate, cobalt chloride, cobalt nitrate, cobalt acetate, or cobalt carbonate. The cobalt-containing compound is more preferably cobalt sulfate.

Examples of the nickel-containing compound include nickel sulfate, nickel chloride, nickel carbonate, nickel sulfamate, and nickel nitrate. The nickel-containing compound is preferably nickel sulfate.

Examples of the phosphorus-containing reducing agent include hypophosphorous acid and sodium hypophosphite. In addition to the phosphorus-containing reducing agent, a boron-containing reducing agent may be used. Examples of the boron-containing reducing agent include dimethylamine borane, sodium borohydride, and potassium borohydride.

Examples of the complexing agent include monocarboxylic acid-based complexing agents such as sodium acetate and sodium propionate, dicarboxylic acid-based complexing agents such as disodium malonate, tricarboxylic acid-based complexing agents such as disodium succinate, hydroxy acid-based complexing agents such as lactic acid, DL-malic acid, Rochelle salt, sodium citrate, and sodium gluconate, amino acid-based complexing agents such as glycine and EDTA, amine-based complexing agents such as ethylenediamine, organic acid-based complexing agents such as maleic acid, or salts thereof. The complexing agent is preferably the monocarboxylic acid-based complexing agent, dicarboxylic acid-based complexing agent, tricarboxylic acid-based complexing agent, hydroxy acid-based complexing agent, amino acid-based complexing agent, amine-based complexing agent, organic acid-based complexing agent, or salts thereof. Only one of these preferred complexing agents may be used, or two or more thereof may be used concurrently.

The inorganic additive is preferably ammonium sulfate, ammonium chloride, or boric acid. Only one of these preferred inorganic additives may be used, or two or more thereof may be used concurrently. The inorganic additive is considered to have an action of promoting the deposition of the electroless cobalt-plated layer.

It is desirable to control the molar ratio of the cobalt compound to the nickel compound in order to form a protrusion having a tapered needle shape that the outer surface of the metal section has. The amount of the cobalt compound used is preferably 2-fold to 100-fold as a molar ratio with respect to the nickel compound.

Moreover, a protrusion having a needle shape is obtained even without using the inorganic additive. It is preferable to use an inorganic additive and it is particularly preferable to use ammonium sulfate in order to form a protrusion having a shape of which the vertical angle is lower and more sharply tapered.

The ratio (average height (b)/average diameter (c)) of the average height (b) of the plurality of protrusions to the average diameter (c) of the bases of the plurality of protrusions depends on the thickness of the metal section and can be controlled by the immersion time in the plating bath. The plating temperature is preferably 30° C. or more, preferably 100° C. or less, and the immersion time in the plating bath is preferably 5 minutes or more.

It is possible to form a metal section having protrusions having a tapered needle shape, the outer surface of the metal section having the protrusions, on the surface of a resin particle by electroless plating in the manner as described above. Furthermore, a metal-containing particle can be obtained by forming a metal film which covers the outer surface of the metal section having the plurality of protrusions by electroless plating and the like.

Examples of a method for forming the metal film which covers the outer surface of the metal section include a method in which a gold-plated layer is formed on the outer surface of the metal section by electroless gold plating.

In the electroless gold plating step, an electroless gold plating solution for depositing gold by a substitution reaction between gold and a basis metal is suitably used in a method by electroless gold plating using a plating solution containing a gold-containing compound and a complexing agent.

By immersing the metal-containing particle in which a metal section is formed in an electroless gold plating bath, a gold ion (having a low ionization tendency) having a noble electrode potential dissolves a less-noble basis metal (having a high ionization tendency), the gold ion in the solution is reduced by the electrons released at that time and deposited as a plated film (substitution reaction), and a gold metal film can be thus formed on the outer surface of the metal section.

Examples of the complexing agent include monocarboxylic acid-based complexing agents such as sodium acetate and sodium propionate, dicarboxylic acid-based complexing agents such as disodium malonate, tricarboxylic acid-based complexing agents such as disodium succinate, hydroxy acid-based complexing agents such as lactic acid, DL-malic acid, Rochelle salt, sodium citrate, and sodium gluconate, amino acid-based complexing agents such as glycine and EDTA, amine-based complexing agents such as ethylenediamine, organic acid-based complexing agents such as maleic acid, a cyanide compound, sodium sulfite, potassium sulfite, and salts thereof. The complexing agent is preferably the monocarboxylic acid-based complexing agent, dicarboxylic acid-based complexing agent, tricarboxylic acid-based complexing agent, hydroxy acid-based complexing agent, amino acid-based complexing agent, amine-based complexing agent, organic acid-based complexing agent, cyanide compound, sodium sulfite, potassium sulfite, or salts thereof. Only one of these preferred complexing agents may be used, or two or more thereof may be used concurrently.

Examples of the method for forming a protrusion which has a concavoconvex shape and is melt-deformable at 400° C. or less, the outer surface of the metal section having the protrusion, include the following methods. Method in which gold-tin alloy solder is formed by covering tin nanoparticles by gold plating, forming these metals into a composite, and performing a heat treatment. Method in which silver-tin alloy solder is formed by covering tin nanoparticles by silver plating, forming these metals into a composite, and performing a heat treatment. Method in which tin-copper alloy solder is formed by covering tin nanoparticles by copper plating, forming these metals into a composite, and performing a heat treatment. Method in which tin-bismuth alloy solder is formed by covering tin nanoparticles by bismuth plating, forming these metals into a composite, and performing a heat treatment. Method in which tin-zinc alloy solder is formed by covering zinc nanoparticles by tin plating, forming these metals into a composite, and performing a heat treatment. Method in which tin-indium alloy solder is formed by covering indium nanoparticles by tin plating, forming these metals into a composite, and performing a heat treatment. Method in which pure tin solder is formed by depositing tin plating on the concavoconvex of protrusion.

In the method for forming a protrusion by electroless plating, a catalyzing step and an electroless plating step are generally performed. Hereinafter, an example of a method for forming an alloy-plated layer containing copper and nickel and a protrusion which has a concavoconvex shape and is melt-deformable at 400° C. or less, the outer surface of a metal section having the protrusion, on the surface of a resin particle by electroless plating will be described.

In the catalyzing step, a catalyst serving as a starting point for forming a plated layer by electroless plating is formed on the surface of a resin particle.

Examples of the method for forming the catalyst on the surface of a resin particle include the following methods. Method in which resin particles are added to a solution containing palladium chloride and tin chloride and then the surface of the resin particle is activated by an acid solution or an alkaline solution to deposit palladium on the surface of the resin particles. Method in which resin particles are added to a solution containing palladium sulfate and aminopyridine and then the surface of the resin particle is activated by a solution containing a reducing agent to deposit palladium on the surface of the resin particles. A phosphorus-containing reducing agent is used as the reducing agent. Moreover, a metal section containing phosphorus can be formed as a phosphorus-containing reducing agent is used as the reducing agent.

In the electroless plating step, it is preferable to use a nickel-phosphorus alloy plating solution containing a hypophosphorous acid compound as a reducing agent, a nickel-containing compound as a metal catalyst for initiating the reaction of the reducing agent, and a nonionic surfactant in the method by electroless nickel-phosphorus alloy plating using a plating solution containing a nickel-containing compound, a complexing agent, and a reducing agent.

By immersing the resin particles in a nickel-phosphorus alloy plating bath, it is possible to deposit a nickel-phosphorus alloy on the surface on which a catalyst is formed of the resin particles and to form a metal section containing nickel and phosphorus.

Examples of the nickel-containing compound include nickel sulfate, nickel chloride, nickel carbonate, nickel sulfamate, and nickel nitrate. The nickel-containing compound is preferably nickel sulfate.

Examples of the phosphorus-containing reducing agent include hypophosphorous acid and sodium hypophosphite. In addition to the phosphorus-containing reducing agent, a boron-containing reducing agent may be used. Examples of the boron-containing reducing agent include dimethylamine borane, sodium borohydride, and potassium borohydride.

Examples of the complexing agent include monocarboxylic acid-based complexing agents such as sodium acetate and sodium propionate, dicarboxylic acid-based complexing agents such as disodium malonate, tricarboxylic acid-based complexing agents such as disodium succinate, hydroxy acid-based complexing agents such as lactic acid, DL-malic acid, Rochelle salt, sodium citrate, and sodium gluconate, amino acid-based complexing agents such as glycine and EDTA, amine-based complexing agents such as ethylenediamine, and organic acid-based complexing agents such as maleic acid. Examples of the complexing agent also include complexing agents containing at least one complexing agent selected from the group consisting of salts of these organic acid-based complexing agents.

Examples of the surfactant include anionic surfactants, cationic surfactants, nonionic surfactants, and amphoteric surfactants. In particular, nonionic surfactants are suitable. Preferred nonionic surfactants are polyethers containing an ether oxygen atom. Examples of the preferred nonionic surfactants include polyoxyethylene lauryl ether, polyethylene glycol, polypropylene glycol, polyoxyethylene alkyl ether, polyoxyethylene polyoxypropylene glycol, polyoxyethylene nonylphenyl ether, polyoxyethylene polyoxypropylene alkylamine, and polyoxyalkylene adduct of ethylenediamine. The surfactant is preferably polyoxyethylene monoalkyl ethers such as polyoxyethylene monobutyl ether, polyoxypropylene monobutyl ether, and polyoxyethylene polyoxypropylene glycol monobutyl ether, polyethylene glycol, or phenol ethoxylate. As the surfactant, only one surfactant may be used or two or more surfactants may be used concurrently. Polyethylene glycol having a molecular weight of about 1,000 (for example, 500 or more and 2,000 or less) is particularly preferable.

Next, a tin nanoparticle slurry is adsorbed on the surface of the metal section containing nickel and phosphorus and electroless silver plating is formed on the tin nanoparticle surface.

In the electroless plating step, it is preferable to use a silver plating solution containing hydrazine as a reducing agent, a nonionic surfactant, and a sulfur-containing organic compound in the method by electroless silver plating using a plating solution containing a silver-containing compound, a complexing agent, and a reducing agent.

By immersing the resin particles in a silver plating bath, it is possible to deposit silver on the surface on which a catalyst is formed of the resin particles and to form a metal section containing silver.

As the silver-containing compound, silver potassium cyanide, silver nitrate, silver sodium thiosulfate, silver gluconate, a silver-cysteine complex, and silver methanesulfonate are preferable.

Examples of the reducing agent include hydrazine, sodium hypophosphite, dimethylamine borane, sodium borohydride, potassium borohydride, formalin, and glucose.

As a reducing agent for forming a protrusion which has a concavoconvex shape and is melt-deformable at 400° C. or less, hydrazine monohydrate, hydrazine hydrochloride, and hydrazine sulfate are preferable.

Examples of the complexing agent include monocarboxylic acid-based complexing agents such as sodium acetate and sodium propionate, dicarboxylic acid-based complexing agents such as disodium malonate, tricarboxylic acid-based complexing agents such as disodium succinate, hydroxy acid-based complexing agents such as lactic acid, DL-malic acid, Rochelle salt, sodium citrate, and sodium gluconate, amino acid-based complexing agents such as glycine and EDTA, amine-based complexing agents such as ethylenediamine, and organic acid-based complexing agents such as maleic acid. Examples of the complexing agent also include complexing agents containing at least one complexing agent selected from the group consisting of salts of these organic acid-based complexing agents.

Examples of the surfactant include anionic surfactants, cationic surfactants, nonionic surfactants, and amphoteric surfactants. In particular, nonionic surfactants are suitable. Preferred nonionic surfactants are polyethers containing an ether oxygen atom. Examples of the preferred nonionic surfactants include polyoxyethylene lauryl ether, polyethylene glycol, polypropylene glycol, polyoxyethylene alkyl ether, polyoxyethylene polyoxypropylene glycol, polyoxyethylene nonylphenyl ether, polyoxyethylene polyoxypropylene alkylamine, and polyoxyalkylene adduct of ethylenediamine. The surfactant is preferably polyoxyethylene monoalkyl ethers such as polyoxyethylene monobutyl ether, polyoxypropylene monobutyl ether, and polyoxyethylene polyoxypropylene glycol monobutyl ether, polyethylene glycol, or phenol ethoxylate. As the surfactant, only one surfactant may be used or two or more surfactants may be used concurrently. Polyethylene glycol having a molecular weight of about 1,000 (for example, 500 or more and 2,000 or less) is particularly preferable.

Moreover, a protrusion which has a concavoconvex shape and is melt-deformable at 400° C. or less is obtained even without using the nonionic surfactant and the like. It is preferable to use a nonionic surfactant and it is particularly preferable to use polyethylene glycol having a molecular weight of about 1,000 (for example, 500 or more and 2,000 or less) in order to form a protrusion which has a concavoconvex shape and is melt-deformable at a lower temperature.

Examples of the sulfur-containing organic compound include an organic compound having a sulfide or a sulfonic acid group, a thiourea compound, and a benzothiazole compound. Examples of the organic compound having a sulfide or a sulfonic acid group include N,N-dimethyl-dithiocarbamic acid (3-sulfopropyl) ester, 3-mercapto-propylsulfonic acid (3-sulfopropyl) ester, 3-mercapto-propylsulfonic acid sodium salt, 3-mercapto-1-propanesulfonic acid potassium salt, carbonic acid dithio-o-ethyl ester, bissulfopropyl disulfide, bis-(3-sulfopropyl) disulfide disodium salt, 3-(benzothiazolyl-s-thio)propylsulfonic acid sodium salt, pyridinium propyl sulfobetaine, 1-sodium 3-mercaptopropane-1-sulfonate, N,N-dimethyl-dithiocarbamic acid (3-sulfoethyl) ester, 3-mercapto-ethylpropylsulfonic acid (3-sulfoethyl) ester, 3-mercapto-ethylsulfonic acid sodium salt, 3-mercapto-1-ethanesulfonic acid potassium salt, carbonic acid-dithio-o-ethyl ester-s-ester, bissulfoethyl disulfide, 3-(benzothiazolyl-s-thio)ethyl sulfonic acid sodium salt, pyridinium ethyl sulfobetaine, 1-sodium 3-mercaptoethane-1-sulfonate, and thiourea compounds. Examples of the thiourea compound include thiourea, 1,3-dimethylthiourea, trimethylthiourea, diethylthiourea, and allylthiourea.

Moreover, a protrusion having a needle shape is obtained even without using the sulfur-containing organic compound and the like. It is preferable to use a sulfur-containing organic compound and it is particularly preferable to use thiourea in order to form a protrusion having a shape of which the vertical angle is more sharply tapered.

The ratio (average height (b)/average diameter (c)) of the average height (b) of the plurality of protrusions to the average diameter (c) of the bases of the plurality of protrusions depends on the thickness of the metal section and can be controlled by the immersion time in the plating bath. The plating temperature is preferably 30° C. or more, preferably 100° C. or less, and the immersion time in the plating bath is preferably 5 minutes or more.

Next, a tin nanoparticle slurry is adsorbed on the surface of the metal section containing nickel and phosphorus, and electroless silver plating is formed on the tin nanoparticle surface, tin of the protrusion core and the silver plating in contact with the tin protrusion portion mutually diffuse by a heat treatment in a nitrogen atmosphere, and thus silver-tin alloy solder is formed. The heat treatment temperature in a nitrogen atmosphere for solder alloying is preferably 100° C. or more, preferably 200° C. or less, and the heat treatment time is preferably 3 minutes or more.

The thickness of the entire metal sections at the portion not having the protrusions is preferably 5 nm or more, more preferably 10 nm or more, still more preferably 20 nm or more, particularly preferably 50 nm or more and preferably 1,000 nm or less, more preferably 800 nm or less, still more preferably 500 nm or less, particularly preferably 400 nm or less. The thickness of the entire metal sections at the portion not having the convexes is preferably 5 nm or more, more preferably 10 nm or more, still more preferably 20 nm or more, particularly preferably 50 nm or more and preferably 1,000 nm or less, more preferably 800 nm or less, still more preferably 500 nm or less, particularly preferably 400 nm or less. Peeling off of the metal section is suppressed when the thickness of the entire metal sections is the lower limit or more. The difference in thermal expansion coefficient between the base particle and the metal section decreases and the metal section is less likely to peel off from the base particle when the thickness of the entire metal sections is the upper limit or less. The thickness of the metal section denotes the thickness of the entire metal sections (the total thickness of the first and second metal sections) when the metal section has a plurality of metal sections (first metal section and second metal section).

When the metal section has a plurality of metal sections, the thickness of the metal section at the portion not having the protrusions in the outermost layer is preferably 1 nm or more, more preferably 10 nm or more and preferably 500 nm or less, more preferably 200 nm or less. When the metal section has a plurality of metal sections, the thickness of the metal section at the portion not having the convexes in the outermost layer is preferably 1 nm or more, more preferably 10 nm or more and preferably 500 nm or less, more preferably 200 nm or less. The covering with the metal section in the outermost layer can be uniform performed, the corrosion resistance is sufficiently enhanced, and the connection resistance between the electrodes is sufficiently lowered when the thickness of the metal section in the outermost layer is the lower limit or more and the upper limit or less. In addition, the cost is lower as the thickness of the outermost layer is thinner when the outermost layer is more expensive than the metal section in the inner layer.

The thickness of the metal section can be measured, for example, by observing the cross section of the metal-containing particle using a transmission electron microscope (TEM).

From the viewpoint of still further effectively enhancing the connection reliability, the thickness of the metal film is preferably 0.1 nm or more, more preferably 1 nm or more, still more preferably 10 nm or more and preferably 500 nm or less, more preferably 200 nm or less, still more preferably 100 nm or less, yet more preferably 50 nm or less, most preferably 30 nm or less. Oxidation or sulfurization of the metal section can be effectively suppressed when the thickness of the metal film is the lower limit or more and the upper limit or less. As a result, the connection reliability can be effectively enhanced. In addition, the ion migration phenomenon can be suppressed and the insulation reliability can be enhanced when the thickness of the metal film is the lower limit or more and the upper limit or less. The metal film may be formed of one layer. The metal film may be formed of a plurality of layers. The thickness of the metal film denotes the thickness of the entire metal films when the metal film has a plurality of layers.

The thickness of the portion covering the tip of the protrusion of the metal section of the metal film is preferably 0.1 nm or more, more preferably 1 nm or more and preferably 50 nm or less, more preferably 30 nm or less. The tip of the protrusion in the metal-containing particle can be effectively melted when the thickness of the portion covering the tip of the protrusion of the metal section is the lower limit or more and the upper limit or less.

When the metal film has a plurality of layers, the thickness of the metal film in the outermost layer is preferably 0.1 nm or more, more preferably 1 nm or more and preferably 50 nm or less, more preferably 30 nm or less. Oxidation or sulfurization of the metal section can be effectively suppressed when the thickness of the metal film in the outermost layer is the lower limit or more and the upper limit or less. As a result, the connection reliability can be effectively enhanced. In addition, the ion migration phenomenon can be suppressed and the insulation reliability can be enhanced when the thickness of the metal film is the lower limit or more and the upper limit or less.

The thickness of the metal film can be measured, for example, by observing the cross section of the metal-containing particle using a transmission electron microscope (TEM).

[Core Substance]

The metal-containing particle preferably includes a plurality of core substances which raise the surface of the metal section and more preferably includes a plurality of core substances which raise the surface of the metal section so that the plurality of convexes or the plurality of protrusions are formed in the metal section. As the core substance is embedded in the metal section, the outer surface of the metal section easily has the plurality of convexes or the plurality of protrusions. However, a core substance may not be necessarily used in order that the outer surface of the metal-containing particle and the outer surface of the metal section have convexes or protrusions. Examples of a method for forming convexes or protrusions by electroless plating without using a core substance include a method in which a metal nucleus is generated by electroless plating, the metal nucleus is attached to the surface of the base particle or metal section, and a metal section is further formed by electroless plating.

Examples of the method for forming convexes or protrusions include the following methods.

Method in which a core substance is attached onto the surface of a base particle and then a metal section is formed by electroless plating. Method in which a metal section is formed on the surface of a base particle by electroless plating, then a core substance is attached to the metal section, and a metal section is further formed by electroless plating. Method in which a core substance is added at an intermediate stage of forming a metal section on the surface of a base particle by electroless plating.

Examples of a method for disposing a core substance on the surface of the base particle include a method in which a core substance is added to the dispersion of base particle and the core substance is accumulated on and attached to the surface of the base particles by, for example, van der Waals force and a method in which a core substance is added into a container containing a base particle and the core substance is attached to the surface of the base particle by mechanical action such as rotation of the container. Among these, a method in which a core substance is accumulated on and attached to the surface of a base particle in a dispersion is preferable since the amount of the core substance to be attached is easily controlled.

Examples of the material of the core substance include conductive substances and non-conductive substances. Examples of the conductive substance include metals, metal oxides, conductive nonmetals such as graphite, and conductive polymers. Examples of the conductive polymer include polyacetylene. Examples of the nonconductive substance include silica, alumina, barium titanate, and zirconia. Among these, metals are preferable since the conductivity can be enhanced and the connection resistance can be effectively lowered. The core substance is preferably metal particles. As a metal which is a material of the core substance, the metals mentioned as the material of the metal section or the material of the metal film can be suitably used.

Specific examples of the material of the core substance include barium titanate (Mohs hardness: 4.5), nickel (Mohs hardness: 5), silica (silicon dioxide, Mohs hardness: 6 to 7), titanium oxide (Mohs hardness: 7), zirconia (Mohs hardness: 8 to 9), alumina (Mohs hardness: 9), tungsten carbide (Mohs hardness: 9), and diamond (Mohs hardness: 10). The material of the core substance is preferably nickel, silica, titanium oxide, zirconia, alumina, tungsten carbide, or diamond and more preferably silica, titanium oxide, zirconia, alumina, tungsten carbide, or diamond. The material of the core substance is still more preferably titanium oxide, zirconia, alumina, tungsten carbide, or diamond and particularly preferably zirconia, alumina, tungsten carbide, or diamond. The Mohs hardness of the material of the core substance is preferably 5 or more, more preferably 6 or more, still more preferably 7 or more, and particularly preferably 7.5 or more.

The shape of the core substance is not particularly limited. The shape of the core substance is preferably a lump shape. Examples of the core substance include a particulate lump, an aggregated in which a plurality of microparticles are aggregated, and an unstructured lump.

The average diameter (average particle diameter) of the core substance is preferably 0.001 μm or more, more preferably 0.05 μm or more and preferably 0.9 μm or less, more preferably 0.2 μm or less. The connection resistance between the electrodes is effectively lowered when the average diameter of the core substance is the lower limit or more and the upper limit or less.

The “average diameter (average particle diameter)” of the core substance denotes the number average diameter (number average particle diameter). The average diameter of the core substance can be determined by observing 50 arbitrary core substances under an electron microscope or an optical microscope and calculating the average value.

[Insulating Substance]

It is preferable that the metal-containing particle according to the present invention includes an insulating substance disposed on the outer surface of the metal section or metal film. The metal-containing particle according to the present invention may be a metal-containing particle with insulating substance. In this case, a short circuit between adjacent electrodes can be prevented when the metal-containing particle is used for connection of electrodes to each other. Specifically, it is possible to prevent a short circuit between the electrodes adjacent to each other in the lateral direction but not a short circuit between the upper and lower electrodes since an insulating substance is present between the plurality of electrodes when a plurality of metal-containing particles are in contact with one another. Incidentally, at the time of connection of electrodes to each other, the insulating substance between the metal section or metal film of the metal-containing particle and the electrode can be easily removed by pressurizing the metal-containing particle with two electrodes. The outer surface of the metal section has a plurality of protrusions, and thus the insulating substance between the metal section or metal film of the metal-containing particle and the electrode can be easily removed. In addition, when the outer surface of the metal section has a plurality of convexes, the insulating substance between the metal section or metal film of the metal-containing particle and the electrode can be easily removed.

The insulating substance is preferably an insulating particle since the insulating substance can be still further easily removed at the time of pressure bonding between the electrodes.

Specific examples of the insulating resin which is the material of the insulating substance include polyolefin compounds, (meth)acrylate polymers, (meth)acrylate copolymers, block polymers, thermoplastic resins, crosslinked products of thermoplastic resins, thermosetting resins, and water-soluble resins.

Examples of the polyolefin compound include polyethylene, an ethylene-vinyl acetate copolymer, and an ethylene-acrylic acid ester copolymer. Examples of the (meth)acrylate polymer include polymethyl (meth)acrylate, polyethyl (meth)acrylate, and polybutyl (meth)acrylate. Examples of the block polymer include polystyrene, a styrene-acrylic acid ester copolymer, a SB-type styrene-butadiene block copolymer, a SBS-type styrene-butadiene block copolymer, and hydrogenated additives thereof. Examples of the thermoplastic resin include a vinyl polymer and a vinyl copolymer. Examples of the thermosetting resin include an epoxy resin, a phenol resin, and a melamine resin. Examples of the water-soluble resin include polyvinyl alcohol, polyacrylic acid, polyacrylamide, polyvinyl pyrrolidone, polyethylene oxide, and methylcellulose. Among these, a water-soluble resin is preferable and polyvinyl alcohol is more preferable.

Examples of a method for disposing an insulating substance on the surface of the metal section or metal film include chemical methods and physical or mechanical methods. Examples of the chemical method include an interfacial polymerization method, a suspension polymerization method in the presence of particles, and an emulsion polymerization method. Examples of the physical or mechanical method include spray drying, hybridization, electrostatic deposition, spraying, dipping, and vacuum deposition. Among these, a method in which the insulating substance is disposed on the surface of the metal section or metal film through chemical binding is preferable since the insulating substance is hardly detached.

The outer surface of the metal section or metal film and the surface of the insulating substance (insulating particle or the like) may be each covered with a compound having a reactive functional group. The outer surface of the metal section or metal film and the surface of the insulating substance may not be directly chemically bound to each other but may be indirectly chemically bound to each other through a compound having a reactive functional group. A carboxyl group may be introduced into the outer surface of the metal section or metal film, and then the carboxyl group may be chemically bound to the functional group on the surface of the insulating substance through a polymer electrolyte such as polyethyleneimine.

The average diameter (average particle diameter) of the insulating substance can be appropriately selected depending on the particle diameter of the metal-containing particle, the application of the metal-containing particle, and the like. The average diameter (average particle diameter) of the insulating substance is preferably 0.005 μm or more, more preferably 0.01 μm or more and preferably 1 μm or less, more preferably 0.5 μm or less. When the average diameter of the insulating substance is the lower limit or more, the metal sections or metal films in the plurality of metal-containing particles hardly come into contact with one another when the metal-containing particles are dispersed in a binder resin. When the average diameter of the insulating substance is the upper limit or less, it is not required to excessively raise the pressure and to heat the insulating substance to a high temperature in order to remove the insulating substance between the electrode and the metal-containing particle at the time of connection of electrodes to each other.

The “average diameter (average particle diameter)” of the insulating substance denotes the number average diameter (number average particle diameter). The average diameter of the insulating substance is determined using a particle size distribution measuring apparatus and the like.

(Particle Linked Body)

The metal-containing particles according to the present invention can be melt-bonded to one another as described above. It is possible to form a particle linked body in which two or more metal-containing particles are linked to one another by melting and then solidifying the protrusions in the metal-containing particles. Such a particle linked body is useful as a novel material capable of enhancing the connection reliability to be higher than that of conventional metal-containing particles. In other words, the present inventors have further found out the following invention as a novel connection material.

1) A particle linked body in which a plurality of metal-containing particles (also referred to as metal-containing particle body in distinction from the metal-containing particle according to the present invention) are linked to one another via a columnar link section containing a metal.

2) The particle linked body according to 1), in which the columnar link section contains the same kind of metal as the metal contained in the metal-containing particle.

3) The particle linked body of 1) or 2), in which the metal-containing particles constituting the particle linked body are derived from the metal-containing particle according to the present invention.

4) The particle linked body of any one of 1) to 3), in which the metal-containing particles and the columnar link section constituting the particle linked body are formed by melting and solidifying the protrusion in the metal-containing particle according to the present invention.

5) The particle linked body according to any one of 1) to 4), in which the columnar link section is derived from the protrusions in the metal-containing particle according to the present invention.

The particle linked body can be manufactured by the methods described above, but the manufacturing method is not limited to the methods described above. For example, metal-containing particles and a columnar body may be separately manufactured and the metal-containing particles may be linked to one another through the columnar body to form a columnar link section.

The columnar link section may be a cylindrical link section or a polygonal columnar link section, and the central portion of the column may be thick or thin.

In the columnar link section, the diameter (d) of the circumscribed circle of the connection surface with the metal-containing particle is preferably 3 nm or more, more preferably 100 nm or more and preferably 10,000 nm or less, more preferably 1,000 nm or less.

In the columnar link section, the length (l) of the columnar link section is preferably 3 nm or more, more preferably 100 nm or more and preferably 10,000 nm or less, more preferably 1,000 nm or less.

In the columnar link section, the ratio ((d)/(l)) of the diameter (d) of the circumscribed circle of the connection surface with the metal-containing particle to the length (l) of the columnar link section is preferably 0.001 or more, more preferably 0.1 or more and preferably 100 or less, more preferably 10 or less.

The particle linked body may be a linked body of two metal-containing particles or may be a linked body composed of three or more metal-containing particles.

(Connection Material)

The connection material according to the present invention is suitably used to form a connection section connecting two connection target members to each other. The connection material includes the metal-containing particle described above and a resin. The connection material is preferably used to form the connection section by melting and then solidifying the tips of the plurality of protrusions of the metal-containing particles. The connection material is preferably used to form the connection section by metal-diffusing or melt-deforming and then solidifying the plurality of protrusions of the metal sections of the metal-containing particles.

The resin is not particularly limited. The resin is a binder for dispersing the metal-containing particles. The resin preferably contains a thermoplastic resin or a curable resin and more preferably contains a curable resin. Examples of the curable resin include a photocurable resin and a thermosetting resin. It is preferable that the photocurable resin contains a photocurable resin and a photopolymerization initiator. It is preferable that the thermosetting resin contains a thermosetting resin and a thermosetting agent. Examples of the resin include a vinyl resin, a thermoplastic resin, a curable resin, a thermoplastic block copolymer, and an elastomer. As the resin, only one resin may be used or two or more resins may be used concurrently.

Examples of the vinyl resin include a vinyl acetate resin, an acrylic resin, and a styrene resin. Examples of the thermoplastic resin include a polyolefin resin, an ethylene-vinyl acetate copolymer, and a polyamide resin. Examples of the curable resin include an epoxy resin, a urethane resin, a polyimide resin, and an unsaturated polyester resin. Incidentally, the curable resin may be a room temperature curable resin, a thermosetting resin, a photocurable resin, or a moisture curable resin. Examples of the thermoplastic block copolymer include a styrene-butadiene-styrene block copolymer, a styrene-isoprene-styrene block copolymer, a hydrogenated product of a styrene-butadiene-styrene block copolymer, and a hydrogenated product of a styrene-isoprene-styrene block copolymer. Examples of the elastomer include styrene-butadiene copolymer rubber and acrylonitrile-styrene block copolymer rubber.

It is preferable to use a reducing agent when the protrusions of the metal-containing particles contain a metal oxide. Examples of the reducing agent include alcohol compounds (compounds having an alcoholic hydroxyl group), carboxylic acid compounds (compounds having a carboxyl group), and amine compounds (compounds having an amino group). As the reducing agent, only one reducing agent may be used or two or more reducing agents may be used concurrently.

Examples of the alcohol compound include alkyl alcohols. Specific examples of the alcohol compound include ethanol, propanol, butyl alcohol, pentyl alcohol, hexyl alcohol, heptyl alcohol, octyl alcohol, nonyl alcohol, decyl alcohol, undecyl alcohol, dodecyl alcohol, tridecyl alcohol, tetradecyl alcohol, pentadecyl alcohol, hexadecyl alcohol, heptadecyl alcohol, octadecyl alcohol, nonadecyl alcohol, and icosyl alcohol. Moreover, the alcohol compound is not limited to primary alcohol type compounds, and secondary alcohol type compounds, tertiary alcohol type compounds, alkane diols, alcohol compounds having a cyclic structure, and the like can also be used.

Furthermore, as the alcohol compound, compounds having a large number of alcohol groups such as ethylene glycol and triethylene glycol may be used. Moreover, as the alcohol compound, compounds such as citric acid, ascorbic acid, and glucose may be used.

Examples of the carboxylic acid compound include alkyl carboxylic acids. Specific examples of the carboxylic acid compound include butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, and icosanoic acid. Moreover, the carboxylic acid compound is not limited to primary carboxylic acid type compounds, and secondary carboxylic acid type compounds, tertiary carboxylic acid type compounds, dicarboxylic acids, carboxyl compounds having a cyclic structure, and the like can also be used.

Examples of the amine compound include alkyl amines. Specific examples of the amine compound include butylamine, pentylamine, hexylamine, heptylamine, octylamine, nonylamine, decylamine, undecylamine, dodecylamine, tridecylamine, tetradecylamine, pentadecylamine, hexadecylamine, heptadecylamine, octadecylamine, nonadecylamine, and icodecylamine. Moreover, the amine compound may have a branched structure. Examples of the amine compound having a branched structure include 2-ethylhexylamine and 1,5-dimethylhexylamine. The amine compound is not limited to primary amine type compounds, and secondary amine type compounds, tertiary amine type compounds, amine compounds having a cyclic structure, and the like can also be used.

The reducing agent may be an organic substance having an aldehyde group, an ester group, a sulfonyl group, a ketone group or the like or may be an organic substance such as a carboxylic acid metal salt. The carboxylic acid metal salt is also used as a precursor of metal particles and is also used as a reducing agent for metal oxide particles since the carboxylic acid metal salt contains an organic substance.

The connection material may contain various additives such as a filler, an extender, a softener, a plasticizer, a polymerization catalyst, a curing catalyst, a coloring agent, an antioxidant, a heat stabilizer, a light stabilizer, an ultraviolet absorber, a lubricant, an antistatic agent, and a flame retardant in addition to the metal-containing particles and the resin.

The connection material is preferably used for conductive connection and is preferably a conductive connection material. The connection material is preferably used for anisotropic conductive connection and is preferably an anisotropic conductive connection material. The connection material can be used as a paste, a film and the like. When the connection material is a film, a film not containing a metal-containing particle may be layered on a film containing a metal-containing particle. The paste is preferably a conductive paste and more preferably an anisotropic conductive paste. The film is preferably a conductive film and more preferably an anisotropic conductive film.

The content of the resin in 100% by weight of the connection material is preferably 1% by weight or more, more preferably 5% by weight or more, may be 10% by weight or more, 30% by weight or more, 50% by weight or more, or 70% by weight or more, and is preferably 99.99% by weight or less, more preferably 99.9% by weight or less. The connection reliability is still further enhanced when the content of the resin is the lower limit or more and the upper limit or less.

The content of the metal-containing particle is preferably 0.01% by weight or more and more preferably 0.1% by weight or more in 100% by weight of the connection material. The content of the metal-containing particle in 100% by weight of the connection material is preferably 99% by weight or less, more preferably 95% by weight or less and may be 80% by weight or less, 60% by weight or less, 40% by weight or less, 20% by weight or less, or 10% by weight or less. The connection reliability is still further enhanced when the content of the metal-containing particle is the lower limit or more and the upper limit or less. In addition, the metal-containing particles can be sufficiently present between the first and second connection target members and it can be still further suppressed by the metal-containing particles that the space between the first and second connection target members partially narrows when the content of the metal-containing particle is the lower limit or more and the upper limit or less. For this reason, it is also possible to suppress that the heat dissipation of the connection section partially decreases.

The connection material may contain a metal atom-containing particle which does not have a base particle separately from the metal-containing particle.

Examples of the metal atom-containing particle include metal particles and metal compound particles. The metal compound particle contains a metal atom and an atom other than the metal atom. Specific examples of the metal compound particle include metal oxide particles, metal carbonate particles, metal carboxylate particles, and metal complex particles. It is preferable that the metal compound particle is a metal oxide particle. For example, the metal oxide particle is formed into a metal particle by heating at the time of connection in the presence of a reducing agent and then sintered. The metal oxide particle is a precursor of a metal particle. Examples of the metal carboxylate particle include metal acetate particles.

Examples of the metal constituting the metal particle and metal oxide particle include silver, copper, nickel, and gold. Silver or copper is preferable and silver is particularly preferable. Hence, the metal particle is preferably a silver particle or a copper particle and more preferably a silver particle. The metal oxide particle is preferably a silver oxide particle or a copper oxide particle and more preferably a silver oxide particle. There are few residues after connection and the volume decreasing rate is also significantly small when a silver particle and a silver oxide particle are used. Examples of silver oxide in the silver oxide particle include Ag₂O and AgO.

It is preferable that the metal atom-containing particle is sintered by being heated at less than 400° C. The temperature (sintering temperature) at which the metal atom-containing particle is sintered is more preferably 350° C. or less, preferably 300° C. or more. Sintering can be efficiently performed, energy required for sintering can be further decreased, and the environmental burden can be decreased when the temperature at which the metal atom-containing particle is sintered is the upper limit or less or less than the upper limit.

It is preferable that the connection material containing the metal atom-containing particles is a connection material containing metal particles having an average particle diameter of 1 nm or more and 100 nm or less or a connection material containing metal oxide particles having an average particle diameter of 1 nm or more and 50 μm or less and a reducing agent. The metal atom-containing particles can be favorably sintered together by heating at the time of connection when such a connection material is used. The average particle diameter of the metal oxide particles is preferably 5 μm or less. The particle diameter of the metal atom-containing particle denotes the diameter when the metal atom-containing particle has a perfect spherical shape and denotes the maximum diameter when the metal atom-containing particle does not have a perfect spherical shape.

The content of the metal atom-containing particles in 100% by weight of the connection material is preferably 10% by weight or more, more preferably 30% by weight or more, still more preferably 50% by weight or more and preferably 100% by weight or less, more preferably 99% by weight or less, still more preferably 90% by weight or less. The entire amount of the connection material may be the metal atom-containing particle. The metal atom-containing particle can be still further minutely sintered when the content of the metal atom-containing particle is the lower limit or more. As a result, the heat dissipation and heat resistance at the connection section are also enhanced.

It is preferable to use a reducing agent when the metal atom-containing particle is a metal oxide particle. Examples of the reducing agent include alcohol compounds (compounds having an alcoholic hydroxyl group), carboxylic acid compounds (compounds having a carboxyl group), and amine compounds (compounds having an amino group). As the reducing agent, only one reducing agent may be used or two or more reducing agents may be used concurrently.

Examples of the alcohol compound include alkyl alcohols. Specific examples of the alcohol compound include ethanol, propanol, butyl alcohol, pentyl alcohol, hexyl alcohol, heptyl alcohol, octyl alcohol, nonyl alcohol, decyl alcohol, undecyl alcohol, dodecyl alcohol, tridecyl alcohol, tetradecyl alcohol, pentadecyl alcohol, hexadecyl alcohol, heptadecyl alcohol, octadecyl alcohol, nonadecyl alcohol, and icosyl alcohol. Moreover, the alcohol compound is not limited to primary alcohol type compounds, and secondary alcohol type compounds, tertiary alcohol type compounds, alkane diols, alcohol compounds having a cyclic structure, and the like can also be used.

Furthermore, as the alcohol compound, compounds having a large number of alcohol groups such as ethylene glycol and triethylene glycol may be used. Moreover, as the alcohol compound, compounds such as citric acid, ascorbic acid, and glucose may be used.

Examples of the carboxylic acid compound include alkyl carboxylic acids. Specific examples of the carboxylic acid compound include butanoic acid, pentanoic acid, hexanoic acid, heptanoic acid, octanoic acid, nonanoic acid, decanoic acid, undecanoic acid, dodecanoic acid, tridecanoic acid, tetradecanoic acid, pentadecanoic acid, hexadecanoic acid, heptadecanoic acid, octadecanoic acid, nonadecanoic acid, and icosanoic acid. Moreover, the carboxylic acid compound is not limited to primary carboxylic acid type compounds, and secondary carboxylic acid type compounds, tertiary carboxylic acid type compounds, dicarboxylic acids, carboxyl compounds having a cyclic structure, and the like can also be used.

Examples of the amine compound include alkyl amines. Specific examples of the amine compound include butylamine, pentylamine, hexylamine, heptylamine, octylamine, nonylamine, decylamine, undecylamine, dodecylamine, tridecylamine, tetradecylamine, pentadecylamine, hexadecylamine, heptadecylamine, octadecylamine, nonadecylamine, and icodecylamine. Moreover, the amine compound may have a branched structure. Examples of the amine compound having a branched structure include 2-ethylhexylamine and 1,5-dimethylhexylamine. The amine compound is not limited to primary amine type compounds, and secondary amine type compounds, tertiary amine type compounds, amine compounds having a cyclic structure, and the like can also be used.

Furthermore, the reducing agent may be an organic substance having an aldehyde group, an ester group, a sulfonyl group, a ketone group or the like or may be an organic substance such as a carboxylic acid metal salt. The carboxylic acid metal salt is also used as a precursor of metal particles and is also used as a reducing agent for metal oxide particles since the carboxylic acid metal salt contains an organic substance.

When a reducing agent having a melting point lower than the sintering temperature (bonding temperature) of the metal atom-containing particle is used, the reducing agent tends to aggregate at the time of bonding and voids tend to be generated at the bonding section. The carboxylic acid metal salt does not melt by heating at the time of bonding and the generation of voids can be thus suppressed by the use of a carboxylic acid metal salt. Incidentally, metal compounds containing an organic substance other than the carboxylic acid metal salt may be used as a reducing agent.

When the reducing agent is used, the content of the reducing agent in 100% by weight of the connection material is preferably 1% by weight or more, more preferably 10% by weight or more and preferably 90% by weight or less, more preferably 70% by weight or less, still more preferably 50% by weight or less. The metal atom-containing particle can be still further minutely sintered when the content of the reducing agent is the lower limit or more. As a result, the heat dissipation and heat resistance at the connection section are also enhanced.

When the reducing agent is used, the content of the metal oxide particle is preferably 10% by weight or more, more preferably 30% by weight or more, and still more preferably 60% by weight or more in 100% by weight of the connection material. The content of the metal oxide particle is preferably 99.99% by weight or less, more preferably 99.9% by weight or less, still more preferably 99.5% by weight or less, yet more preferably 99 wt % or less, particularly preferably 90 wt % or less, and most preferably 80 wt % or less in 100% by weight of the connection material. The metal oxide particle can be still further minutely sintered when the content of the metal oxide particle is the lower limit or more and the upper limit or less. As a result, the heat dissipation and heat resistance at the connection section are also enhanced.

When the connection material is a paste containing a metal atom-containing particle, a binder may be used in the paste together with the metal atom-containing particle. The binder used in the paste is not particularly limited. The binder preferably disappears when the metal atom-containing particle is sintered. As the binder, only one binder may be used or two or more binders may be used concurrently.

Specific examples of the binder include solvents. Examples of the solvent include aliphatic solvents, ketone-based solvents, aromatic solvents, ester-based solvents, ether-based solvents, alcohol-based solvents, paraffin-based solvents, and petroleum-based solvents.

Examples of the aliphatic solvents include cyclohexane, methylcyclohexane, and ethylcyclohexane. Examples of the ketone-based solvents include acetone and methyl ethyl ketone. Examples of the aromatic solvents include toluene and xylene. Examples of the ester-based solvents include ethyl acetate, butyl acetate, and isopropyl acetate. Examples of the ether-based solvents include tetrahydrofuran (THF) and dioxane. Examples of the alcohol-based solvents include ethanol and butanol. Examples of the paraffin-based solvents include paraffin oil and naphthenic oil. Examples of the petroleum-based solvents include mineral terpene and naphtha.

(Connection Structure)

A connection structure according to the present invention includes a first connection target member, a second connection target member, and a connection section connecting the first and second connection target members to each other. In the connection structure according to the present invention, the connection section is formed of the metal-containing particle or the connection material. The material of the connection section is the metal-containing particle or the connection material.

A method for manufacturing a connection structure according to the present invention includes a step of disposing the metal-containing particle or the connection material between a first connection target member and a second connection target member. The method for manufacturing a connection structure according to the present invention includes a step of heating the metal-containing particle to melt the tips of the protrusions of the metal section, solidifying the melt after melting, and forming a connection section connecting the first connection target member and the second connection target member to each other through the metal-containing particle or the connection material. The method for manufacturing a connection structure according to the present invention includes a step of heating the metal-containing particle to metal-diffuse or melt-deform a component of the protrusions of the metal section and forming a connection section connecting the first connection target member and the second connection target member to each other through the metal-containing particle or the connection material.

FIG. 15 is a cross-sectional view schematically illustrating a connection structure in which the metal-containing particle according to the first embodiment of the present invention is used.

A connection structure 51 illustrated in FIG. 15 includes a first connection target member 52, a second connection target member 53, and a connection section 54 connecting the first and second connection target members and 53 to each other. The connection section 54 includes a metal-containing particle 1 and a resin (such as a cured resin). The connection section 54 is formed of a connection material containing the metal-containing particle 1. The material of the connection section 54 is the connection material. The connection section 54 is preferably formed by curing the connection material. Incidentally, in FIG. 15, the tip of a protrusion 3a of a metal section 3 in the metal-containing particle 1 is melted and then solidified. The connection section 54 includes a bonded body composed of a plurality of metal-containing particles 1. In the connection structure 51, the metal-containing particle 1 and the first connection target member 51 are bonded to each other and the metal-containing particle 1 and the second connection target member 53 are bonded to each other.

Instead of the metal-containing particle 1, other metal-containing particles such as the metal-containing particles 1A, 1B, 10, 1D, 1E, 1F, 1G, 11A, 11B, 11C, 11D, and 11E may be used.

The first connection target member 52 has a plurality of first electrodes 52a on the surface (upper surface) of the first connection target member 52. The second connection target member 53 has a plurality of second electrodes 53a on the surface (lower surface) of the second connection target member 53. The first electrode 52a and the second electrode 53a are electrically connected to each other by one or plural metal-containing particles 1. Hence, the first and second connection target members 52 and 53 are electrically connected to each other through the metal-containing particle 1. In the connection structure 51, the metal-containing particle 1 and the first electrode 52a are bonded to each other and the metal-containing particle 1 and the second electrode 53a are bonded to each other.

The method for manufacturing the connection structure is not particularly limited. An example of the method for manufacturing the connection structure include a method in which the connection material is disposed between a first connection target member and a second connection target member to obtain a layered body and then the layered body is heated and pressurized. The pressure applied is about 9.8×10⁴ Pa to 4.9×10⁶ Pa. The heating temperature is about 120° C. to 220° C.

Specific examples of the connection target member include electronic parts such as a semiconductor chip, a capacitor, and a diode and electronic parts which are circuit boards such as printed substrates, flexible printed substrates, glass epoxy substrates, and glass substrates. The connection target member is preferably an electronic part. The metal-containing particle is preferably used to electrically connect the electrodes in an electronic part.

Examples of the electrode provided in the connection target member include metal electrodes such as a gold electrode, a nickel electrode, a tin electrode, an aluminum electrode, a copper electrode, a silver electrode, a SUS electrode, a molybdenum electrode, and a tungsten electrode. When the connection target member is a flexible printed substrate, the electrode is preferably a gold electrode, a nickel electrode, a tin electrode, or a copper electrode. When the connection target member is a glass substrate, the electrode is preferably an aluminum electrode, a copper electrode, a molybdenum electrode, or a tungsten electrode. Incidentally, when the electrode is an aluminum electrode, the electrode may be an electrode formed only of aluminum or an electrode in which an aluminum layer is layered on the surface of a metal oxide layer. Examples of the material of the metal oxide layer include indium oxide doped with a trivalent metal element and zinc oxide doped with a trivalent metal element. Examples of the trivalent metal element include Sn, Al, and Ga.

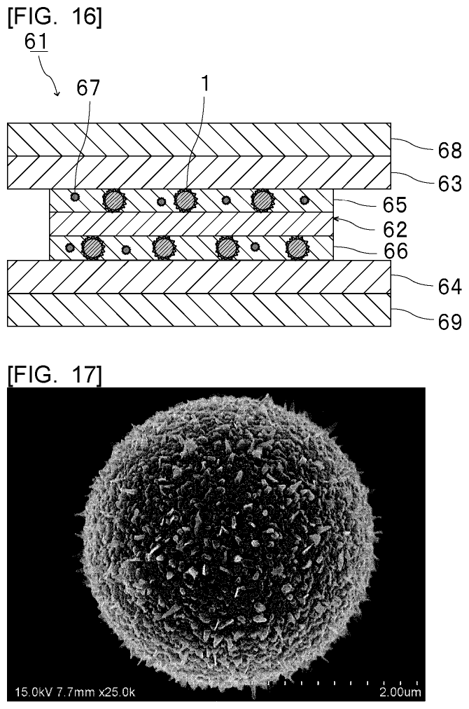

FIG. 16 is a cross-sectional view schematically illustrating a modification of the connection structure in which the metal-containing particle according to the first embodiment of the present invention is used.

A connection structure 61 illustrated in FIG. 16 includes a first connection target member 62, second connection target members 63 and 64, and connection sections 65 and 66 connecting the connection target member 62 and the second connection target members 63 and 64 to each other. The connection sections 65 and 66 are formed using a connection material containing the metal-containing particle 1 and another metal-containing particle 67. The material of the connection sections 65 and 66 is the connection material. The connection material contains a metal atom-containing particle.

The connection section 65 and the second connection target member 63 are disposed on the first surface (one surface) side of the first connection target member 62. The connection section 65 connects the first connection target member 62 and the second connection target member 63 to each other.

The connection section 66 and the second connection target member 64 are disposed on the side of the second surface (the other surface) opposite to the first surface of the first connection target member 62. The connection section 66 connects the first connection target member 62 and the second connection target member 64 to each other.

The metal-containing particles 1 and another metal-containing particle 67 are disposed between the first connection target member 62 and the second connection target members 63 and 64, respectively. In the present embodiment, the metal atom-containing particle is in the state of a sintered product which has been sintered at the connection sections 65 and 66. The metal-containing particle 1 is disposed between the first connection target member 62 and the second connection target members 63 and 64. The first connection target member 62 and the second connection target members 63 and 64 are connected to each other through the metal-containing particle 1.

A heat sink 68 is disposed on the surface opposite to the connection section 65 side of the second connection target member 63. A heat sink 69 is disposed on the surface on the side opposite to the connection section 66 side of the second connection target member 64. Hence, the connection structure 61 has a portion in which the heat sink 68, the second connection target member 63, the connection section 65, the first connection target member 62, the connection section 66, the second connection target member 64, and the heat sink 69 are layered in this order.

Examples of the first connection target member 62 include power semiconductor elements which are formed of materials such as Si, SiC, and GaN and used in rectifying diodes, power transistors (power MOSFET, an insulated gate bipolar transistor), thyristors, gate turn-off thyristors, triacs and the like. In the connection structure 61 including such a first connection target member 62, a large amount of heat is likely to be generated in the first connection target member 62 at the time of use of the connection structure 61. Hence, it is required to efficiently dissipate the heat generated from the first connection target member 62 to the heat sinks 68 and 69 and the like. For this reason, high heat dissipation and high reliability are demanded for the connection sections 65 and 66 disposed between the first connection target member 62 and the heat sinks 68 and 69.

Examples of the second connection target members 63 and 64 include substrates which are formed of materials such as ceramics and plastics.

The connection sections 65 and 66 are formed by heating the connection material to melt the tip of the metal-containing particle and then solidifying the melt.

(Conduction Inspection Member and Conduction Inspection Device)

The metal-containing particles, the particle linked body, and the connection material can also be applied to a conduction inspection member and a conduction inspection device. Hereinafter, an aspect of the conduction inspection member and conduction inspection device will be described. Incidentally, the conduction inspection member and the conduction inspection device are not limited to the following aspect. The conduction inspection member may be a conduction member. The conduction inspection member and the conduction member may be a sheet-shaped conduction member.

The conduction inspection member according to the present invention includes a base body having a through hole and a conductive section. In the conduction inspection member according to the present invention, a plurality of through holes are disposed on the base body and the conductive section is disposed in the through holes. In the conduction inspection member according to the present invention, the material of the conductive section contains the metal-containing particles described above.

The conduction inspection device according to the present invention includes an ammeter and the conduction inspection member.

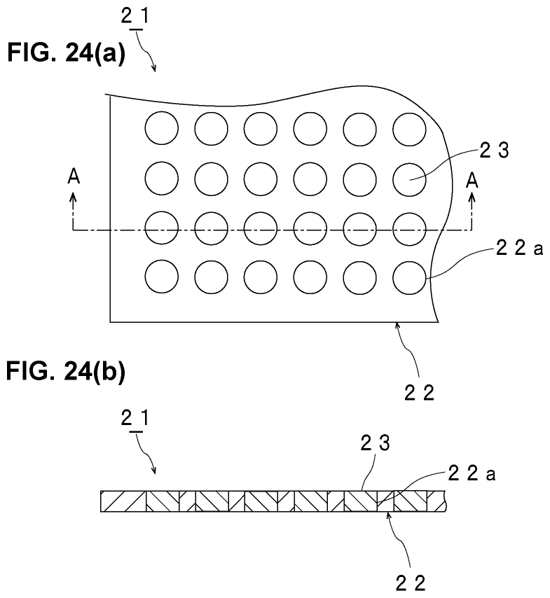

FIGS. 24(a) and 24(b) are a plan view and a cross-sectional view which illustrate an example of the conduction inspection member. FIG. 24(b) is a cross-sectional view taken along the line A-A in FIG. 24(a).

A conduction inspection member 21 illustrated in FIGS. 24(a) and 24(b) includes a base body 22 having a through hole 22a and a conductive section 23 disposed in the through hole 22a of the base body 22. The material of the conductive section 23 contains the metal-containing particles. The conduction inspection member 21 may be a conduction member.

The base body is a member to be a substrate of the conduction inspection member. The base body preferably exhibits insulating property and is preferably formed of an insulating material. Examples of the insulating material include an insulating resin.

The insulating resin constituting the base body may be, for example, either of a thermoplastic resin or a thermosetting resin. Examples of the thermoplastic resin include a polyester resin, a polystyrene resin, a polyethylene resin, a polyamide resin, an ABS resin, and a polycarbonate resin. Examples of the thermosetting resin include an epoxy resin, a urethane resin, a polyimide resin, a polyether ether ketone resin, a polyamideimide resin, a polyether imide resin, a silicone resin, and a phenol resin. Examples of the silicone resin include silicone rubber.

When the base body is formed of an insulating resin, as the insulating resin constituting the base body, only one insulating resin may be used or two or more insulating resins may be used concurrently.

The base body has, for example, a plate shape and a sheet shape. The sheet shape includes a film shape. The thickness of the base body can be appropriately set depending on the kind of conduction inspection member and may be, for example, a thickness of 0.005 mm or more and 50 mm or less. The size of the base body in plan view can also be appropriately set depending on the intended inspection device.

The base body can be obtained, for example, by molding an insulating material such as the insulating resin as a raw material into a desired shape.

A plurality of through holes of the base body are disposed on the base body. It is preferable that the through holes penetrate in the thickness direction of the base body.

The through hole of the base body can be formed in a cylindrical shape, but is not limited to a cylindrical shape, and may be formed in another shape, for example, a polygonal columnar shape. In addition, the through hole may be formed in a tapered shape which is tapered in one direction or may be formed in a distorted shape.

The size of the through hole, for example, the apparent area of the through hole in plan view can also be formed as an appropriate size and, for example, may be formed as a size in which the conductive section can be accommodate and held. The diameter of the through hole is preferably 0.01 mm or more and preferably 10 mm or less when the through hole has, for example, a cylindrical shape.

Incidentally, all the through holes of the base body may have the same shape and the same size or the shape or size of a part of the through holes of the base body may be different from those of the other through holes.

The number of the through holes of the base body may be set in an appropriate range, may be the number in which the conduction inspection is possible, and can be appropriately set depending on the intended inspection device. In addition, the place at which the through holes of the base body are disposed can be appropriately set depending on the intended inspection device.

The method for forming the through hole of the base body is not particularly limited, and it is possible to form the through hole by a known method (for example, laser processing).

The conductive section in the through hole of the base body exhibits conductivity.

Specifically, the conductive section contains particles derived from the metal-containing particle. For example, the conductive section is formed by accommodating a plurality of metal-containing particles in the through hole. The conductive section contains an aggregate (particle group) of particles derived from the metal-containing particle.

The material of the conductive section may contain a material other than the metal-containing particle. For example, the material of the conductive section can contain a binder resin other than the metal-containing particle. As the material of the conductive section contains a binder resin, the metal-containing particles more firmly gather, and thus the particles derived from the metal-containing particles are more likely to be held in the through holes.

The binder resin is not particularly limited. Examples of the binder resin include a photocurable resin and a thermosetting resin. It is preferable that the photocurable resin contains a photocurable resin and a photopolymerization initiator. It is preferable that the thermosetting resin contains a thermosetting resin and a thermosetting agent. The binder resin may be, for example, a silicone-based copolymer, a vinyl resin, a thermoplastic resin, a curable resin, a thermoplastic block copolymer, and an elastomer. As the binder resin, only one binder resin may be used or two or more binder resins may be used concurrently.

It is preferable that the particles derived from the metal-containing particles are densely filled in the through hole, and more reliable conduction inspection can be performed by the conduction inspection member in this case. It is preferable that the conductive section is accommodated in the through hole so that conduction is possible over the front and back of the conduction inspection member or the conduction member.

In the conductive section, it is preferable that the particles derived from the metal-containing particles are present continuously from the front surface to the back surface of the conductive section while being in contact with one another. In this case, the conductivity of the conductive section is improved.

The method for accommodating the conductive section in the through hole is not particularly limited. For example, the conductive section can be formed in the through hole by filling the metal-containing particles in the through hole by a method in which the base body is coated with a material containing the metal-containing particles and a binder resin and curing the binder resin under appropriate conditions. The conductive section is thus accommodated in the through hole. The material containing the metal-containing particles and a binder resin may contain a solvent if necessary.

The content of the binder with respect to 100 parts by weight of the metal-containing particles in the material containing the metal-containing particles and a binder resin is preferably 5 parts by weight or more, more preferably 10 parts by weight or more and preferably 70 parts by weight or less, more preferably 50 parts by weight or less in terms of solid content.

The conduction inspection member can be used as a probe card or a probe sheet. Incidentally, the conduction inspection member may include other constituents as long as the effects of the present invention are not inhibited.

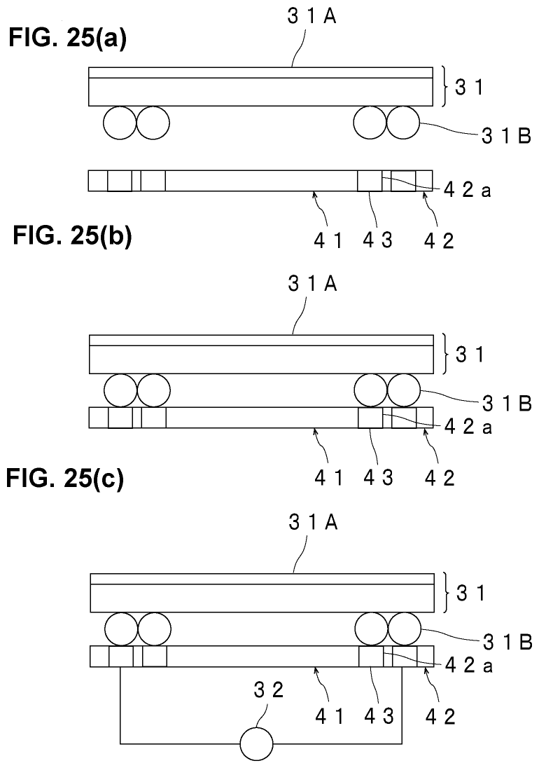

FIGS. 25(a) to 25(c) are views schematically illustrating a situation in which the electrical properties of an electronic circuit device are inspected using a conduction inspection device.

In FIGS. 25(a) to 25(c), the electronic circuit device is a BGA substrate 31 (ball grid array substrate). The BGA substrate 31 is a substrate having a structure in which connection pads are arranged in a grid shape on a multilayer substrate 31A and a solder ball 31B is disposed on each pad. Moreover, in FIGS. 25(a) to 25(c), a conduction inspection member 41 is a probe card. In the conduction inspection member 41, a plurality of through holes 42a are formed on a base body 42 and a conductive section 43 is disposed in the through hole 42a. The conductive section 43 contains the metal-containing particle and exhibits conductivity. The BGA substrate 31 and the conduction inspection member 41 are prepared as illustrated in FIG. 25(a), and the BGA substrate 31 is brought into contact with the conduction inspection member 41 and compressed as illustrated in FIG. 25(b).

At this time, the solder ball 31B comes into contact with the conductive section 43 in the through hole 42a. In this state, an ammeter 32 is connected to the conductive section, the conduction inspection is performed, and the acceptance or rejection of the BGA substrate 31 can be determined as illustrated in FIG. 25(c).

Hereinafter, the present invention will be specifically described with reference to Examples and Comparative Examples. The present invention is not limited only to the following Examples.

### Example 1

As base particle A, a divinylbenzene copolymer resin particle (“Micropearl SP-203” manufactured by Sekisui Chemical Co., Ltd.) having a particle diameter of 3.0 μm was prepared.

In 100 parts by weight of an alkaline solution containing a palladium catalyst solution at 5% by weight, 10 parts by weight of the base particle A was dispersed using an ultrasonic disperser, and then the solution was filtered to take out the base particle A. Subsequently, the base particle A was added to 100 parts by weight of a 1% by weight solution of dimethylamine borane to activate the surface of the base particle A. The surface-activated base particle A was thoroughly washed with water and then added to and dispersed in 500 parts by weight of distilled water to obtain a suspension (A).

Next, 1 part by weight of metal nickel particle slurry (“2020SUS” manufactured by Mitsui Mining & Smelting Co., Ltd., average particle diameter: 150 nm) was added to the suspension (A) over 3 minutes to obtain a suspension (B) containing the base particle A to which a core substance was attached.

The suspension (B) was placed in a solution containing copper sulfate at 20 g/L and ethylenediaminetetraacetic acid at 30 g/L to obtain a particle mixture (C).

In addition, as an electroless copper plating solution, a copper plating solution (D) was prepared by adjusting the pH of a mixture containing copper sulfate at 250 g/L, ethylenediaminetetraacetic acid at 150 g/L, sodium gluconate at 100 g/L, and formaldehyde at 50 g/L to 10.5 with ammonia.

In addition, as an electroless silver plating solution, a silver plating solution (E) was prepared by adjusting the pH of a mixture containing silver nitrate at 30 g/L, succinimide at 100 g/L, and formaldehyde at 20 g/L to 8.0 with aqueous ammonia.

Moreover, a plating solution for protrusion formation (F) (pH 10.0) containing dimethylamine borane at 100 g/L and sodium hydroxide at 0.5 g/L was prepared.

In addition, as an electroless gold plating solution, an electrolytic substitution gold plating solution (G) (pH 6.5) containing gold potassium cyanide at 2 g/L, sodium citrate at 20 g/L, ethylenediaminetetraacetic acid at 3.0 g/L, and sodium hydroxide at 20 g/L was prepared.

The copper plating solution (D) was gradually dropped to the particle mixture (C) which was in a dispersed state and adjusted to 55° C. to perform electroless copper plating. The electroless copper plating was performed at a dropping rate of the copper plating solution (D) of 30 mL/min and a dropping time of 30 minutes. A particle mixture (H) containing a particle in which a copper metal section was disposed on the surface of a resin particle and a metal section having convexes on the surface of the metal section was equipped was thus obtained.

Thereafter, the particle was taken out by filtering the particle mixture (H) and washed with water to obtain a particle in which a copper metal section was disposed on the surface of the base particle A and a metal section having convexes on the surface of the metal section was equipped. This particle was thoroughly washed with water and then added to and dispersed in 500 parts by weight of distilled water to obtain a particle mixture (I).

Next, the silver plating solution (E) was gradually dropped to the particle mixture (I) which was in a dispersed state and adjusted to 60° C. to perform electroless silver plating. The electroless silver plating was performed at a dropping rate of the silver plating solution (E) of 10 mL/min and a dropping time of 30 minutes. Thereafter, the plating solution for protrusion formation (F) was gradually dropped thereto to form a protrusion. The protrusion formation was performed at a dropping rate of the plating solution for protrusion formation (F) of 1 mL/min and a dropping time of 10 minutes. Silver plating was performed while dispersing the generated silver protrusion nuclei by ultrasonic stirring during the dropping of the plating solution for protrusion formation (F) (protrusion forming step). This particle was thoroughly washed with water and then added to and dispersed in 500 parts by weight of distilled water to obtain a particle mixture (J). Next, the electroless substitution gold plating solution (G) was gradually dropped to the particle mixture (J) at 60° C. in which a particle was dispersed to perform electroless substitution gold plating. The electroless substitution gold plating was performed at a dropping rate of the electroless substitution gold plating solution (G) of 2 mL/min and a dropping time of 45 minutes. Thereafter, the particle was taken out by filtration, washed with water, and dried to obtain a metal-containing particle in which copper and silver metal sections and a gold metal film (the thickness of the entire metal sections and the entire metal films at the portion not having convexes: 0.105 μm) were disposed on the surface of the base particle A. The outer surface of the metal-containing particle has a convex and the surface of the convex has a plurality of protrusions.

### Example 2

A metal-containing particle was obtained in the same manner as Example 1 except that the metal nickel particle slurry was changed to an alumina particle slurry (average particle diameter: 150 nm).

### Example 3

The suspension (A) obtained in Example 1 was placed in a solution containing nickel sulfate at 40 ppm, trisodium citrate at 2 g/L, and aqueous ammonia at 10 g/L to obtain a particle mixture (B).

As a plating solution for needle-shaped protrusion formation, a mixture containing copper sulfate at 100 g/L, nickel sulfate at 10 g/L, sodium hypophosphite at 100 g/L, trisodium citrate at 70 g/L, boric acid at 10 g/L, and polyethylene glycol 1000 (molecular weight: 1,000) as a nonionic surfactant at 5 mg/L was prepared. Next, a plating solution for needle-shaped protrusion formation (C), which was an electroless copper-nickel-phosphorus alloy plating solution prepared by adjusting the pH of the mixture to pH 10.0 with aqueous ammonia, was prepared.

In addition, as an electroless silver plating solution, a silver plating solution (D) was prepared by adjusting the pH of a mixture containing silver nitrate at 30 g/L, succinimide at 100 g/L, and formaldehyde at 20 g/L to 8.0 with aqueous ammonia.

Moreover, a plating solution for protrusion formation (E) (pH 10.0) containing dimethylamine borane at 100 g/L and sodium hydroxide at 0.5 g/L was prepared.

In addition, as an electroless gold plating solution, an electrolytic substitution gold plating solution (F) (pH 6.5) containing gold potassium cyanide at 2 g/L, sodium citrate at 20 g/L, ethylenediaminetetraacetic acid at 3.0 g/L, and sodium hydroxide at 20 g/L was prepared.

The plating solution for needle-shaped protrusion formation (C) was gradually dropped to the particle mixture (B) which was in a dispersed state and adjusted to 70° C. to form a needle-shaped protrusion. The electroless copper-nickel-phosphorus alloy plating was performed at a dropping rate of the plating solution for needle-shaped protrusion formation (C) of 40 mL/min and a dropping time of 60 minutes (needle-shaped protrusion forming and copper-nickel-phosphorus alloy plating step). Thereafter, the particle was taken out by filtration to obtain a particle (G) in which a copper-nickel-phosphorus alloy metal section was disposed on the surface of the base particle A and a metal section having convexes on the surface of the metal section was equipped. The particle (G) was added to and dispersed in 500 parts by weight of distilled water to obtain a suspension (H).

Thereafter, the particle was taken out by filtering the suspension (H) and washed with water to obtain a particle in which a copper-nickel-phosphorus alloy metal section was disposed on the surface of the base particle A and a metal section having needle-shaped convexes on the surface of the metal section was equipped. This particle was thoroughly washed with water and then added to and dispersed in 500 parts by weight of distilled water to obtain a particle mixture (I).

Next, the silver plating solution (D) was gradually dropped to the particle mixture (I) which was in a dispersed state and adjusted to 60° C. to perform electroless silver plating. The electroless silver plating was performed at a dropping rate of the silver plating solution (D) of 10 mL/min and a dropping time of 30 minutes. Thereafter, the plating solution for protrusion formation (E) was gradually dropped thereto to form a protrusion. The protrusion formation was performed at a dropping rate of the plating solution for protrusion formation (E) of 1 mL/min and a dropping time of 10 minutes. Silver plating was performed while dispersing the generated silver protrusion nuclei by ultrasonic stirring during the dropping of the plating solution for protrusion formation (E) (protrusion forming step). This particle was thoroughly washed with water and then added to and dispersed in 500 parts by weight of distilled water to obtain a particle mixture (J). Next, the electroless substitution gold plating solution (F) was gradually dropped to the particle mixture (J) at 60° C. in which a particle was dispersed to perform electroless substitution gold plating. The electroless substitution gold plating was performed at a dropping rate of the electroless substitution gold plating solution (F) of 2 mL/min and a dropping time of 45 minutes. Thereafter, the particle was taken out by filtration, washed with water, and dried to obtain a metal-containing particle in which copper-nickel-phosphorus alloy and silver metal sections and a gold metal film (the thickness of the entire metal sections and the entire metal films at the portion not having convexes: 0.105 μm) were disposed on the surface of the base particle A. The outer surface of the metal-containing particle has a plurality of needle-shaped convexes and the surface of the convex has a plurality of protrusions.

### Example 4

The suspension (A) obtained in Example 1 was placed in a solution containing nickel sulfate at 80 g/L, thallium nitrate at 10 ppm, and bismuth nitrate at 5 ppm to obtain a particle mixture (B).

As a plating solution for needle-shaped protrusion formation, a plating solution for needle-shaped protrusion formation (C), which was an electroless highly pure nickel plating solution obtained by adjusting the pH of a mixture containing nickel chloride at 100 g/L, hydrazine monohydrate at 100 g/L, trisodium citrate at 50 g/L, and polyethylene glycol 1000 (molecular weight: 1,000) at 20 mg/L to 9.0 with sodium hydroxide, was prepared.

In addition, as an electroless silver plating solution, a silver plating solution (D) was prepared by adjusting the pH of a mixture containing silver nitrate at 30 g/L, succinimide at 100 g/L, and formaldehyde at 20 g/L to 8.0 with aqueous ammonia.

Moreover, a plating solution for protrusion formation (E) (pH 10.0) containing dimethylamine borane at 100 g/L and sodium hydroxide at 0.5 g/L was prepared.

In addition, as an electroless substitution gold plating solution, an electrolytic substitution gold plating solution (F) (pH 6.5) containing gold potassium cyanide at 2 g/L, sodium citrate at 20 g/L, ethylenediaminetetraacetic acid at 3.0 g/L, and sodium hydroxide at 20 g/L was prepared.

The plating solution for needle-shaped protrusion formation (C) was gradually dropped to the particle mixture (B) which was in a dispersed state and adjusted to 60° C. to form a needle-shaped protrusion. The electroless highly pure nickel plating was performed at a dropping rate of the plating solution for needle-shaped protrusion formation (C) of 20 mL/min and a dropping time of 50 minutes (needle-shaped protrusion forming and highly pure nickel plating step). Thereafter, the particle was taken out by filtration to obtain a particle (G) in which a highly pure nickel metal section was disposed on the surface of the base particle A and a metal section having convexes on the surface of the metal section was equipped. The particle (G) was added to and dispersed in 500 parts by weight of distilled water to obtain a suspension (H).

Thereafter, the particle was taken out by filtering the suspension (H) and washed with water to obtain a particle in which a highly pure nickel metal section was disposed on the surface of the base particle A and a metal section having needle-shaped convexes on the surface of the metal section was equipped. This particle was thoroughly washed with water and then added to and dispersed in 500 parts by weight of distilled water to obtain a particle mixture (I).

Next, the silver plating solution (D) was gradually dropped to the particle mixture (I) which was in a dispersed state and adjusted to 60° C. to perform electroless silver plating. The electroless silver plating was performed at a dropping rate of the silver plating solution (D) of 10 mL/min and a dropping time of 30 minutes. Thereafter, the plating solution for protrusion formation (E) was gradually dropped thereto to form a protrusion. The protrusion formation was performed at a dropping rate of the plating solution for protrusion formation (E) of 1 mL/min and a dropping time of 10 minutes. Silver plating was performed while dispersing the generated silver protrusion nuclei by ultrasonic stirring during the dropping of the plating solution for protrusion formation (E) (protrusion forming step). This particle was thoroughly washed with water and then added to and dispersed in 500 parts by weight of distilled water to obtain a particle mixture (J). Next, the electroless substitution gold plating solution (F) was gradually dropped to the particle mixture (J) at 60° C. in which a particle was dispersed to perform electroless substitution gold plating. The electroless substitution gold plating was performed at a dropping rate of the electroless substitution gold plating solution (F) of 2 mL/min and a dropping time of 45 minutes. Thereafter, the particle was taken out by filtration to obtain a metal-containing particle in which highly pure nickel and silver metal sections and a gold metal film (the thickness of the entire metal sections and the entire metal films at the portion not having convexes: 0.105 μm) were disposed on the surface of the base particle A. The outer surface of the metal-containing particle has a plurality of needle-shaped convexes and the surface of the convex has a plurality of protrusions.

### Example 5

The suspension (A) obtained in Example 1 was placed in a solution containing silver nitrate at 500 ppm, succinimide at 10 g/L, and aqueous ammonia at 10 g/L to obtain a particle mixture (B).

In addition, as an electroless silver plating solution, a silver plating solution (C) was prepared by adjusting the pH of a mixture containing silver nitrate at 30 g/L, succinimide at 100 g/L, and formaldehyde at 20 g/L to 8 with aqueous ammonia.

Moreover, a plating solution for protrusion formation (D) (pH 10.0) containing dimethylamine borane at 100 g/L and sodium hydroxide at 0.5 g/L was prepared.

In addition, as an electroless substitution gold plating solution, an electrolytic substitution gold plating solution (E) (pH 6.5) containing gold potassium cyanide at 2 g/L, sodium citrate at 20 g/L, ethylenediaminetetraacetic acid at 3.0 g/L, and sodium hydroxide at 20 g/L was prepared.

The electroless silver plating solution (C) was gradually dropped to the particle mixture (B) which was in a dispersed state and adjusted to 60° C. to form a needle-shaped protrusion. The electroless silver plating was performed at a dropping rate of the electroless silver plating solution (C) of 10 mL/min and a dropping time of 30 minutes (silver plating step). Thereafter, the plating solution for protrusion formation (D) was gradually dropped thereto to form a protrusion. The protrusion formation was performed at a dropping rate of the plating solution for protrusion formation (D) of 1 mL/min and a dropping time of 10 minutes. Silver plating was performed while dispersing the generated silver protrusion nuclei by ultrasonic stirring during the dropping of the plating solution for protrusion formation (D) (protrusion forming step). This particle was thoroughly washed with water and then added to and dispersed in 500 parts by weight of distilled water to obtain a particle mixture (F). Next, the electroless substitution gold plating solution (E) was gradually dropped to the particle mixture (F) at 60° C. in which a particle was dispersed to perform electroless substitution gold plating. The electroless substitution gold plating was performed at a dropping rate of the electroless substitution gold plating solution (E) of 2 mL/min and a dropping time of 45 minutes. Thereafter, the particle was taken out by filtration, washed with water, and dried to obtain a metal-containing particle in which a silver metal section and a gold metal film (the thickness of the entire metal sections and the entire metal films at the portion not having protrusions: 0.105 μm) were disposed on the surface of the base particle A. The outer surface of the metal-containing particle has a plurality of protrusions.

### Example 6

The suspension (A) obtained in Example 1 was placed in a solution containing silver potassium cyanide at 500 ppm, potassium cyanide at 10 g/L, and potassium hydroxide at 10 g/L to obtain a particle mixture (B).

As a plating solution for needle-shaped protrusion formation, a silver plating solution (C) was prepared by adjusting the pH of a mixture containing silver potassium cyanide at 80 g/L, potassium cyanide at 10 g/L, polyethylene glycol 1000 (molecular weight: 1,000) at 20 mg/L, thiourea at 50 ppm, and hydrazine monohydrate at 100 g/L to 7.5 with potassium hydroxide.

In addition, as an electroless substitution gold plating solution, an electrolytic substitution gold plating solution (D) (pH 6.5) containing gold potassium cyanide at 2 g/L, sodium citrate at 20 g/L, ethylenediaminetetraacetic acid at 3.0 g/L, and sodium hydroxide at 20 g/L was prepared.

The electroless silver plating solution (C) was gradually dropped to the particle mixture (B) which was in a dispersed state and adjusted to 80° C. to form a needle-shaped protrusion. The electroless silver plating was performed at a dropping rate of the electroless silver plating solution (C) of 10 mL/min and a dropping time of 60 minutes (needle-shaped protrusion forming and silver plating step). This particle was thoroughly washed with water and then added to and dispersed in 500 parts by weight of distilled water to obtain a particle mixture (E). Next, the electroless substitution gold plating solution (D) was gradually dropped to the particle mixture (E) at 60° C. in which a particle was dispersed to perform electroless substitution gold plating. The electroless substitution gold plating was performed at a dropping rate of the electroless substitution gold plating solution (D) of 2 mL/min and a dropping time of 45 minutes. Thereafter, the particle was taken out by filtration, washed with water, and dried to obtain a metal-containing particle in which a silver metal section and a gold metal film (the thickness of the entire metal sections and the entire metal films at the portion not having protrusions: 0.105 μm) were disposed on the surface of a resin particle. In the metal-containing particle, the outer surface of the metal-containing particle has a plurality of needle-shaped protrusions.

### Example 7

The suspension (A) obtained in Example 1 was placed in a solution containing silver potassium cyanide at 500 ppm, potassium cyanide at 10 g/L, and potassium hydroxide at 10 g/L to obtain a particle mixture (B).

As a plating solution for needle-shaped protrusion formation, a silver plating solution (C) was prepared by adjusting the pH of a mixture containing silver potassium cyanide at 80 g/L, potassium cyanide at 10 g/L, polyethylene glycol 1000 (molecular weight: 1,000) at 20 mg/L, thiourea at 50 ppm, and hydrazine monohydrate at 100 g/L to 7.5 with potassium hydroxide.

In addition, as an electroless silver plating solution, a silver plating solution (D) was prepared by adjusting the pH of a mixture containing silver nitrate at 30 g/L, succinimide at 100 g/L, and formaldehyde at 20 g/L to 8.0 with aqueous ammonia.

Moreover, a plating solution for protrusion formation (E) (pH 10.0) containing dimethylamine borane at 100 g/L and sodium hydroxide at 0.5 g/L was prepared.

In addition, as an electroless substitution gold plating solution, an electrolytic substitution gold plating solution (F) (pH 6.5) containing gold potassium cyanide at 2 g/L, sodium citrate at 20 g/L, ethylenediaminetetraacetic acid at 3.0 g/L, and sodium hydroxide at 20 g/L was prepared.

The electroless silver plating solution (C) was gradually dropped to the particle mixture (B) which was in a dispersed state and adjusted to 80° C. to form a needle-shaped protrusion. The electroless silver plating was performed at a dropping rate of the electroless silver plating solution (C) of 10 mL/min and a dropping time of 45 minutes (needle-shaped protrusion forming and silver plating step).

Thereafter, the particle was taken out by filtration to obtain a particle (G) in which a silver metal section was disposed on the surface of the base particle A and a metal section having needle-shaped convexes on the surface of the metal section was equipped. The particle (G) was added to and dispersed in 500 parts by weight of distilled water to obtain a particle mixture (H).

Next, the silver plating solution (D) was gradually dropped to the particle mixture (H) which was in a dispersed state and adjusted to 60° C. to perform electroless silver plating. The electroless silver plating was performed at a dropping rate of the silver plating solution (D) of 10 mL/min and a dropping time of 30 minutes. Thereafter, the plating solution for protrusion formation (E) was gradually dropped thereto to form a protrusion. The protrusion formation was performed at a dropping rate of the plating solution for protrusion formation (E) of 1 mL/min and a dropping time of 10 minutes. Silver plating was performed while dispersing the generated silver protrusion nuclei by ultrasonic stirring during the dropping of the plating solution for protrusion formation (E) (protrusion forming step). This particle was thoroughly washed with water and then added to and dispersed in 500 parts by weight of distilled water to obtain a particle mixture (I). Next, the electroless substitution gold plating solution (F) was gradually dropped to the particle mixture (I) at 60° C. in which a particle was dispersed to perform electroless substitution gold plating. The electroless substitution gold plating was performed at a dropping rate of the electroless substitution gold plating solution (F) of 2 mL/min and a dropping time of 45 minutes. Thereafter, the particle was taken out by filtration, washed with water, and dried to obtain a metal-containing particle in which silver and gold metal sections and a gold metal film (the thickness of the entire metal sections and the entire metal films at the portion not having convexes: 0.105 μm) were disposed on the surface of the base particle A. The outer surface of the metal-containing particle has a plurality of needle-shaped convexes and the surface of the convex has a plurality of protrusions.

### Example 8

The suspension (B) obtained in Example 1 was placed in a solution containing nickel sulfate at 50 g/L, thallium nitrate at 30 ppm, and bismuth nitrate at 20 ppm to obtain a particle mixture (C).

As an electroless nickel-tungsten-boron alloy plating solution, a mixture containing nickel sulfate at 100 g/L, sodium tungstate at 5 g/L, dimethylamine borane at 30 g/L, bismuth nitrate at 10 ppm, and trisodium citrate at 30 g/L was prepared. Next, an electroless nickel-tungsten-boron alloy plating solution (D) was prepared by adjusting the pH of the mixture to 6 with sodium hydroxide.

In addition, as an electroless silver plating solution, a silver plating solution (E) was prepared by adjusting the pH of a mixture containing silver nitrate at 30 g/L, succinimide at 100 g/L, and formaldehyde at 20 g/L to 8.0 with aqueous ammonia.

Moreover, a plating solution for protrusion formation (F) (pH 10.0) containing dimethylamine borane at 100 g/L and sodium hydroxide at 0.5 g/L was prepared.

In addition, as an electroless substitution gold plating solution, an electrolytic substitution gold plating solution (G) (pH 6.5) containing gold potassium cyanide at 2 g/L, sodium citrate at 20 g/L, ethylenediaminetetraacetic acid at 3.0 g/L, and sodium hydroxide at 20 g/L was prepared.

The electroless nickel-tungsten-boron alloy plating solution (D) was gradually dropped to the particle mixture (C) which was in a dispersed state and adjusted to 60° C. to perform electroless nickel-tungsten-boron alloy plating. The electroless nickel-tungsten-boron alloy plating was performed at a dropping rate of the electroless nickel-tungsten-boron alloy plating solution (D) of 15 mL/min and a dropping time of 60 minutes. A particle mixture (H) containing a particle in which a nickel-tungsten-boron alloy metal section was disposed on the surface of the base particle A and a metal section having convexes on the surface of the metal section was equipped was thus obtained.

Thereafter, the particle was taken out by filtering the particle mixture (H) and washed with water to obtain a particle in which a nickel-tungsten-boron alloy metal layer was disposed on the surface of the base particle A and a metal section having convexes on the surface of the metal section was equipped. This particle was thoroughly washed with water and then added to and dispersed in 500 parts by weight of distilled water to obtain a particle mixture (I).

Next, the silver plating solution (E) was gradually dropped to the particle mixture (I) which was in a dispersed state and adjusted to 60° C. to perform electroless silver plating. The electroless silver plating was performed at a dropping rate of the silver plating solution (E) of 10 mL/min and a dropping time of 30 minutes. Thereafter, the plating solution for protrusion formation (F) was gradually dropped thereto to form a protrusion. The protrusion formation was performed at a dropping rate of the plating solution for protrusion formation (F) of 1 mL/min and a dropping time of 10 minutes. Silver plating was performed while dispersing the generated silver protrusion nuclei by ultrasonic stirring during the dropping of the plating solution for protrusion formation (F) (protrusion forming step). This particle was thoroughly washed with water and then added to and dispersed in 500 parts by weight of distilled water to obtain a particle mixture (J). Next, the electroless substitution gold plating solution (G) was gradually dropped to the particle mixture (J) at 60° C. in which a particle was dispersed to perform electroless substitution gold plating. The electroless substitution gold plating was performed at a dropping rate of the electroless substitution gold plating solution (G) of 2 mL/min and a dropping time of 45 minutes. Thereafter, the particle was taken out by filtration, washed with water, and dried to obtain a metal-containing particle in which nickel-tungsten-boron alloy and silver metal sections and a gold metal film (the thickness of the entire metal sections and the entire metal films at the portion not having convexes: 0.105 μm) were disposed on the surface of the base particle A. The outer surface of the metal-containing particle has a plurality of convexes and the surface of the convex has a plurality of protrusions.

### Example 9

The suspension (B) obtained in Example 1 was placed in a solution containing nickel sulfate at 50 g/L, thallium nitrate at 30 ppm, and bismuth nitrate at 20 ppm to obtain a particle mixture (C).

As an electroless nickel-tungsten-boron alloy plating solution, a mixture containing nickel sulfate at 100 g/L, sodium tungstate at 2 g/L, dimethylamine borane at 30 g/L, bismuth nitrate at 10 ppm, and trisodium citrate at 30 g/L was prepared. Next, an electroless nickel-tungsten-boron alloy plating solution (D) was prepared by adjusting the pH of the mixture to 6 with sodium hydroxide.

In addition, as an electroless silver plating solution, a silver plating solution (E) was prepared by adjusting the pH of a mixture containing silver nitrate at 30 g/L, succinimide at 100 g/L, and formaldehyde at 20 g/L to 8.0 with aqueous ammonia.

Moreover, a plating solution for protrusion formation (F) (pH 10.0) containing sodium borohydride at 30 g/L and sodium hydroxide at 0.5 g/L was prepared.

In addition, as an electroless palladium plating solution, an electroless palladium plating solution (G) was prepared by adjusting the pH of a mixture containing palladium sulfate at 2.5 g/L, ethylenediamine at 30 ml/L, sodium formate at 80 g/L, and saccharin sodium at 5 mg/L to 8 with ammonia.

The electroless nickel-tungsten-boron alloy plating solution (D) was gradually dropped to the particle mixture (C) which was in a dispersed state and adjusted to 60° C. to perform electroless nickel-tungsten-boron alloy plating. The electroless nickel-tungsten-boron alloy plating was performed at a dropping rate of the electroless nickel-tungsten-boron alloy plating solution (D) of 15 mL/min and a dropping time of 60 minutes. A particle (H) in which a nickel-tungsten-boron alloy metal section was disposed on the surface of the base particle A and a metal section having convexes on the surface of the metal section was equipped was thus obtained.

Thereafter, the particle was taken out by filtering the suspension (H) and washed with water to obtain a particle in which a nickel-tungsten-boron alloy metal section was disposed on the surface of the base particle A and a metal section having convexes on the surface of the metal section was equipped. This particle was thoroughly washed with water and then added to and dispersed in 500 parts by weight of distilled water to obtain a particle mixture (I).

Next, the electroless silver plating solution (E) was gradually dropped to the particle mixture (I) which was in a dispersed state and adjusted to 60° C. to perform electroless silver plating. The electroless silver plating was performed at a dropping rate of the electroless silver plating solution (E) of 10 mL/min and a dropping time of 30 minutes. Thereafter, the plating solution for protrusion formation (F) was gradually dropped thereto to form a protrusion. The protrusion formation was performed at a dropping rate of the plating solution for protrusion formation (F) of 1 mL/min and a dropping time of 5 minutes. Silver plating was performed while dispersing the generated silver protrusion nuclei by ultrasonic stirring during the dropping of the plating solution for protrusion formation (F) (protrusion forming step). This particle was thoroughly washed with water and then added to and dispersed in 500 parts by weight of distilled water to obtain a particle mixture (J). Next, the electroless palladium plating solution (G) was gradually dropped to the particle mixture (J) at 55° C. in which a particle was dispersed to perform electroless palladium plating. The electroless palladium plating was performed at a dropping rate of the electroless palladium plating solution (G) of 2 mL/min and a dropping time of 45 minutes. Thereafter, the particle was taken out by filtration, washed with water, and dried to obtain a metal-containing particle in which nickel-tungsten-boron alloy and silver metal sections and a palladium metal film (the thickness of the entire metal sections and the entire metal films at the portion not having convexes: 0.105 μm) were disposed on the surface of the base particle A. The outer surface of the metal-containing particle has a plurality of convexes and the surface of the convex has a plurality of protrusions.

### Example 10

The suspension (B) obtained in Example 1 was placed in a solution containing copper sulfate at 20 g/L and ethylenediaminetetraacetic acid at 30 g/L to obtain a particle mixture (C).

In addition, as an electroless copper plating solution, a copper plating solution (D) was prepared by adjusting the pH of a mixture containing copper sulfate at 250 g/L, ethylenediaminetetraacetic acid at 150 g/L, sodium gluconate at 100 g/L, and formaldehyde at 50 g/L to 10.5 with ammonia.

In addition, as an electroless silver plating solution, a silver plating solution (E) was prepared by adjusting the pH of a mixture containing silver nitrate at 30 g/L, succinimide at 100 g/L, and formaldehyde at 20 g/L to 8.0 with aqueous ammonia.

Moreover, a plating solution for protrusion formation (F) (pH 7.0) containing dimethylamine borane at 100 g/L was prepared.

In addition, as an electroless palladium plating solution, an electroless palladium plating solution (G) was prepared by adjusting the pH of a mixture containing palladium sulfate at 2.5 g/L, ethylenediamine at 30 ml/L, sodium formate at 80 g/L, and saccharin sodium at 5 mg/L to 8 with ammonia.

The copper plating solution (D) was gradually dropped to the particle mixture (C) which was in a dispersed state and adjusted to 55° C. to perform electroless copper plating. The electroless copper plating was performed at a dropping rate of the copper plating solution (D) of 30 mL/min and a dropping time of 30 minutes. Thereafter, the particle was taken out by filtration, and a particle mixture (H) in which a copper metal section was disposed on the surface of the base particle A and a metal section having convexes on the surface of the metal section was equipped was thus obtained.

Thereafter, the particle was taken out by filtering the particle mixture (H) and washed with water to obtain a particle in which a copper metal section was disposed on the surface of the base particle A and a metal section having convexes on the surface of the metal section was equipped. This particle was thoroughly washed with water and then added to and dispersed in 500 parts by weight of distilled water to obtain a particle mixture (I).

Next, the silver plating solution (E) was gradually dropped to the particle mixture (I) which was in a dispersed state and adjusted to 60° C. to perform electroless silver plating. The electroless silver plating was performed at a dropping rate of the silver plating solution (E) of 10 mL/min and a dropping time of 30 minutes. Thereafter, the plating solution for protrusion formation (F) was gradually dropped thereto to form a protrusion. The protrusion formation was performed at a dropping rate of the plating solution for protrusion formation (F) of 1 mL/min and a dropping time of 10 minutes. Silver plating was performed while dispersing the generated silver protrusion nuclei by ultrasonic stirring during the dropping of the plating solution for protrusion formation (F) (protrusion forming step). This particle was thoroughly washed with water and then added to and dispersed in 500 parts by weight of distilled water to obtain a particle mixture (J). Next, the electroless palladium plating solution (G) was gradually dropped to the particle mixture (J) at 55° C. in which a particle was dispersed to perform electroless palladium plating. The electroless palladium plating was performed at a dropping rate of the electroless palladium plating solution (G) of 2 mL/min and a dropping time of 45 minutes. Thereafter, the particle was taken out by filtration, washed with water, and dried to obtain a metal-containing particle in which copper and silver metal sections and a palladium metal film (the thickness of the entire metal sections and the entire metal films at the portion not having convexes: 0.105 μm) were disposed on the surface of the base particle A. The outer surface of the metal-containing particle has a plurality of convexes and the surface of the convex has a plurality of protrusions.

### Example 11

(1) Fabrication of Silicone Oligomer

In a 100 ml separable flask installed in a hot bath, 1 part by weight of 1,3-divinyltetramethyldisiloxane and 20 parts by weight of a 0.5% by weight aqueous solution of p-toluenesulfonic acid were placed. After the mixture was stirred at 40° C. for 1 hour, 0.05 parts by weight of sodium hydrogen carbonate was added thereto. Thereafter, 10 parts by weight of dimethoxymethylphenylsilane, 49 parts by weight of dimethyldimethoxysilane, 0.6 parts by weight of trimethylmethoxysilane, and 3.6 parts by weight of methyltrimethoxysilane were added to the mixture, and this mixture was stirred for 1 hour. Thereafter, 1.9 parts by weight of a 10% by weight aqueous solution of potassium hydroxide was added to the resultant mixture, the temperature of this mixture was raised to 85° C., and the mixture was stirred and reacted for 10 hours while the pressure was lowered using an aspirator. After completion of the reaction, the pressure was returned to normal pressure, and the reaction mixture was cooled to 40° C., 0.2 parts by weight of acetic acid was added thereto, and the mixture was allowed to stand in a separatory funnel for 12 hours or more. After separation of two layers, the lower layer was taken out and purified using an evaporator to obtain a silicone oligomer.

(2) Fabrication of Silicone Particle Material (Containing Organic Polymer)

A solution A was prepared by dissolving 0.5 parts by weight of tert-butyl 2-ethylperoxyhexanoate (polymerization initiator, “PERBUTYL 0” manufactured by NOF Corporation) in 30 parts by weight of the silicone oligomer obtained. In addition, an aqueous solution B was prepared by mixing 0.8 parts by weight of a 40% by weight aqueous solution of triethanolamine lauryl sulfate (emulsifier) and 80 parts by weight of a 5% by weight aqueous solution of polyvinyl alcohol (degree of polymerization: about 2,000, degree of saponification: 86.5 to 89% by mole, “GOHSENOL GH-20” manufactured by The Nippon Synthetic Chemical Industry Co., Ltd.) in 150 parts by weight of ion-exchanged water. The solution A was placed in a separable flask installed in a hot bath, and then the aqueous solution B was added thereto. Thereafter, emulsification was performed by using a Shirasu Porous Glass (SPG) membrane (pore average diameter: about 1 μm). Thereafter, the temperature of the emulsion was raised to 85° C., and polymerization was performed for 9 hours. The whole particles after polymerization were washed with water by centrifugation and freeze-dried. After drying, the aggregate of particles was crushed using a ball mill until the intended ratio (average secondary particle diameter/average primary particle diameter) was attained, thereby obtaining a silicone particle (base particle B) having a particle diameter of 3.0 μm.

The base particle A was changed to the base particle B, and a metal section and a metal film were formed in the same manner as in Example 1, thereby obtaining a metal-containing particle.

### Example 12

A silicone particle (base particle C) having a particle diameter of 3.0 μm was obtained using both terminals acrylic silicone oil (“X-22-2445” manufactured by Shin-Etsu Chemical Co., Ltd.) instead of the silicone oligomer.

The base particle A was changed to the base particle C, and a metal section and a metal film were formed in the same manner as in Example 1, thereby obtaining a metal-containing particle.

### Example 13

A pure copper particle (“HXR-Cu” manufactured by NIPPON ATOMIZED METAL POWDERS CORPORATION, particle diameter: 2.5 μm) was prepared as a base particle D.

The base particle A was changed to the base particle D, and a metal section and a metal film were formed in the same manner as in Example 1, thereby obtaining a metal-containing particle.

### Example 14

A pure silver particle (particle diameter: 2.5 μm) was prepared as a base particle E.

The base particle A was changed to the base particle E, and a metal section and a metal film were formed in the same manner as in Example 1, thereby obtaining a metal-containing particle.

### Example 15

A base particle F, which was different from the base particle A only in the particle diameter and had a particle diameter of 2.0 μm, was prepared.

The base particle A was changed to the base particle F, and a metal section and a metal film were formed in the same manner as in Example 1, thereby obtaining a metal-containing particle.

### Example 16

A base particle G, which was different from the base particle A only in the particle diameter and had a particle diameter of 10.0 μm, was prepared.

The base particle A was changed to the base particle G, and a metal section and a metal film were formed in the same manner as in Example 1, thereby obtaining a metal-containing particle.

### Example 17

A base particle H, which was different from the base particle A only in the particle diameter and had a particle diameter of 50.0 μm, was prepared.

The base particle A was changed to the base particle H, and a metal section and a metal film were formed in the same manner as in Example 1, thereby obtaining a metal-containing particle.

### Example 18

A monomer composition containing 100 mmol of methyl methacrylate, 1 mmol of N,N,N-trimethyl-N-2-methacryloyloxyethylammonium chloride, and 1 mmol of 2,2′-azobis(2-amidinopropane) dihydrochloride was weighed and placed in ion-exchanged water so as to have a solid content of 5% by weight. In a 1,000 mL separable flask equipped with a four-neck separable cover, a stirrer, a three-way cock, a condenser, and a temperature probe, the monomer composition was placed, stirred at 200 rpm, and subjected to polymerization at 70° C. for 24 hours in a nitrogen atmosphere. After completion of the reaction, the resultant was freeze-dried to obtain insulating particles having an ammonium group on the surface, an average particle diameter of 220 nm, and a CV value of 10%.

The insulating particles were dispersed in ion-exchanged water under ultrasonic irradiation to obtain a 10% by weight aqueous dispersion of insulating particles.

In 500 mL of ion-exchanged water, 10 g of the metal-containing particle obtained in Example 1 was dispersed, 4 g of the aqueous dispersion of insulating particle was added thereto, and the mixture was stirred at room temperature for 6 hours. After filtration through a 3 μm mesh filter, the resultant was further washed with methanol and dried to obtain a metal-containing particle to which an insulating particle was attached.

As a result of observation under a scanning electron microscope (SEM), only one covering layer composed of an insulating particle was formed on the surface of the metal-containing particle. The coverage factor was 30% when the area covered with the insulating particle (namely, the projected area of the particle diameter of insulating particle) with respect to the area of the portion from the center of the metal-containing particle to 2.5 μm was calculated by image analysis.

### Example 19

The suspension (B) obtained in Example 1 was placed in a solution containing nickel sulfate at 50 g/L, thallium nitrate at 30 ppm, and bismuth nitrate at 20 ppm to obtain a particle mixture (C).

As an electroless nickel-phosphorus alloy plating solution, an electroless nickel-phosphorus alloy plating solution (D) was prepared by adjusting the pH of a mixture containing nickel sulfate at 100 g/L, sodium hypophosphite at 30 g/L, bismuth nitrate at 10 ppm, and trisodium citrate at 30 g/L to 6 with sodium hydroxide.

In addition, as an electroless silver plating solution, a silver plating solution (E) was prepared by adjusting the pH of a mixture containing silver nitrate at 30 g/L, succinimide at 100 g/L, and formaldehyde at 20 g/L to 8.0 with aqueous ammonia.

Moreover, a plating solution for protrusion formation (F) (pH 12.0) containing sodium hypophosphite at 130 g/L and sodium hydroxide at 0.5 g/L was prepared.

In addition, as an electroless substitution gold plating solution, an electrolytic substitution gold plating solution (G) (pH 6.5) containing gold potassium cyanide at 2 g/L, sodium citrate at 20 g/L, ethylenediaminetetraacetic acid at 3.0 g/L, and sodium hydroxide at 20 g/L was prepared.

The electroless nickel-phosphorus alloy plating solution (D) was gradually dropped to the particle mixture (C) which was in a dispersed state and adjusted to 65° C. to perform electroless nickel-phosphorus alloy plating. The electroless nickel-phosphorus alloy plating was performed at a dropping rate of the electroless nickel-phosphorus alloy plating solution (D) of 15 mL/min and a dropping time of 60 minutes. A particle mixture (H) containing a particle in which a nickel-phosphorus alloy metal section was disposed on the surface of the base particle A and a metal section having convexes on the surface of the metal section was equipped was thus obtained.

Thereafter, the particle was taken out by filtering the particle mixture (H) and washed with water to obtain a particle in which a nickel-phosphorus alloy metal layer was disposed on the surface of the base particle A and a metal section having convexes on the surface of the metal section was equipped. This particle was thoroughly washed with water and then added to and dispersed in 500 parts by weight of distilled water to obtain a particle mixture (I).

Next, the silver plating solution (E) was gradually dropped to the particle mixture (I) which was in a dispersed state and adjusted to 60° C. to perform electroless silver plating. The electroless silver plating was performed at a dropping rate of the silver plating solution (E) of 10 mL/min and a dropping time of 30 minutes. Thereafter, the plating solution for protrusion formation (F) was gradually dropped thereto to form a protrusion. The protrusion formation was performed at a dropping rate of the plating solution for protrusion formation (F) of 1 mL/min and a dropping time of 10 minutes. Silver plating was performed while dispersing the generated silver protrusion nuclei by ultrasonic stirring during the dropping of the plating solution for protrusion formation (F) (protrusion forming step). This particle was thoroughly washed with water and then added to and dispersed in 500 parts by weight of distilled water to obtain a particle mixture (J). Next, the electroless substitution gold plating solution (G) was gradually dropped to the particle mixture (J) at 60° C. in which a particle was dispersed to perform electroless substitution gold plating. The electroless substitution gold plating was performed at a dropping rate of the electroless substitution gold plating solution (G) of 2 mL/min and a dropping time of 45 minutes. Thereafter, the particle was taken out by filtration, washed with water, and dried to obtain a metal-containing particle in which nickel-phosphorus alloy and silver metal sections and a gold metal film (the thickness of the entire metal sections and the entire metal films at the portion not having convexes: 0.105 μm) were disposed on the surface of the base particle A. The outer surface of the metal-containing particle has a plurality of convexes and the surface of the convex has a plurality of protrusions.

### Example 20

The metal-containing particle obtained in Example 1 was subjected to an anti-sulfurization treatment using “New Dain Silver” manufactured by Daiwa Fine Chemicals Co., Ltd. as a silver anti-tarnish agent.

In 100 parts by weight of an isopropyl alcohol solution containing New Dain Silver at 10% by weight, 10 parts by weight of the metal-containing particle obtained in Example 1 was dispersed using an ultrasonic disperser, and then the solution was filtered to obtain a metal-containing particle in which an anti-sulfurization film was formed.

### Example 21

The metal-containing particle obtained in Example 1 was subjected to an anti-sulfurization treatment using a 2-mercaptobenzothiazole solution as a silver anti-tarnish agent.

In 100 parts by weight of an isopropyl alcohol solution containing 2-mercaptobenzothiazole at 0.5% by weight, 10 parts by weight of the metal-containing particle obtained in Example 1 was dispersed using an ultrasonic disperser, and then the solution was filtered to obtain a metal-containing particle in which an anti-sulfurization film was formed.

### Example 22

The suspension (B) obtained in Example 1 was placed in a solution containing copper sulfate at 20 g/L and ethylenediaminetetraacetic acid at 30 g/L to obtain a particle mixture (C).

In addition, as an electroless copper plating solution, a copper plating solution (D) was prepared by adjusting the pH of a mixture containing copper sulfate at 250 g/L, ethylenediaminetetraacetic acid at 150 g/L, sodium gluconate at 100 g/L, and formaldehyde at 50 g/L to 10.5 with ammonia.

In addition, as an electroless silver plating solution, a silver plating solution (E) was prepared by adjusting the pH of a mixture containing silver nitrate at 30 g/L, succinimide at 100 g/L, and formaldehyde at 20 g/L to 8.0 with aqueous ammonia.

Moreover, a plating solution for protrusion formation (F) (pH 10.0) containing dimethylamine borane at 100 g/L and sodium hydroxide at 0.5 g/L was prepared.

The copper plating solution (D) was gradually dropped to the particle mixture (C) which was in a dispersed state and adjusted to 55° C. to perform electroless copper plating. The electroless copper plating was performed at a dropping rate of the copper plating solution (D) of 30 mL/min and a dropping time of 30 minutes. A particle mixture (G) containing a particle in which a copper metal section was disposed on the surface of a resin particle and a metal section having convexes on the surface of the metal section was equipped was thus obtained.

Thereafter, the particle was taken out by filtering the particle mixture (G) and washed with water to obtain a particle in which a copper metal section was disposed on the surface of the base particle A and a metal section having convexes on the surface of the metal section was equipped. This particle was thoroughly washed with water and then added to and dispersed in 500 parts by weight of distilled water to obtain a particle mixture (H).

Next, the silver plating solution (E) was gradually dropped to the particle mixture (H) which was in a dispersed state and adjusted to 60° C. to perform electroless silver plating. The electroless silver plating was performed at a dropping rate of the silver plating solution (E) of 10 mL/min and a dropping time of 30 minutes. Thereafter, the plating solution for protrusion formation (F) was gradually dropped thereto to form a protrusion. The protrusion formation was performed at a dropping rate of the plating solution for protrusion formation (F) of 1 mL/min and a dropping time of 10 minutes. Silver plating was performed while dispersing the generated silver protrusion nuclei by ultrasonic stirring during the dropping of the plating solution for protrusion formation (F) (protrusion forming step). Thereafter, the particle was taken out by filtration, washed with water, and dried to obtain a metal-containing particle in which copper and silver metal sections and a silver metal film (the thickness of the entire metal sections and the entire metal films at the portion not having convexes: 0.105 μm) were disposed on the surface of the base particle A. The outer surface of the metal-containing particle has a plurality of convexes and the surface of the convex has a plurality of protrusions.

### Example 23

A metal-containing particle was obtained in the same manner as Example 22 except that the metal nickel particle slurry was changed to an alumina particle slurry (average particle diameter: 150 nm).

### Example 24

The suspension (A) obtained in Example 1 was placed in a solution containing nickel sulfate at 40 ppm, trisodium citrate at 2 g/L, and aqueous ammonia at 10 g/L to obtain a particle mixture (B).

As a plating solution for needle-shaped protrusion formation, a mixture containing copper sulfate at 100 g/L, nickel sulfate at 10 g/L, sodium hypophosphite at 100 g/L, trisodium citrate at 70 g/L, boric acid at 10 g/L, and polyethylene glycol 1000 (molecular weight: 1,000) as a nonionic surfactant at 5 mg/L was prepared. Next, a plating solution for needle-shaped protrusion formation (C), which was an electroless copper-nickel-phosphorus alloy plating solution prepared by adjusting the pH of the mixture to pH 10.0 with aqueous ammonia, was prepared.

In addition, as an electroless silver plating solution, a silver plating solution (D) was prepared by adjusting the pH of a mixture containing silver nitrate at 30 g/L, succinimide at 100 g/L, and formaldehyde at 20 g/L to 8.0 with aqueous ammonia.

Moreover, a plating solution for protrusion formation (E) (pH 10.0) containing dimethylamine borane at 100 g/L and sodium hydroxide at 0.5 g/L was prepared.

The plating solution for needle-shaped protrusion formation (C) was gradually dropped to the particle mixture (B) which was in a dispersed state and adjusted to 70° C. to form a needle-shaped protrusion. The electroless copper-nickel-phosphorus alloy plating was performed at a dropping rate of the plating solution for needle-shaped protrusion formation (C) of 40 mL/min and a dropping time of 60 minutes (needle-shaped protrusion forming and copper-nickel-phosphorus alloy plating step). Thereafter, the particle was taken out by filtration to obtain a particle (F) in which a copper-nickel-phosphorus alloy metal section was disposed on the surface of the base particle A and a metal section having convexes on the surface of the metal section was equipped. The particle (F) was added to and dispersed in 500 parts by weight of distilled water to obtain a suspension (G).

Thereafter, the particle was taken out by filtering the suspension (G) and washed with water to obtain a particle in which a copper-nickel-phosphorus alloy metal section was disposed on the surface of the base particle A and a metal section having needle-shaped convexes on the surface of the metal section was equipped. This particle was thoroughly washed with water and then added to and dispersed in 500 parts by weight of distilled water to obtain a particle mixture (H).

Next, the silver plating solution (D) was gradually dropped to the particle mixture (H) which was in a dispersed state and adjusted to 60° C. to perform electroless silver plating. The electroless silver plating was performed at a dropping rate of the silver plating solution (D) of 10 mL/min and a dropping time of 30 minutes. Thereafter, the plating solution for protrusion formation (E) was gradually dropped thereto to form a protrusion. The protrusion formation was performed at a dropping rate of the plating solution for protrusion formation (E) of 1 mL/min and a dropping time of 10 minutes. Silver plating was performed while dispersing the generated silver protrusion nuclei by ultrasonic stirring during the dropping of the plating solution for protrusion formation (E) (protrusion forming step). Thereafter, the particle was taken out by filtration, washed with water, and dried to obtain a metal-containing particle in which copper-nickel-phosphorus alloy and silver metal sections and a silver metal film (the thickness of the entire metal sections and the entire metal films at the portion not having convexes: 0.105 μm) (the thickness of the entire metal sections at the portion not having convexes: 0.1 μm) were disposed on the surface of the base particle A. The outer surface of the metal-containing particle has a plurality of needle-shaped convexes and the surface of the convex has a plurality of protrusions.

### Example 25

The suspension (A) obtained in Example 1 was placed in a solution containing nickel sulfate at 80 g/L, thallium nitrate at 10 ppm, and bismuth nitrate at 5 ppm to obtain a particle mixture (B).

As a plating solution for needle-shaped protrusion formation, a plating solution for needle-shaped protrusion formation (C), which was an electroless highly pure nickel plating solution obtained by adjusting the pH of a mixture containing nickel chloride at 100 g/L, hydrazine monohydrate at 100 g/L, trisodium citrate at 50 g/L, and polyethylene glycol 1000 (molecular weight: 1,000) at 20 mg/L to 9.0 with sodium hydroxide, was prepared.

In addition, as an electroless silver plating solution, a silver plating solution (D) was prepared by adjusting the pH of a mixture containing silver nitrate at 30 g/L, succinimide at 100 g/L, and formaldehyde at 20 g/L to 8.0 with aqueous ammonia.

Moreover, a plating solution for protrusion formation (E) (pH 10.0) containing dimethylamine borane at 100 g/L and sodium hydroxide at 0.5 g/L was prepared.

The plating solution for needle-shaped protrusion formation (C) was gradually dropped to the particle mixture (B) which was in a dispersed statean embedded resin body for and adjusted to 60° C. to form a needle-shaped protrusion. The electroless highly pure nickel plating was performed at a dropping rate of the plating solution for needle-shaped protrusion formation (C) of 20 mL/min and a dropping time of 50 minutes (needle-shaped protrusion forming and highly pure nickel plating step). Thereafter, the particle was taken out by filtration to obtain a particle (F) in which a highly pure nickel metal section was disposed on the surface of the base particle A and a metal section having convexes on the surface of the metal section was equipped. The particle (F) was added to and dispersed in 500 parts by weight of distilled water to obtain a suspension (G).

Thereafter, the particle was taken out by filtering the suspension (G) and washed with water to obtain a particle in which a highly pure nickel metal section was disposed on the surface of the base particle A and a metal section having needle-shaped convexes on the surface of the metal section was equipped. This particle was thoroughly washed with water and then added to and dispersed in 500 parts by weight of distilled water to obtain a particle mixture (H).

Next, the silver plating solution (D) was gradually dropped to the particle mixture (H) which was in a dispersed state and adjusted to 60° C. to perform electroless silver plating. The electroless silver plating was performed at a dropping rate of the silver plating solution (D) of 10 mL/min and a dropping time of 30 minutes. Thereafter, the plating solution for protrusion formation (E) was gradually dropped thereto to form a protrusion. The protrusion formation was performed at a dropping rate of the plating solution for protrusion formation (E) of 1 mL/min and a dropping time of 10 minutes. Silver plating was performed while dispersing the generated silver protrusion nuclei by ultrasonic stirring during the dropping of the plating solution for protrusion formation (E) (protrusion forming step). Thereafter, the particle was taken out by filtration to obtain a particle mixture (I) in which highly pure nickel and silver metal sections were disposed on the surface of the base particle A and a metal section having needle-shaped convexes on the surface of the metal section and a plurality of protrusions on the surface of the convex was equipped. Thereafter, the particle was taken out by filtering the particle mixture (I), washed with water, and dried to obtain a metal-containing particle in which highly pure nickel and silver metal sections and a silver metal film (the thickness of the entire metal sections and the entire metal films at the portion not having convexes: 0.105 μm) were disposed on the surface of the base particle A. The outer surface of the metal-containing particle has a plurality of needle-shaped convexes and the surface of the convex has a plurality of protrusions.

### Example 26

The suspension (A) obtained in Example 1 was placed in a solution containing silver nitrate at 500 ppm, succinimide at 10 g/L, and aqueous ammonia at 10 g/L to obtain a particle mixture (B).

In addition, as an electroless silver plating solution, a silver plating solution (C) was prepared by adjusting the pH of a mixture containing silver nitrate at 30 g/L, succinimide at 100 g/L, and formaldehyde at 20 g/L to 8 with aqueous ammonia.

Moreover, a plating solution for protrusion formation (D) (pH 10.0) containing dimethylamine borane at 100 g/L and sodium hydroxide at 0.5 g/L was prepared.

The electroless silver plating solution (C) was gradually dropped to the particle mixture (B) which was in a dispersed state and adjusted to 60° C. to form a needle-shaped protrusion. The electroless silver plating was performed at a dropping rate of the electroless silver plating solution (C) of 10 mL/min and a dropping time of 30 minutes (silver plating step). Thereafter, the plating solution for protrusion formation (D) was gradually dropped thereto to form a protrusion. The protrusion formation was performed at a dropping rate of the plating solution for protrusion formation (D) of 1 mL/min and a dropping time of 10 minutes. Silver plating was performed while dispersing the generated silver protrusion nuclei by ultrasonic stirring during the dropping of the plating solution for protrusion formation (D) (protrusion forming step). Thereafter, the particle was taken out by filtration, washed with water, and dried to obtain a metal-containing particle in which a silver metal section and a silver metal film (the thickness of the entire metal sections and the entire metal films at the portion not having convexes: 0.105 μm) were disposed on the surface of the base particle A. The outer surface of the metal-containing particle has a plurality of protrusions.

### Example 27

The suspension (A) obtained in Example 1 was placed in a solution containing silver potassium cyanide at 500 ppm, potassium cyanide at 10 g/L, and potassium hydroxide at 10 g/L to obtain a particle mixture (B).

As a plating solution for needle-shaped protrusion formation, a silver plating solution (C) was prepared by adjusting the pH of a mixture containing silver potassium cyanide at 80 g/L, potassium cyanide at 10 g/L, polyethylene glycol 1000 (molecular weight: 1,000) at 20 mg/L, thiourea at 50 ppm, and hydrazine monohydrate at 100 g/L to 7.5 with potassium hydroxide.

The electroless silver plating solution (C) was gradually dropped to the particle mixture (B) which was in a dispersed state and adjusted to 80° C. to form a needle-shaped protrusion. The electroless silver plating was performed at a dropping rate of the electroless silver plating solution (C) of 10 mL/min and a dropping time of 60 minutes (needle-shaped protrusion forming and silver plating step). Thereafter, the particle was taken out by filtration, washed with water, and dried to obtain a metal-containing particle in which a silver metal section and a silver metal film (the thickness of the entire metal sections and the entire metal films at the portion not having convexes: 0.105 μm) were disposed on the surface of a resin particle. The outer surface of the metal-containing particle has a plurality of needle-shaped protrusions.

### Example 28

The suspension (A) obtained in Example 1 was placed in a solution containing silver potassium cyanide at 500 ppm, potassium cyanide at 10 g/L, and potassium hydroxide at 10 g/L to obtain a particle mixture (B).

As a plating solution for needle-shaped protrusion formation, a silver plating solution (C) was prepared by adjusting the pH of a mixture containing silver potassium cyanide at 80 g/L, potassium cyanide at 10 g/L, polyethylene glycol 1000 (molecular weight: 1,000) at 20 mg/L, thiourea at 50 ppm, and hydrazine monohydrate at 100 g/L to 7.5 with potassium hydroxide.

In addition, as an electroless silver plating solution, a silver plating solution (D) was prepared by adjusting the pH of a mixture containing silver nitrate at 30 g/L, succinimide at 100 g/L, and formaldehyde at 20 g/L to 8.0 with aqueous ammonia.

Moreover, a plating solution for protrusion formation (E) (pH 10.0) containing dimethylamine borane at 100 g/L and sodium hydroxide at 0.5 g/L was prepared.

The electroless silver plating solution (C) was gradually dropped to the particle mixture (B) which was in a dispersed state and adjusted to 80° C. to form a needle-shaped protrusion. The electroless silver plating was performed at a dropping rate of the electroless silver plating solution (C) of 10 mL/min and a dropping time of 45 minutes (needle-shaped protrusion forming and silver plating step).

Thereafter, the particle was taken out by filtration to obtain a particle (F) in which a silver metal section was disposed on the surface of the base particle A and a metal section having needle-shaped convexes on the surface of the metal section was equipped. The particle (F) was added to and dispersed in 500 parts by weight of distilled water to obtain a particle mixture (G).

Next, the silver plating solution (D) was gradually dropped to the particle mixture (G) which was in a dispersed state and adjusted to 60° C. to perform electroless silver plating. The electroless silver plating was performed at a dropping rate of the silver plating solution (D) of 10 mL/min and a dropping time of 30 minutes. Thereafter, the plating solution for protrusion formation (E) was gradually dropped thereto to form a protrusion. The protrusion formation was performed at a dropping rate of the plating solution for protrusion formation (E) of 1 mL/min and a dropping time of 10 minutes. Silver plating was performed while dispersing the generated silver protrusion nuclei by ultrasonic stirring during the dropping of the plating solution for protrusion formation (E) (protrusion forming step). Thereafter, the particle was taken out by filtration, washed with water, and dried to obtain a metal-containing particle in which a silver metal section and a silver metal film (the thickness of the entire metal sections and the entire metal films at the portion not having convexes: 0.105 μm) were disposed on the surface of the base particle A. The outer surface of the metal-containing particle has a plurality of needle-shaped convexes and the surface of the convex has a plurality of protrusions.

### Example 29

The suspension (B) obtained in Example 1 was placed in a solution containing nickel sulfate at 50 g/L, thallium nitrate at 30 ppm, and bismuth nitrate at 20 ppm to obtain a particle mixture (C).

As an electroless nickel-tungsten-boron alloy plating solution, a mixture containing nickel sulfate at 100 g/L, sodium tungstate at 5 g/L, dimethylamine borane at 30 g/L, bismuth nitrate at 10 ppm, and trisodium citrate at 30 g/L was prepared. Next, an electroless nickel-tungsten-boron alloy plating solution (D) was prepared by adjusting the pH of the mixture to 6 with sodium hydroxide.

In addition, as an electroless silver plating solution, a silver plating solution (E) was prepared by adjusting the pH of a mixture containing silver nitrate at 30 g/L, succinimide at 100 g/L, and formaldehyde at 20 g/L to 8.0 with aqueous ammonia.

Moreover, a plating solution for protrusion formation (F) (pH 10.0) containing dimethylamine borane at 100 g/L and sodium hydroxide at 0.5 g/L was prepared.

The electroless nickel-tungsten-boron alloy plating solution (D) was gradually dropped to the particle mixture (C) which was in a dispersed state and adjusted to 60° C. to perform electroless nickel-tungsten-boron alloy plating. The electroless nickel-tungsten-boron alloy plating was performed at a dropping rate of the electroless nickel-tungsten-boron alloy plating solution (D) of 15 mL/min and a dropping time of 60 minutes. A particle mixture (G) containing a particle in which a nickel-tungsten-boron alloy metal section was disposed on the surface of the base particle A and a metal section having convexes on the surface of the metal section was equipped was thus obtained.

Thereafter, the particle was taken out by filtering the particle mixture (G) and washed with water to obtain a particle in which a nickel-tungsten-boron alloy metal layer was disposed on the surface of the base particle A and a metal section having convexes on the surface of the metal section was equipped. This particle was thoroughly washed with water and then added to and dispersed in 500 parts by weight of distilled water to obtain a particle mixture (H).

Next, the silver plating solution (E) was gradually dropped to the particle mixture (H) which was in a dispersed state and adjusted to 60° C. to perform electroless silver plating. The electroless silver plating was performed at a dropping rate of the silver plating solution (E) of 10 mL/min and a dropping time of 30 minutes. Thereafter, the plating solution for protrusion formation (F) was gradually dropped thereto to form a protrusion. The protrusion formation was performed at a dropping rate of the plating solution for protrusion formation (F) of 1 mL/min and a dropping time of 10 minutes. Silver plating was performed while dispersing the generated silver protrusion nuclei by ultrasonic stirring during the dropping of the plating solution for protrusion formation (F) (protrusion forming step). Thereafter, the particle was taken out by filtration, washed with water, and dried to obtain a metal-containing particle in which nickel-tungsten-boron alloy and silver metal sections and a silver metal film (the thickness of the entire metal sections and the entire metal films at the portion not having convexes: 0.105 μm) were disposed on the surface of the base particle A. The outer surface of the metal-containing particle has a plurality of convexes and the surface of the convex has a plurality of protrusions.

### Example 30

The suspension (B) obtained in Example 1 was placed in a solution containing copper sulfate at 20 g/L and ethylenediaminetetraacetic acid at 30 g/L to obtain a particle mixture (C).

In addition, as an electroless copper plating solution, a copper plating solution (D) was prepared by adjusting the pH of a mixture containing copper sulfate at 250 g/L, ethylenediaminetetraacetic acid at 150 g/L, sodium gluconate at 100 g/L, and formaldehyde at 50 g/L to 10.5 with ammonia.

In addition, as an electroless tin plating solution, a tin plating solution (E) was prepared by adjusting the pH of a mixture containing tin chloride at 20 g/L, nitrilotriacetic acid at 50 g/L, thiourea at 2 g/L, thiomalic acid at 1 g/L, ethylenediaminetetraacetic acid at 7.5 g/L, and titanium trichloride at 15 g/L to 7.0 with sulfuric acid.

Moreover, a plating solution for protrusion formation (F) (pH 7.0) containing dimethylamine borane at 100 g/L was prepared.

The copper plating solution (D) was gradually dropped to the particle mixture (C) which was in a dispersed state and adjusted to 55° C. to perform electroless copper plating. The electroless copper plating was performed at a dropping rate of the copper plating solution (D) of 30 mL/min and a dropping time of 30 minutes. Thereafter, the particle was taken out by filtration thus to obtain a particle mixture (G) in which a copper metal section was disposed on the surface of the base particle A and a metal section having convexes on the surface of the metal section was equipped.

Thereafter, the particle was taken out by filtering the particle mixture (G) and washed with water to obtain a particle in which a copper metal section was disposed on the surface of the base particle A and a metal section having convexes on the surface of the metal section was equipped. This particle was thoroughly washed with water and then added to and dispersed in 500 parts by weight of distilled water to obtain a particle mixture (H).

Next, the tin plating solution (E) was gradually dropped to the particle mixture (H) which was in a dispersed state and adjusted to 60° C. to perform electroless tin plating. The electroless tin plating was performed at a dropping rate of the tin plating solution (E) of 10 mL/min and a dropping time of 30 minutes. Thereafter, the plating solution for protrusion formation (F) was gradually dropped thereto to form a protrusion. The protrusion formation was performed at a dropping rate of the plating solution for protrusion formation (F) of 1 mL/min and a dropping time of 10 minutes. Tin plating was performed while dispersing the generated tin protrusion nuclei by ultrasonic stirring during the dropping of the plating solution for protrusion formation (F) (protrusion forming step). Thereafter, the particle was taken out by filtration, washed with water, and dried to obtain a metal-containing particle in which copper and tin metal sections and a tin metal film (the thickness of the entire metal sections and the entire metal films at the portion not having convexes: 0.105 μm) were disposed on the surface of the base particle A. The outer surface of the metal-containing particle has a plurality of convexes and the surface of the convex has a plurality of protrusions.

### Example 31

(1) Fabrication of Silicone Oligomer

In a 100 ml separable flask installed in a hot bath, 1 part by weight of 1,3-divinyltetramethyldisiloxane and 20 parts by weight of a 0.5% by weight aqueous solution of p-toluenesulfonic acid were placed. After the mixture was stirred at 40° C. for 1 hour, 0.05 part by weight of sodium hydrogen carbonate was added thereto. Thereafter, 10 parts by weight of dimethoxymethylphenylsilane, 49 parts by weight of dimethyldimethoxysilane, 0.6 parts by weight of trimethylmethoxysilane, and 3.6 parts by weight of methyltrimethoxysilane were added to the mixture, and this mixture was stirred for 1 hour. Thereafter, 1.9 parts by weight of a 10% by weight aqueous solution of potassium hydroxide was added to the resultant mixture, the temperature of this mixture was raised to 85° C., and the mixture was stirred and reacted for 10 hours while the pressure was lowered using an aspirator. After completion of the reaction, the pressure was returned to normal pressure, and the reaction mixture was cooled to 40° C., 0.2 parts by weight of acetic acid was added thereto, and the mixture was allowed to stand in a separatory funnel for 12 hours or more. After separation of two layers, the lower layer was taken out and purified using an evaporator to obtain a silicone oligomer.

(2) Fabrication of Silicone Particle Material (Containing Organic Polymer)

A solution A was prepared by dissolving 0.5 parts by weight of tert-butyl 2-ethylperoxyhexanoate (polymerization initiator, “PERBUTYL 0” manufactured by NOF Corporation) in 30 parts by weight of the silicone oligomer obtained. In addition, an aqueous solution B was prepared by mixing 0.8 parts by weight of a 40% by weight aqueous solution of triethanolamine lauryl sulfate (emulsifier) and 80 parts by weight of a 5% by weight aqueous solution of polyvinyl alcohol (degree of polymerization: about 2,000, degree of saponification: 86.5 to 89% by mole, “GOHSENOL GH-20” manufactured by The Nippon Synthetic Chemical Industry Co., Ltd.) in 150 parts by weight of ion-exchanged water. The solution A was placed in a separable flask installed in a hot bath, and then the aqueous solution B was added thereto. Thereafter, emulsification was performed by using a Shirasu Porous Glass (SPG) membrane (pore average diameter: about 1 Ξm). Thereafter, the temperature of the emulsion was raised to 85° C., and polymerization was performed for 9 hours. The whole particles after polymerization were washed with water by centrifugation and freeze-dried. After drying, the aggregate of particles was crushed using a ball mill until the intended ratio (average secondary particle diameter/average primary particle diameter) was attained, thereby obtaining a silicone particle (base particle B) having a particle diameter of 3.0 μm.

The base particle A was changed to the base particle B, and a metal section and a metal film were formed in the same manner as in Example 22, thereby obtaining a metal-containing particle.

### Example 32

A silicone particle (base particle C) having a particle diameter of 3.0 μm was obtained using both terminals acrylic silicone oil (“X-22-2445” manufactured by

Shin-Etsu Chemical Co., Ltd.) instead of the silicone oligomer.

The base particle A was changed to the base particle C, and a metal section and a metal film were formed in the same manner as in Example 22, thereby obtaining a metal-containing particle.

### Example 33

A pure copper particle (“HXR-Cu” manufactured by NIPPON ATOMIZED METAL POWDERS CORPORATION, particle diameter: 2.5 μm) was prepared as a base particle D.

The base particle A was changed to the base particle D, and a metal section and a metal film were formed in the same manner as in Example 22, thereby obtaining a metal-containing particle.

### Example 34

A pure silver particle (particle diameter: 2.5 μm) was prepared as a base particle E.

The base particle A was changed to the base particle E, and a metal section and a metal film were formed in the same manner as in Example 22, thereby obtaining a metal-containing particle.

### Example 35

A base particle F, which was different from the base particle A only in the particle diameter and had a particle diameter of 2.0 μm, was prepared.

The base particle A was changed to the base particle F, and a metal section and a metal film were formed in the same manner as in Example 22, thereby obtaining a metal-containing particle.

### Example 36

A base particle G, which was different from the base particle A only in the particle diameter and had a particle diameter of 10.0 μm, was prepared.

The base particle A was changed to the base particle G, and a metal section and a metal film were formed in the same manner as in Example 22, thereby obtaining a metal-containing particle.

### Example 37

A base particle H, which was different from the base particle A only in the particle diameter and had a particle diameter of 50.0 μm, was prepared.

The base particle A was changed to the base particle H, and a metal section and a metal film were formed in the same manner as in Example 22, thereby obtaining a metal-containing particle.

### Example 38

A monomer composition containing 100 mmol of methyl methacrylate, 1 mmol of N,N,N-trimethyl-N-2-methacryloyloxyethylammonium chloride, and 1 mmol of 2,2′-azobis(2-amidinopropane) dihydrochloride was weighed and placed in ion-exchanged water so as to have a solid content of 5% by weight. In a 1,000 mL separable flask equipped with a four-neck separable cover, a stirrer, a three-way cock, a condenser, and a temperature probe, the monomer composition was placed, stirred at 200 rpm, and subjected to polymerization at 70° C. for 24 hours in a nitrogen atmosphere. After completion of the reaction, the resultant was freeze-dried to obtain insulating particles having an ammonium group on the surface, an average particle diameter of 220 nm, and a CV value of 10%.

The insulating particles were dispersed in ion-exchanged water under ultrasonic irradiation to obtain a 10% by weight aqueous dispersion of insulating particles.

In 500 mL of ion-exchanged water, 10 g of the metal-containing particle obtained in Example 22 was dispersed, 4 g of the aqueous dispersion of insulating particle was added thereto, and the mixture was stirred at room temperature for 6 hours. After filtration through a 3 μm mesh filter, the resultant was further washed with methanol and dried to obtain a metal-containing particle to which an insulating particle was attached.

As a result of observation under a scanning electron microscope (SEM), only one covering layer composed of an insulating particle was formed on the surface of the metal-containing particle. The coverage factor was 30% when the area covered with the insulating particle (namely, the projected area of the particle diameter of insulating particle) with respect to the area of the portion from the center of the metal-containing particle to 2.5 μm was calculated by image analysis.

### Example 39

The suspension (B) obtained in Example 1 was placed in a solution containing nickel sulfate at 50 g/L, thallium nitrate at 30 ppm, and bismuth nitrate at 20 ppm to obtain a particle mixture (C).

As an electroless nickel-phosphorus alloy plating solution, an electroless nickel-phosphorus alloy plating solution (D) was prepared by adjusting the pH of a mixture containing nickel sulfate at 100 g/L, sodium hypophosphite at 30 g/L, bismuth nitrate at 10 ppm, and trisodium citrate at 30 g/L to 6 with sodium hydroxide.

In addition, as an electroless silver plating solution, a silver plating solution (E) was prepared by adjusting the pH of a mixture containing silver nitrate at 30 g/L, succinimide at 100 g/L, and formaldehyde at 20 g/L to 8.0 with aqueous ammonia.

Moreover, a plating solution for protrusion formation (F) (pH 12.0) containing sodium hypophosphite at 130 g/L and sodium hydroxide at 0.5 g/L was prepared.

The electroless nickel-phosphorus alloy plating solution (D) was gradually dropped to the particle mixture (C) which was in a dispersed state and adjusted to 65° C. to perform electroless nickel-phosphorus alloy plating. The electroless nickel-phosphorus alloy plating was performed at a dropping rate of the electroless nickel-phosphorus alloy plating solution (D) of 15 mL/min and a dropping time of 60 minutes. A particle mixture (G) containing a particle in which a nickel-phosphorus alloy metal section was disposed on the surface of the base particle A and a metal section having convexes on the surface of the metal section was equipped was thus obtained.

Thereafter, the particle was taken out by filtering the particle mixture (G) and washed with water to obtain a particle in which a nickel-phosphorus alloy metal layer was disposed on the surface of the base particle A and a metal section having convexes on the surface of the metal section was equipped. This particle was thoroughly washed with water and then added to and dispersed in 500 parts by weight of distilled water to obtain a particle mixture (H).

Next, the silver plating solution (E) was gradually dropped to the particle mixture (H) which was in a dispersed state and adjusted to 60° C. to perform electroless silver plating. The electroless silver plating was performed at a dropping rate of the silver plating solution (E) of 10 mL/min and a dropping time of 30 minutes. Thereafter, the plating solution for protrusion formation (F) was gradually dropped thereto to form a protrusion. The protrusion formation was performed at a dropping rate of the plating solution for protrusion formation (F) of 1 mL/min and a dropping time of 10 minutes. Silver plating was performed while dispersing the generated silver protrusion nuclei by ultrasonic stirring during the dropping of the plating solution for protrusion formation (F) (protrusion forming step). Thereafter, the particle was taken out by filtration, washed with water, and dried to obtain a metal-containing particle in which nickel-phosphorus alloy and silver metal sections and a silver metal film (the thickness of the entire metal sections and the entire metal films at the portion not having convexes: 0.105 μm) were disposed on the surface of the base particle A. The outer surface of the metal-containing particle has a plurality of convexes and the surface of the convex has a plurality of protrusions.

### Example 40

Using “New Dain Silver” manufactured by Daiwa Fine Chemicals Co., Ltd. as a silver anti-tarnish agent, the anti-sulfurization treatment of 10 g of the metal-containing particle obtained in Example 22 was performed.

In 100 parts by weight of an isopropyl alcohol solution containing New Dain Silver at 10% by weight, 10 g of the metal-containing particle obtained in Example 22 was dispersed using an ultrasonic disperser, and then the solution was filtered to obtain a metal-containing particle in which an anti-sulfurization film was formed.

### Example 41

Using a 2-mercaptobenzothiazole solution as a silver anti-tarnish agent, the anti-sulfurization treatment of 10 g of the metal-containing particle obtained in Example 1 was performed.

In 100 parts by weight of an isopropyl alcohol solution containing 2-mercaptobenzothiazole at 0.5% by weight, 10 g of the metal-containing particle obtained in Example 1 was dispersed using an ultrasonic disperser, and then the solution was filtered to obtain a metal-containing particle in which an anti-sulfurization film was formed.

### Comparative Example 1

In 100 parts by weight of an alkaline solution containing a palladium catalyst solution at 5% by weight, 10 parts by weight of the base particle A was dispersed using an ultrasonic disperser, and then the solution was filtered to take out the base particle A. Subsequently, the base particle A was added to 100 parts by weight of a 1% by weight solution of dimethylamine borane to activate the surface of the base particle A. The surface-activated base particle A was thoroughly washed with water and then added to and dispersed in 500 parts by weight of distilled water to obtain a suspension (A).

Next, 1 g of metal nickel particle slurry (“2020SUS” manufactured by Mitsui Mining & Smelting Co., Ltd., average particle diameter: 150 nm) was added to the suspension (A) over 3 minutes to obtain a suspension (B) containing the base particle A to which a core substance was attached.

The suspension (B) was placed in a solution containing nickel sulfate at 50 g/L, thallium nitrate at 30 ppm, and bismuth nitrate at 20 ppm to obtain a particle mixture (C).

In addition, a nickel plating solution (D) (pH 6.5) containing nickel sulfate at 200 g/L, sodium hypophosphite at 85 g/L, sodium citrate at 30 g/L, thallium nitrate at 50 ppm, and bismuth nitrate at 20 ppm was prepared.

In addition, as an electroless silver plating solution, a silver plating solution (E) was prepared by adjusting the pH of a mixture containing silver nitrate at 30 g/L, succinimide at 100 g/L, imidazole at 10 g/L, and formaldehyde at 20 g/L to 7.0 with aqueous ammonia.

The nickel plating solution (D) was gradually dropped to the particle mixture (C) which was in a dispersed state and adjusted to 50° C. to perform electroless nickel plating. The electroless nickel plating was performed at a dropping rate of the electroless nickel plating solution (D) of 25 mL/min and a dropping time of 60 minutes (Ni plating step). A particle mixture (F) in a dispersed state was thus obtained. Next, the silver plating solution (E) was gradually dropped to the particle mixture (F) which was in a dispersed state and adjusted to 60° C. to perform electroless silver plating. The electroless silver plating was performed at a dropping rate of the silver plating solution (E) of 10 mL/min and a dropping time of 30 minutes. Thereafter, the particle was taken out by filtration, washed with water, and dried to obtain a metal-containing particle in which nickel-phosphorus alloy and silver metal sections and a silver metal film (the thickness of the entire metal sections and the entire metal films at the portion not having convexes: 0.105 μm) were disposed on the surface of the base particle A. The outer surface of the metal-containing particle has a plurality of needle-shaped convexes and the surface of the convex has a plurality of protrusions.

### Comparative Example 2

In 100 parts by weight of an alkaline solution containing a palladium catalyst solution at 5% by weight, 10 parts by weight of the base particle A was dispersed using an ultrasonic disperser, and then the solution was filtered to take out the base particle A. Subsequently, the base particle A was added to 100 parts by weight of a 1% by weight solution of dimethylamine borane to activate the surface of the base particle A. The surface-activated base particle A was thoroughly washed with water and then added to and dispersed in 500 parts by weight of distilled water to obtain a suspension (A).

The suspension (A) was placed in a solution containing nickel sulfate at 50 g/L, thallium nitrate at 30 ppm, and bismuth nitrate at 20 ppm to obtain a particle mixture (B).

Moreover, a plating solution for protrusion formation (C) (pH 11.0) containing sodium hypophosphite at 300 g/L and sodium hydroxide at 10 g/L was prepared.

In addition, a nickel plating solution (D) (pH 6.5) containing nickel sulfate at 200 g/L, sodium hypophosphite at 85 g/L, sodium citrate at 30 g/L, thallium nitrate at 50 ppm, and bismuth nitrate at 20 ppm was prepared.

The plating solution for protrusion formation (C) was gradually dropped to the particle mixture (B) which was in a dispersed state and adjusted to 50° C. to form a protrusion. The protrusion formation was performed at a dropping rate of the plating solution for protrusion formation (C) of 20 mL/min and a dropping time of 5 minutes. Nickel plating was performed while dispersing the generated Ni protrusion nuclei by ultrasonic stirring during the dropping of the plating solution for protrusion formation (C) (protrusion forming step). A particle mixture (E) in a dispersed state was thus obtained.

Thereafter, the nickel plating solution (D) was gradually dropped to the particle mixture (E) in a dispersed state to perform electroless nickel plating. The electroless nickel plating was performed at a dropping rate of the electroless nickel plating solution (D) of 25 mL/min and a dropping time of 60 minutes. Nickel plating was performed while dispersing the generated Ni protrusion nuclei by ultrasonic stirring during the dropping of the nickel plating solution (D) (Ni plating step). Thereafter, the particle was taken out by filtration, washed with water, and dried to obtain a metal-containing particle in which a nickel-phosphorus alloy metal section and a silver metal film (the thickness of the entire metal sections and the entire metal films at the portion not having protrusions: 0.105 μm) were disposed on the surface of the base particle A. The outer surface of the metal-containing particle has a plurality of convexes and the surface of the convex has a plurality of protrusions.

### Evaluation

Examples 1 to 41 and Comparative Examples 1 and 2 were subjected to the following evaluations.

(1) Measurement of Height of Convex and Protrusion

The metal-containing particles obtained were added to and dispersed in “Technovit 4000” manufactured by Kulzer BmbH so as to have a content of 30% by weight, thereby fabricating an embedded resin body for metal-containing particle inspection. The cross section of the metal-containing particle was cut out so as to pass near the center of the metal-containing particle dispersed in the embedded resin for inspection using an ion milling apparatus (“IM 4000” manufactured by Hitachi High-Technologies Corporation).

Thereafter, using a field emission transmission electron microscope (FE-TEM) (“JEM-ARM200F” manufactured by JEOL Ltd.), the image magnification was set to 50,000-fold, 20 metal-containing particles were randomly selected, and the convexes and protrusions in each metal-containing particle were observed. The heights of the convexes and protrusions in the metal-containing particles obtained were measured, and the values measured were arithmetically averaged to take as the average heights of the convexes and protrusions.

(2) Measurement of Average Diameter of Base of Protrusion

The metal-containing particles obtained were added to and dispersed in “Technovit 4000” manufactured by Kulzer BmbH so as to have a content of 30% by weight, thereby fabricating an embedded resin body for metal-containing particle inspection. The cross section of the metal-containing particle was cut out so as to pass near the center of the metal-containing particle dispersed in the embedded resin for inspection using an ion milling apparatus (“IM 4000” manufactured by Hitachi High-Technologies Corporation).

Thereafter, using a field emission transmission electron microscope (FE-TEM) (“JEM-ARM200F” manufactured by JEOL Ltd.), the image magnification was set to 50,000-fold, 20 metal-containing particles were randomly selected, and the convexes and protrusions in each metal-containing particle were observed. The base diameters of the convexes and protrusions in the metal-containing particles obtained were measured, and the values measured were arithmetically averaged to take as the average base diameters of the convexes and protrusions.

(3) Observation of Shape of Convex and Protrusion

Using a field emission scanning electron microscope (FE-SEM), the image magnification was set to 25,000-fold, 20 metal-containing particles were randomly selected, the convexes and protrusions in each metal-containing particle were observed, and the kinds of shapes to which all the convexes and protrusions belonged were examined.

(4) Measurement of Average of Vertical Angle of Convex and Protrusion

The metal-containing particles obtained were added to and dispersed in “Technovit 4000” manufactured by Kulzer BmbH so as to have a content of 30% by weight, thereby fabricating an embedded resin body for metal-containing particle inspection. The cross section of the metal-containing particle was cut out so as to pass near the center of the metal-containing particle dispersed in the embedded resin for inspection using an ion milling apparatus (“IM 4000” manufactured by Hitachi High-Technologies Corporation).

Thereafter, using a field emission transmission electron microscope (FE-TEM) (“JEM-ARM200F” manufactured by JEOL Ltd.), the image magnification was set to 1,000,000-fold, 20 metal-containing particles were randomly selected, and the protrusion sections in each metal-containing particle were observed. The vertical angles of the plurality of convexes and the plurality of protrusions in the metal-containing particles obtained were measured, and the values measured were arithmetically averaged to take as the average vertical angles of the plurality of convexes and the plurality of protrusions.

(5) Measurement of Average Diameter at Central Position of Height of Convex and Protrusion

The metal-containing particles obtained were added to and dispersed in “Technovit 4000” manufactured by Kulzer BmbH so as to have a content of 30% by weight, thereby fabricating an embedded resin body for metal-containing particle inspection. The cross section of the metal-containing particle was cut out so as to pass near the center of the metal-containing particle dispersed in the embedded resin for inspection using an ion milling apparatus (“IM 4000” manufactured by Hitachi High-Technologies Corporation).

Thereafter, using a field emission transmission electron microscope (FE-TEM) (“JEM-ARM200F” manufactured by JEOL Ltd.), the image magnification was set to 50,000-fold, 20 metal-containing particles were randomly selected, and the protrusion sections in each metal-containing particle were observed. The base diameters of the convexes and protrusions in the metal-containing particles obtained were measured, and the values measured were arithmetically averaged to determine the average diameters at the central position of the heights of the convexes and protrusions.

(6) Measurement of Proportion of Number of Convex and Protrusion in Needle Shape

Using a field emission scanning electron microscope (FE-SEM), the image magnification was set to 25,000-fold, 20 metal-containing particles were randomly selected, and the convexes and protrusions in each metal-containing particle were observed. All the convexes and protrusions were subjected to the evaluation on whether or not the shapes of the convex and protrusion were a tapered needle shape and classified into convexes and protrusions of which the shapes were formed in a tapered needle shape and convexes and protrusions of which the shapes were not formed in a tapered needle shape. In this manner, 1) the number of convexes and protrusions which are formed in a tapered needle shape per one metal-containing particle and 2) the number of convexes and protrusions which are not formed in a tapered needle shape per one metal-containing particle were measured. The proportion X of 1) the number of convexes and protrusions in a needle shape in 100% of the total number of protrusion sections 1) and 2) was calculated.

(7) Measurement of Thickness of Entire Metal Sections at Portion not Having Convex and Protrusion

The metal-containing particles obtained were added to and dispersed in “Technovit 4000” manufactured by Kulzer BmbH so as to have a content of 30% by weight, thereby fabricating an embedded resin body for metal-containing particle inspection. The cross section of the metal-containing particle was cut out so as to pass near the center of the metal-containing particle dispersed in the embedded resin for inspection using an ion milling apparatus (“IM 4000” manufactured by Hitachi High-Technologies Corporation).

Thereafter, using a field emission transmission electron microscope (FE-TEM) (“JEM-ARM200F” manufactured by JEOL Ltd.), the image magnification was set to 50,000-fold, 20 metal-containing particles were randomly selected, and the metal sections at the portions not having protrusions in each metal-containing particle were observed. The thicknesses of the entire metal sections at the portions not having protrusions in the metal-containing particles obtained were measured, and the values measured were arithmetically averaged to take as a thickness (average thickness) (described in Examples and Comparative Examples above).

(8) Compressive Elastic Modulus (10% K Value) of Metal-Containing Particle

The compressive elastic modulus (10% K value) of the metal-containing particles obtained was measured under a condition of 23° C. by the method described above using a micro compression testing machine (“Fisher Scope H-100” manufactured by Helmut Fisher GmbH). The 10% K value was determined.

(9) Evaluation of Surface Lattice of Metal Section

The peak intensity ratio of the diffraction line intrinsic to an apparatus dependent on the diffraction angle was calculated using an X-ray diffractometer (“RINT-2500VHF” manufactured by Rigaku Corporation). The proportion (proportion of (111) plane) of the diffraction peak intensity in the (111) direction in the diffraction peak intensity of the entire diffraction line of the gold layer was determined.

(10) Melted and Solidified State of Tip of Protrusion in Metal-Containing Particle in Connection Structure A

The metal-containing particles obtained were added to and dispersed in “STRUCT BOND XN-5A” manufactured by Mitsui Chemicals, Inc. so as to have a content of 10% by weight, thereby fabricating an anisotropic conductive paste.

A transparent glass substrate having a copper electrode pattern with L/S of 30 μm/30 μm on the upper surface was prepared. In addition, a semiconductor chip having a gold electrode pattern with L/S of 30 μm/30 μm on the lower surface was prepared.

The transparent glass substrate was coated with the anisotropic conductive paste immediately after being fabricated in a thickness of 30 μm to form an anisotropic conductive paste layer. Next, the semiconductor chip was layered on the anisotropic conductive paste layer so that the electrodes faced each other. Thereafter, while adjusting the temperature of the head so that the temperature of the anisotropic conductive paste layer was 250° C., a pressure heating head was put on the upper surface of the semiconductor chip, a pressure of 0.5 MPa was applied, and the anisotropic conductive paste layer was cured at 250° C. to obtain a connection structure A. In order to obtain the connection structure A, the electrodes were connected to each other at a low pressure of 0.5 MPa.

The connection structure obtained was put into “Technovit 4000” manufactured by Kulzer BmbH and cured to fabricate an embedded resin body for connection structure inspection. The cross section of the metal-containing particle was cut out so as to pass near the center of connection structure in the embedded resin for inspection using an ion milling apparatus (“IM 4000” manufactured by Hitachi High-Technologies Corporation).

Thereafter, it was judged whether or not the tips of the plurality of protrusions in the metal-containing particles were solidified after being melted by observing the cross section of the connection structure A obtained using a field emission scanning electron microscope (FE-SEM).

### [Criteria for Judging Melted and Solidified State of Tip of Protrusion in Metal-Containing Particle]

A: Tip of protrusion in metal-containing particle is solidified after being melted

B: Tip of protrusion in metal-containing particle is not solidified after being melted

(11) Bonded State of Protrusion in Metal-Containing Particle in Connection Structure A

In the connection structure A obtained in the evaluation of (10), the bonded state of the protrusion in the metal-containing particle was judged by observing the cross section of the connection structure A.

### [Criteria for Judging Bonded State of Protrusion in Metal-Containing Particle]

A: Tip of protrusion in metal-containing particle is solidified after being melted and bonded to electrode and another metal-containing particle in connection section

B: Tip of protrusion in metal-containing particle is not solidified after being melted and not bonded to electrode and another metal-containing particle in connection section

(12) Connection Reliability in Connection Structure A

The connection resistances between the upper and lower electrodes in the 15 connection structures A obtained in the evaluation of (10) were measured by a four-terminal method. The average value of connection resistance was calculated. Incidentally, the connection resistance can be determined by measuring the voltage when a constant current flows from the relation of voltage=current×resistance. The connection reliability was judged according to the following criteria.

[Criteria for judging connection reliability]

∘∘∘: Connection resistance is 1.0Ω or less

∘∘: Connection resistance is more than 1.0Ω and 2.0Ω or less

∘: Connection resistance is more than 2.0Ω and 3.0Ω or less

Δ: Connection resistance is more than 3.0Ω and 5Ω or less

x: Connection resistance is more than 5 Ω

(13) Insulation Reliability in Connection Structure A

As an insulation resistance between the tip electrodes in the 15 connection structures A obtained in the evaluation of (10), the value of the insulation resistance after the migration test (being left to stand for 2,000 hours under conditions of a temperature of 60° C., a humidity of 90%, and an applied voltage of 20 V) was measured. The insulation reliability was judged according to the following criteria.

[Criteria for Judging Insulation Reliability in Connection Structure A]

◯: Insulation resistance value is 10⁹Ω or more

x: Insulation resistance value is less than 10⁹Ω

(14) Melted and Solidified State of Tip of Protrusion in Metal-Containing Particle in Connection Structure B

The metal-containing particles obtained were added to and dispersed in “ANP-1” (containing metal atom-containing particle) manufactured by Nihon Superior Co., Ltd. so as to have a content of 5% by weight, thereby fabricating a sintered silver paste.

As a first connection target member, a power semiconductor element in which the connection surface was plated with Ni/Au was prepared. As a second connection target member, an aluminum nitride substrate in which the connection surface was plated with Cu was prepared.

The second connection target member was coated with the sintered silver paste in a thickness of about 70 μm to form a silver paste layer for connection. Thereafter, the first connection target member was layered on the silver paste layer for connection to obtain a layered body.

The layered body obtained was preheated for 60 seconds on a hot plate at 130° C., then a pressure of 10 MPa was applied to the layered body, and the layered body was heated at 300° C. for 3 minutes to sinter the metal atom-containing particle contained in the sintered silver paste, a connection section containing a sintered product and a metal-containing particle was formed, and the first and second connection target members were bonded to each other via the sintered product to obtain a connection structure B.

The connection structure obtained was put into “Technovit 4000” manufactured by Kulzer BmbH and cured to fabricate an embedded resin body for connection structure inspection. The cross section of the metal-containing particle was cut out so as to pass near the center of connection structure in the embedded resin for inspection using an ion milling apparatus (“IM 4000” manufactured by Hitachi High-Technologies Corporation).

Thereafter, it was judged whether or not the tips of the plurality of protrusions in the metal-containing particles were solidified after being melted by observing the cross section of the connection structure B obtained using a field emission scanning electron microscope (FE-SEM).

### [Criteria for Judging Melted and Solidified State of Tip of Protrusion in Metal-Containing Particle]

A: Tip of protrusion in metal-containing particle is solidified after being melted

B: Tip of protrusion in metal-containing particle is not solidified after being melted

(15) Bonded State of Protrusion in Metal-Containing Particle in Connection Structure B

In the connection structure B obtained in the evaluation of (14), the bonded state of the protrusion in the metal-containing particle was judged by observing the cross section of the connection structure B.

### [Criteria for Judging Bonded State of Protrusion in Metal-Containing Particle]

A: Tip of protrusion in metal-containing particle is solidified after being melted and bonded to electrode and another metal-containing particle in connection section

B: Tip of protrusion in metal-containing particle is not solidified after being melted and not bonded to electrode and another metal-containing particle in connection section

(16) Connection Reliability in Connection Structure B

The connection structure B obtained in the evaluation of (14) was put into a thermal shock testing machine (TSA-101S-W manufactured by ESPEC CORP.) and subjected to a 3,000 cycle test, in which treatment conditions of a retention time of 30 minutes at a minimum temperature of −40° C. and a retention time of 30 minutes at a maximum temperature of 200° C. were taken as one cycle, and then the bonding strength was measured using a shear strength testing machine (STR-1000 manufactured by RHESCA CO., LTD.). The connection reliability was judged according to the following criteria.

### [Criteria for Judging Connection Reliability]

∘∘∘: Bonding strength is 50 MPa or more

∘∘: Bonding strength is more than 40 MPa and 50 MPa or less

∘: Bonding strength is more than 30 MPa and 40 MPa or less

Δ: Bonding strength is more than 20 MPa and 30 MPa or less

x: Bonding strength is 20 MPa or less

(17) Contact Resistance Value of Conduction Inspection Member

Blended were 10 parts by weight of a silicone-based copolymer, 90 parts by weight of the metal-containing particle obtained, 1 part by weight of an epoxy silane coupling agent (“KBE-303” manufactured by Shin-Etsu Chemical Co., Ltd.), and 36 parts by weight of isopropyl alcohol. Next, the mixture was stirred at 1,000 rpm for 20 minutes using a homodisper and degassed using “THINKYMIXER ARE250” manufactured by THINKY, thereby preparing a conductive material containing a metal-containing particle and a binder.

The silicone-based copolymer was polymerized by the following method. In a metal kneading machine having an inner capacity of 2 L, 162 g (628 mmol) of 4,4′-dicyclohexylmethane diisocyanate (manufactured by Degussa AG) and 900 g (90 mmol) of one terminal amino group-modified polydimethylsiloxane (“TSF 4709” manufactured by Momentive) (molecular weight: 10,000) were put, dissolution was performed at 70° C. to 90° C., and stirring was performed for 2 hours. Thereafter, 65 g (625 mmol) of neopentyl glycol (manufactured by MITSUBISHI GAS CHEMICAL COMPANY) was slowly added to the solution, and the mixture was kneaded for 30 minutes, and then the unreacted neopentyl glycol was removed under reduced pressure. The silicone copolymer obtained was used after being dissolved in isopropyl alcohol so as to have a content of 20% by weight. Incidentally, elimination of the isocyanate group was confirmed by IR spectrum. In the silicone-based copolymer obtained, the silicone content was 80% by weight, the weight average molecular weight was 25,000, the SP value was 7.8, and the SP value of the repeating unit in the structure (polyurethane) having a polar group was 10.

Next, silicone rubber was prepared as a base material (sheet-shaped base material formed of insulating material) of the conduction inspection member. The size of the silicone rubber is 25 mm in width, 25 mm in height, and 1 mm in thickness. In the silicone rubber, a total of 400 cylindrical through holes which have a diameter of 0.5 mm and are formed by laser processing are formed 20 in length and 20 in width.

The silicone rubber having through holes was coated with the conductive material using a knife coater to fill the conductive material in the through holes. Next, the silicone rubber in which the conductive material was filled in the through holes was dried in an oven at 50° C. for 10 minutes and then further dried continuously at 100° C. for 20 minutes to obtain a conduction inspection member having a thickness of 1 mm.

The contact resistance value of the conduction inspection member obtained was measured using a contact resistance measuring system (“MS 7500” manufactured by Fact k co, Ltd). In the contact resistance measurement, the conductive section of the conduction inspection member obtained at a load of 15 gf using a platinum probe having a diameter of 0.5 mm was pressurized from the vertical direction. At that time, 5 V was applied thereto using a low resistance meter (“MODEL 3566” manufactured by Tsuruga Electric Corporation) to measure the contact resistance value. The average value of the contact connection resistance values measured at five conductive sections was calculated. The contact resistance value was judged according to the following criteria.

### [Criteria for Judging Contact Resistance Value]

∘∘: Average value of connection resistance is 50.0 mΩ or less

∘: Average value of connection resistance is more than 50.0 mΩ and 100.0 mΩ or less

Δ: Average value of connection resistance is more than 100.0 mΩ and 500.0 mΩ or less

x: Average value of connection resistance is more than 500.0 mΩ

(18) Repeated Reliability Test of Conduction Inspection Member

The conduction inspection member for the evaluation on (17) the contact resistance value of conduction inspection member was prepared.

The repeated reliability test and measurement of contact resistance value of the conduction inspection member obtained were performed using a contact resistance measuring system (“MS 7500” manufactured by Fact k co, Ltd). In the repeated reliability test, the conductive section of the probe sheet obtained at a load of 15 gf using a platinum probe having a diameter of 0.5 mm was repeatedly pressurized 1,000 times from the vertical direction. After the conductive section was repeatedly pressurized 1,000 times, 5 V was applied thereto using a low resistance meter (“MODEL 3566” manufactured by Tsuruga Electric Corporation) to measure the contact resistance value. The average value of the contact resistance values measured at five conductive sections in the same manner was calculated. The contact resistance value was judged according to the following criteria.

[Criteria for Judging Contact Resistance Value after Repeated Pressurization]

∘∘: Average value of connection resistance is 100.0 mΩ or less

∘: Average value of connection resistance is more than 100.0 mΩ and 500.0 mΩ or less

Δ: Average value of connection resistance is more than 500.0 mΩ and 1,000.0 mΩ or less x: Average value of connection resistance is more than 1,000.0 mΩ

The compositions and the results are presented in Tables 1 to 10.

TABLE 1

| | Kind of metal | | | | | | |
|---|---|---|---|---|---|---|---|
| | Metal section | | | Kind of convex and protrusion | | Shape of protrusion | |
| | Convex | Protrusion | Metal film | Convex | Protrusion | Convex | Protrusion |
| Example 1 | Copper | Silver | Gold | Ni core substance | Deposited | Spherical convex | Spherical |
| | | | | composite convex | protrusion | | protrusion |
| Example 2 | Copper | Silver | Gold | Al2O3 core substance | Deposited | Spherical convex | Spherical |
| | | | | composite convex | protrusion | | protrusion |
| Example 3 | Copper-nickel- | Silver | Gold | Deposited convex | Deposited | Needle-shaped | Spherical |
| | phosphorus alloy | | | | protrusion | (conical shape) | protrusion |
| | | | | | | convex | |
| Example 4 | Highly pure nickel | Silver | Gold | Deposited convex | Deposited | Needle-shaped | Spherical |
| | | | | | protrusion | (conical shape) | protrusion |
| | | | | | | convex | |
| Example 5 | — | Silver | Gold | — | Deposited | — | Spherical |
| | | | | | protrusion | | protrusion |
| Example 6 | — | Silver | Gold | — | Deposited | — | Needle-shaped |
| | | | | | protrusion | | protrusion |
| Example 7 | Silver | Silver | Gold | Deposited convex | Deposited | Needle-shaped | Spherical |
| | | | | | protrusion | (conical shape) | protrusion |
| | | | | | | convex | |
| Example 8 | Nickel-tungsten- | Silver | Gold | Ni core substance | Deposited | Spherical convex | Spherical |
| | boron alloy | | | composite convex | protrusion | | protrusion |
| Example 9 | Nickel-tungsten- | Silver | Palladium | Ni core substance | Deposited | Spherical convex | Spherical |
| | boron alloy | | | composite convex | protrusion | | protrusion |
| Example 10 | Copper | Silver | Palladium | Ni core substance | Deposited | Spherical convex | Spherical |
| | | | | composite convex | protrusion | | protrusion |
| Example 11 | Copper | Silver | Gold | Ni core substance | Deposited | Spherical convex | Spherical |
| | | | | composite convex | protrusion | | protrusion |
| Example 12 | Copper | Silver | Gold | Ni core substance | Deposited | Spherical convex | Spherical |
| | | | | composite convex | protrusion | | protrusion |
| Example 13 | Copper | Silver | Gold | Ni core substance | Deposited | Spherical convex | Spherical |
| | | | | composite convex | protrusion | | protrusion |
| Example 14 | Copper | Silver | Gold | Ni core substance | Deposited | Spherical convex | Spherical |
| | | | | composite convex | protrusion | | protrusion |
| Example 15 | Copper | Silver | Gold | Ni core substance | Deposited | Spherical convex | Spherical |
| | | | | composite convex | protrusion | | protrusion |
| Example 16 | Copper | Silver | Gold | Ni core substance | Deposited | Spherical convex | Spherical |
| | | | | composite convex | protrusion | | protrusion |
| Example 17 | Copper | Silver | Gold | Ni core substance | Deposited | Spherical convex | Spherical |
| | | | | composite convex | protrusion | | protrusion |
| Example 18 | Copper | Silver | Gold | Ni core substance | Deposited | Spherical convex | Spherical |
| | | | | composite convex | protrusion | | protrusion |
| Example 19 | Nickel-phosphorus | Silver | Gold | Ni core substance | Deposited | Spherical convex | Spherical |
| | alloy | | | composite convex | protrusion | | protrusion |
| Example 20 | Copper | Silver | Gold | Ni core substance | Deposited | Spherical convex | Spherical |
| | | | | composite convex | protrusion | | protrusion |
| Example 21 | Copper | Silver | Gold | Ni core substance | Deposited | Spherical convex | Spherical |
| | | | | composite convex | protrusion | | protrusion |
| Comparative | Nickel-phosphorus | — | Silver | Ni core substance | — | Spherical convex | — |
| Example 1 | alloy | | | composite convex | | | |
| Comparative | Nickel-phosphorus | Nickel-phosphorus | Nickel-phosphorus | Ni core substance | Deposited | Spherical convex | Spherical |
| Example 2 | alloy | alloy | alloy | composite convex | protrusion | | protrusion |

TABLE 2

| | Kind of metal | | | | | | |
|---|---|---|---|---|---|---|---|
| | Metal section | | | Kind of convex and protrusion | | Shape of protrusion | |
| | Convex | Protrusion | Metal film | Convex | Protrusion | Convex | Protrusion |
| Example 22 | Copper | Silver | Silver | Ni core substance | Deposited | Spherical convex | Spherical |
| | | | | composite convex | protrusion | | protrusion |
| Example 23 | Copper | Silver | Silver | Al2O3 core substance | Deposited | Spherical convex | Spherical |
| | | | | composite convex | protrusion | | protrusion |
| Example 24 | Copper-Nickel- | Silver | Silver | Deposited convex | Deposited | Needle-shaped (conical | Spherical |
| | phosphorus alloy | | | | protrusion | shape) convex | protrusion |
| Example 25 | Highly pure nickel | Silver | Silver | Deposited convex | Deposited | Needle-shaped (conical | Spherical |
| | | | | | protrusion | shape) convex | protrusion |
| Example 26 | — | Silver | Silver | — | Deposited | — | Spherical |
| | | | | | protrusion | | protrusion |
| Example 27 | — | Silver | Silver | — | Deposited | — | Needle-shaped |
| | | | | | protrusion | | protrusion |
| Example 28 | Silver | Silver | Silver | Deposited convex | Deposited | Needle-shaped (conical | Spherical |
| | | | | | protrusion | shape) convex | protrusion |
| Example 29 | Nickel-tungsten- | Silver | Silver | Ni core substance | Deposited | Spherical convex | Spherical |
| | boron alloy | | | composite convex | protrusion | | protrusion |
| Example 30 | Copper | Tin | Tin | Ni core substance | Deposited | Spherical convex | Spherical |
| | | | | composite convex | protrusion | | protrusion |
| Example 31 | Copper | Silver | Silver | Ni core substance | Deposited | Spherical convex | Spherical |
| | | | | composite convex | protrusion | | protrusion |
| Example 32 | Copper | Silver | Silver | Ni core substance | Deposited | Spherical convex | Spherical |
| | | | | composite convex | protrusion | | protrusion |
| Example 33 | Copper | Silver | Silver | Ni core substance | Deposited | Spherical convex | Spherical |
| | | | | composite convex | protrusion | | protrusion |
| Example 34 | Copper | Silver | Silver | Ni core substance | Deposited | Spherical convex | Spherical |
| | | | | composite convex | protrusion | | protrusion |
| Example 35 | Copper | Silver | Silver | Ni core substance | Deposited | Spherical convex | Spherical |
| | | | | composite convex | protrusion | | protrusion |
| Example 36 | Copper | Silver | Silver | Ni core substance | Deposited | Spherical convex | Spherical |
| | | | | composite convex | protrusion | | protrusion |
| Example 37 | Copper | Silver | Silver | Ni core substance | Deposited | Spherical convex | Spherical |
| | | | | composite convex | protrusion | | protrusion |
| Example 38 | Copper | Silver | Silver | Ni core substance | Deposited | Spherical convex | Spherical |
| | | | | composite convex | protrusion | | protrusion |
| Example 39 | Nickel-phosphorus | Silver | Silver | Ni core substance | Deposited | Spherical convex | Spherical |
| | alloy | | | composite convex | protrusion | | protrusion |
| Example 40 | Copper | Silver | Silver | Ni core substance | Deposited | Spherical convex | Spherical |
| | | | | composite convex | protrusion | | protrusion |
| Example 41 | Copper | Silver | Silver | Ni core substance | Deposited | Spherical convex | Spherical |
| | | | | composite convex | protrusion | | protrusion |

TABLE 3

| | | Particle | 10% K | Proportion |
|---|---|---|---|---|
| | | diameter | value of | of (111) |
| | | of metal- | metal- | plane in |
| | Kind | containing | containing | metal |
| | of base | particle | particle | section |
| | particle | (μm) | (N/mm²) | (%) |
| Example 1 | A | 3.2 | 4800 | 85 |
| Example 2 | A | 3.2 | 4900 | 85 |
| Example 3 | A | 3.2 | 5200 | 75 |
| Example 4 | A | 3.2 | 7400 | 70 |
| Example 5 | A | 3.2 | 4200 | 85 |
| Example 6 | A | 3.2 | 4300 | 85 |
| Example 7 | A | 3.2 | 4700 | 85 |
| Example 8 | A | 3.2 | 8800 | 65 |
| Example 9 | A | 3.2 | 8780 | 65 |
| Example 10 | A | 3.2 | 4700 | 85 |
| Example 11 | B | 3.2 | 150 | 85 |
| Example 12 | C | 3.2 | 120 | 85 |
| Example 13 | D | 2.7 | — | 85 |
| Example 14 | E | 2.7 | — | 85 |
| Example 15 | F | 2.2 | 5900 | 85 |
| Example 16 | G | 10.2 | 4100 | 85 |
| Example 17 | H | 50.2 | 3900 | 85 |
| Example 18 | A | 3.2 | 4800 | 85 |
| Example 19 | A | 3.2 | 820 | 51 |
| Example 20 | A | 3.2 | 4800 | 85 |
| Example 21 | A | 3.2 | 4800 | 85 |
| Comparative | A | 3.2 | 7900 | 45 |
| Example 1 | | | | |
| Comparative | A | 3.2 | 8000 | 46 |
| Example 2 | | | | |

TABLE 4

| | | Particle | 10% K | Proportion |
|---|---|---|---|---|
| | | diameter | value of | of (111) |
| | | of metal- | metal- | plane in |
| | Kind | containing | containing | metal |
| | of base | particle | particle | section |
| | particle | (μm) | (N/mm²) | (%) |
| Example 22 | A | 3.2 | 4800 | 85 |
| Example 23 | A | 3.2 | 4900 | 85 |
| Example 24 | A | 3.2 | 5200 | 75 |
| Example 25 | A | 3.2 | 7400 | 70 |
| Example 26 | A | 3.2 | 4200 | 85 |
| Example 27 | A | 3.2 | 4300 | 85 |
| Example 28 | A | 3.2 | 4700 | 85 |
| Example 29 | A | 3.2 | 8800 | 65 |
| Example 30 | A | 3.2 | 4700 | 85 |
| Example 31 | B | 3.2 | 150 | 85 |
| Example 32 | C | 3.2 | 120 | 85 |
| Example 33 | D | 2.7 | — | 85 |
| Example 34 | E | 2.7 | — | 85 |
| Example 35 | F | 2.2 | 5900 | 85 |
| Example 36 | G | 10.2 | 4100 | 85 |
| Example 37 | H | 50.2 | 3900 | 85 |
| Example 38 | A | 3.2 | 4800 | 85 |
| Example 39 | A | 3.2 | 8200 | 51 |
| Example 40 | A | 3.2 | 4800 | 85 |
| Example 41 | A | 3.2 | 4800 | 85 |

TABLE 5

| | | | | | Average | Average | | | |
|---|---|---|---|---|---|---|---|---|---|
| | | | | | diameter (D) | diameter (d) | | | |
| | | | Average | Average | at central | at central | Ratio | Ratio | Ratio |
| | Average | Average | diameter | diameter | position of | position of | (average | (average | (average |
| | height (B) | height (b) | (C) of base | (c) of base | height of | height of | height | height | height |
| | of convex | of protrusion | of convex | of protrusion | convex | protrusion | (B)/average | (B)/average | (b)/average |
| | (nm) | (nm) | (nm) | (nm) | (nm) | (nm) | height (b)) | diameter (C)) | diameter (c)) |
| Example 1 | 262 | 9 | 320 | — | 291 | — | 29 | 0.82 | — |
| Example 2 | 265 | 8 | 328 | — | 297 | — | 33 | 0.81 | — |
| Example 3 | 480 | 9 | 110 | 104 | 295 | — | 53 | 4.36 | — |
| Example 4 | 320 | 10 | 98 | 98 | 209 | — | 32 | 3.27 | — |
| Example 5 | — | 9 | — | 10 | — | 10 | — | — | 0.90 |
| Example 6 | — | 420 | — | 106 | — | 263 | — | — | 3.96 |
| Example 7 | 420 | 12 | 104 | — | 262 | — | 35 | 4.04 | — |
| Example 8 | 262 | 11 | 330 | — | 296 | — | 24 | 0.79 | — |
| Example 9 | 263 | 16 | 325 | — | 294 | — | 16 | 0.81 | — |
| Example 10 | 262 | 21 | 331 | — | 297 | — | 12 | 0.79 | — |
| Example 11 | 264 | 9 | 328 | — | 296 | — | 29 | 0.80 | — |
| Example 12 | 262 | 9 | 326 | — | 294 | — | 29 | 0.80 | — |
| Example 13 | 263 | 8 | 330 | — | 297 | — | 33 | 0.80 | — |
| Example 14 | 262 | 9 | 312 | — | 287 | — | 29 | 0.84 | — |
| Example 15 | 261 | 9 | 312 | — | 287 | — | 29 | 0.84 | — |
| Example 16 | 260 | 8 | 321 | — | 291 | — | 33 | 0.81 | — |
| Example 17 | 265 | 9 | 322 | — | 294 | — | 29 | 0.82 | — |
| Example 18 | 262 | 9 | 320 | — | 291 | — | 29 | 0.82 | — |
| Example 19 | 243 | 12 | 310 | — | 277 | — | 20 | 0.78 | — |
| Example 20 | 262 | 9 | 320 | — | 291 | — | 29 | 0.82 | — |
| Example 21 | 262 | 9 | 320 | — | 291 | — | 29 | 0.82 | — |
| Comparative | — | 262 | — | 249 | — | 256 | — | — | 1.05 |
| Example 1 | | | | | | | | | |
| Comparative | — | 180 | — | 256 | — | 218 | — | — | 0.70 |
| Example 2 | | | | | | | | | |

TABLE 6

| | | | | | Average | Average | | | |
|---|---|---|---|---|---|---|---|---|---|
| | | | | | diameter (D) | diameter (d) | | | |
| | | | Average | Average | at central | at central | Ratio | Ratio | Ratio |
| | Average | Average | diameter | diameter | position of | position of | (average | (average | (average |
| | height (B) | height (b) | (C) of base | (c) of base | height of | height of | height | height | height |
| | of convex | of protrusion | of convex | of protrusion | convex | protrusion | (B)/average | (B)/average | (b)/average |
| | (nm) | (nm) | (nm) | (nm) | (nm) | (nm) | height (b)) | diameter (C)) | diameter (c)) |
| Example 22 | 262 | 9 | 320 | — | 291 | — | 29 | 0.82 | — |
| Example 23 | 265 | 8 | 328 | — | 297 | — | 33 | 0.81 | — |
| Example 24 | 480 | 9 | 110 | 104 | 295 | — | 53 | 4.36 | — |
| Example 25 | 320 | 10 | 98 | 98 | 209 | — | 32 | 3.27 | — |
| Example 26 | — | 9 | — | 10 | — | 10 | — | — | 0.90 |
| Example 27 | — | 420 | — | 106 | — | 263 | — | — | 3.96 |
| Example 28 | 420 | 12 | 104 | — | 262 | — | 35 | 4.04 | — |
| Example 29 | 262 | 11 | 330 | — | 296 | — | 24 | 0.79 | — |
| Example 30 | 262 | 21 | 331 | — | 297 | — | 12 | 0.79 | — |
| Example 31 | 264 | 9 | 328 | — | 296 | — | 29 | 0.80 | — |
| Example 32 | 262 | 9 | 326 | — | 294 | — | 29 | 0.80 | — |
| Example 33 | 263 | 8 | 330 | — | 297 | — | 33 | 0.80 | — |
| Example 34 | 262 | 9 | 312 | — | 287 | — | 29 | 0.84 | — |
| Example 35 | 261 | 9 | 312 | — | 287 | — | 29 | 0.84 | — |
| Example 36 | 260 | 8 | 321 | — | 291 | — | 33 | 0.81 | — |
| Example 37 | 265 | 9 | 322 | — | 294 | — | 29 | 0.82 | — |
| Example 38 | 262 | 9 | 320 | — | 291 | — | 29 | 0.82 | — |
| Example 39 | 243 | 12 | 310 | — | 277 | — | 20 | 0.78 | — |
| Example 40 | 262 | 9 | 320 | — | 291 | — | 29 | 0.82 | — |
| Example 41 | 262 | 9 | 320 | — | 291 | — | 29 | 0.82 | — |

TABLE 7

| | Proportion (X) of | Proportion (x) of | | | Proportion of | Proportion (x) |
|---|---|---|---|---|---|---|
| | surface area of | surface area of | Average (A) of | Average (a) of | number of | of number of |
| | portion having | portion having | vertical angle | vertical angle | needle-shaped | needle-shaped |
| | convex | protrusion | of convex | of protrusion | convex | protrusion |
| | (%) | (%) | (°) | (°) | (%) | (%) |
| Example 1 | 80 | Not measured | — | — | — | — |
| Example 2 | 80 | Not measured | — | — | — | — |
| Example 3 | 95 | Not measured | 28 | — | 99 | — |
| Example 4 | 95 | Not measured | 15 | — | 99 | — |
| Example 5 | — | 95 | — | — | — | — |
| Example 6 | — | 95 | — | 30 | — | 95 |
| Example 7 | 95 | Not measured | 30 | — | 95 | — |
| Example 8 | 80 | Not measured | — | — | — | — |
| Example 9 | 80 | Not measured | — | — | — | — |
| Example 10 | 80 | Not measured | — | — | — | — |
| Example 11 | 80 | Not measured | — | — | — | — |
| Example 12 | 80 | Not measured | — | — | — | — |
| Example 13 | 80 | Not measured | — | — | — | — |
| Example 14 | 80 | Not measured | — | — | — | — |
| Example 15 | 80 | Not measured | — | — | — | — |
| Example 16 | 80 | Not measured | — | — | — | — |
| Example 17 | 80 | Not measured | — | — | — | — |
| Example 18 | 80 | Not measured | — | — | — | — |
| Example 19 | 80 | Not measured | — | — | — | — |
| Example 20 | 80 | Not measured | — | — | — | — |
| Example 21 | 80 | Not measured | — | — | — | — |
| Comparative | — | 80 | — | — | — | — |
| Example 1 | | | | | | |
| Comparative | — | 95 | — | — | — | — |
| Example 2 | | | | | | |

TABLE 8

| | Proportion (X) of | Proportion (x) of | | | Proportion of | Proportion (x) |
|---|---|---|---|---|---|---|
| | surface area of | surface area of | Average (A) of | Average (a) of | number of | of number of |
| | portion having | portion having | vertical angle | vertical angle | needle-shaped | needle-shaped |
| | convex | protrusion | of convex | of protrusion | convex | protrusion |
| | (%) | (%) | (°) | (°) | (%) | (%) |
| Example 22 | 80 | Not measured | — | — | — | — |
| Example 23 | 80 | Not measured | — | — | — | — |
| Example 24 | 95 | Not measured | 28 | — | 99 | — |
| Example 25 | 95 | Not measured | 15 | — | 99 | — |
| Example 26 | — | 95 | — | — | — | — |
| Example 27 | — | 95 | — | 30 | — | 95 |
| Example 28 | 95 | Not measured | 30 | — | 95 | — |
| Example 29 | 80 | Not measured | — | — | — | — |
| Example 30 | 80 | Not measured | — | — | — | — |
| Example 31 | 80 | Not measured | — | — | — | — |
| Example 32 | 80 | Not measured | — | — | — | — |
| Example 33 | 80 | Not measured | — | — | — | — |
| Example 34 | 80 | Not measured | — | — | — | — |
| Example 35 | 80 | Not measured | — | — | — | — |
| Example 36 | 80 | Not measured | — | — | — | — |
| Example 37 | 80 | Not measured | — | — | — | — |
| Example 38 | 80 | Not measured | — | — | — | — |
| Example 39 | 80 | Not measured | — | — | — | — |
| Example 40 | 80 | Not measured | — | — | — | — |
| Example 41 | 80 | Not measured | — | — | — | — |

TABLE 9

| | | | | | | | | Conduction inspection | |
|---|---|---|---|---|---|---|---|---|---|
| | Connection structure A | | | | Connection structure B | | | member | |
| | Melted and | | | | Melted and | | | Contact | Repeated |
| | solidified | Bonded | Connection | Insulation | solidified | Bonded | Connection | resistance | reliability |
| | state | state | reliability | reliability | state | state | reliability | value | test |
| Example 1 | A | A | ∘∘ | ∘ | A | A | ∘∘ | ∘∘ | ∘∘ |
| Example 2 | A | A | ∘∘ | ∘ | A | A | ∘∘ | ∘∘ | ∘∘ |
| Example 3 | A | A | ∘∘∘ | ∘ | A | A | ∘∘∘ | ∘∘ | ∘∘ |
| Example 4 | A | A | ∘∘∘ | ∘ | A | A | ∘∘ | ∘∘ | ∘∘ |
| Example 5 | A | A | ∘ | ∘ | A | A | ∘ | ∘∘ | ∘∘ |
| Example 6 | A | A | ∘∘ | ∘ | A | A | ∘∘ | ∘∘ | ∘∘ |
| Example 7 | A | A | ∘∘∘ | ∘ | A | A | ∘∘∘ | ∘∘ | ∘∘ |
| Example 8 | A | A | ∘∘ | ∘ | A | A | ∘∘ | ∘∘ | ∘∘ |
| Example 9 | A | A | ∘∘ | ∘ | A | A | ∘∘ | ∘∘ | ∘∘ |
| Example 10 | A | A | ∘∘ | ∘ | A | A | ∘∘ | ∘∘ | ∘∘ |
| Example 11 | A | A | ∘∘∘ | ∘ | A | A | ∘∘∘ | ∘∘ | ∘∘ |
| Example 12 | A | A | ∘∘∘ | ∘ | A | A | ∘∘∘ | ∘∘ | ∘∘ |
| Example 13 | A | A | ∘ | ∘ | A | A | ∘∘ | ∘∘ | ∘∘ |
| Example 14 | A | A | ∘ | ∘ | A | A | ∘∘ | ∘∘ | ∘∘ |
| Example 15 | A | A | ∘∘ | ∘ | A | A | ∘∘ | ∘∘ | ∘∘ |
| Example 16 | A | A | ∘∘ | ∘ | A | A | ∘∘ | ∘∘ | ∘∘ |
| Example 17 | — | — | — | ∘ | A | A | ∘∘ | ∘∘ | ∘∘ |
| Example 18 | A | A | ∘ | ∘ | A | A | ∘ | ∘ | ∘ |
| Example 19 | A | A | ∘∘ | ∘ | A | A | ∘ | ∘∘ | ∘∘ |
| Example 20 | A | A | ∘∘ | ∘ | A | A | ∘∘ | ∘∘ | ∘∘ |
| Example 21 | A | A | ∘∘ | ∘ | A | A | ∘∘ | ∘∘ | ∘∘ |
| Comparative | B | B | x | x | B | B | x | x | x |
| Example 1 | | | | | | | | | |
| Comparative | B | B | Δ | ∘ | B | B | x | Δ | x |
| Example 2 | | | | | | | | | |

TABLE 10

| | | | | | | | | Conduction inspection | |
|---|---|---|---|---|---|---|---|---|---|
| | Connection structure A | | | | Connection structure B | | | member | |
| | Melted and | | | | Melted and | | | Contact | Repeated |
| | solidified | Bonded | Connection | Insulation | solidified | Bonded | Connection | resistance | reliability |
| | state | state | reliability | reliability | state | state | reliability | value | test |
| Example 22 | A | A | ∘∘ | ∘ | A | A | ∘∘ | ∘∘ | ∘∘ |
| Example 23 | A | A | ∘∘ | ∘ | A | A | ∘∘ | ∘∘ | ∘∘ |
| Example 24 | A | A | ∘∘∘ | ∘ | A | A | ∘∘∘ | ∘∘ | ∘∘ |
| Example 25 | A | A | ∘∘∘ | ∘ | A | A | ∘∘ | ∘∘ | ∘∘ |
| Example 26 | A | A | ∘ | ∘ | A | A | ∘ | ∘∘ | ∘∘ |
| Example 27 | A | A | ∘∘ | ∘ | A | A | ∘∘ | ∘∘ | ∘∘ |
| Example 28 | A | A | ∘∘∘ | ∘ | A | A | ∘∘∘ | ∘∘ | ∘∘ |
| Example 29 | A | A | ∘∘ | ∘ | A | A | ∘ | ∘∘ | ∘∘ |
| Example 30 | A | A | ∘ | ∘ | A | A | ∘∘ | ∘ | ∘ |
| Example 31 | A | A | ∘∘∘ | ∘ | A | A | ∘∘∘ | ∘∘ | ∘∘ |
| Example 32 | A | A | ∘∘∘ | ∘ | A | A | ∘∘∘ | ∘∘ | ∘∘ |
| Example 33 | A | A | ∘ | ∘ | A | A | ∘∘ | ∘∘ | ∘∘ |
| Example 34 | A | A | ∘ | ∘ | A | A | ∘∘ | ∘∘ | ∘∘ |
| Example 35 | A | A | ∘∘ | ∘ | A | A | ∘∘ | ∘∘ | ∘∘ |
| Example 36 | A | A | ∘∘ | ∘ | A | A | ∘∘ | ∘∘ | ∘∘ |
| Example 37 | — | — | — | ∘ | A | A | ∘∘ | ∘∘ | ∘∘ |
| Example 38 | A | A | ∘ | ∘ | A | A | ∘ | ∘ | ∘ |
| Example 39 | A | A | ∘∘ | ∘ | A | A | ∘ | ∘∘ | ∘∘ |
| Example 40 | A | A | ∘∘ | ∘ | A | A | ∘∘ | ∘∘ | ∘∘ |
| Example 41 | A | A | ∘∘ | ∘ | A | A | ∘∘ | ∘∘ | ∘∘ |

Incidentally, the spherical shape of the convex and protrusion includes a shape of a part of a sphere. Incidentally, in Comparative Examples 1 and 2, it has been confirmed that the tips of the plurality of protrusions do not melt even when being heated to 400° C.

### Example 42

As a base particle S1, a divinylbenzene copolymer resin particle (“Micropearl SP-203” manufactured by Sekisui Chemical Co., Ltd.) having a particle diameter of 3.0 μm was prepared.

In 100 parts by weight of an alkaline solution containing a palladium catalyst solution at 5% by weight, 10 parts by weight of the base particle S1 was dispersed using an ultrasonic disperser, and then the solution was filtered to take out the base particle S1. Subsequently, the base particle S1 was added to 100 parts by weight of a 1% by weight solution of dimethylamine borane to activate the surface of the base particle S1. The surface-activated base particle S1 was thoroughly washed with water and then added to and dispersed in 500 parts by weight of distilled water to obtain a suspension (A1).

The suspension (A1) was placed in a solution containing nickel sulfate at 25 g/L, thallium nitrate at 15 ppm, and bismuth nitrate at 10 ppm to obtain a particle mixture (B1).

In addition, a nickel plating solution (C1) (pH 5.5) containing nickel sulfate at 100 g/L, sodium hypophosphite at 40 g/L, sodium citrate at 15 g/L, thallium nitrate at 25 ppm, and bismuth nitrate at 10 ppm was prepared.

In addition, as an electroless substitution gold plating solution, a gold plating solution (D1) (pH 8.0) containing gold potassium cyanide at 10 g/L, sodium citrate at 20 g/L, thallium nitrate at 5 ppm, ethylenediaminetetraacetic acid at 3.0 g/L, sodium hydroxide at 20 g/L, and dimethylamine borane at 10 g/L was prepared.

The nickel plating solution (C1) was gradually dropped to the particle mixture (B1) at 50° C. in which a particle was dispersed to perform electroless nickel plating. The electroless nickel plating was performed at a dropping rate of the nickel plating solution (C1) of 12.5 mL/min and a dropping time of 30 minutes (Ni plating step). A particle mixture (E1) containing a particle in which a nickel-phosphorus alloy metal section as the first metal section was equipped on the surface of a resin particle was thus obtained.

Thereafter, the particle was taken out by filtering the particle mixture (E1) and washed with water to obtain a particle in which a nickel-phosphorus alloy metal section was disposed on the surface of the base particle S1. This particle was thoroughly washed with water and then added to and dispersed in 500 parts by weight of distilled water to obtain a particle mixture (F1).

Next, 1 part by weight of metal tin particle slurry (average particle diameter: 150 nm) was added to the particle mixture (F1) over 3 minutes to obtain a particle mixture (G1) containing a particle in which a core substance was attached onto the nickel-phosphorus alloy metal section.

Next, the gold plating solution (D1) was gradually dropped to the particle mixture (G1) at 60° C. in which a particle was dispersed to perform electroless gold plating. The electroless gold plating was performed at a dropping rate of the gold plating solution (D1) of 2 mL/min and a dropping time of 45 minutes. Thereafter, the particle was taken out by filtration, washed with water, and dried to obtain a metal-containing particle in which a nickel-phosphorus alloy metal section and a gold metal protion (the thickness of the entire metal sections at the portion not having protrusions: 0.1 μm) and protrusions were equipped on the surface of the base particle S1.

### Example 43

The suspension (A1) of Example 42 was prepared.

The suspension (A1) was placed in a solution containing gold potassium cyanide at 2 g/L, sodium citrate at 10 g/L, ethylenediaminetetraacetic acid at 0.5 g/L, and sodium hydroxide at 5 g/L to obtain a particle mixture (C2).

In addition, as an electroless gold plating solution, a gold plating solution (D2) (pH 8.0) containing gold potassium cyanide at 10 g/L, sodium citrate at 20 g/L, thallium nitrate at 5 ppm, ethylenediaminetetraacetic acid at 3.0 g/L, sodium hydroxide at 20 g/L, and dimethylamine borane at 10 g/L was prepared.

In addition, as a tin solution, a tin plating solution (E2) was prepared by adjusting the pH of a mixture containing tin chloride at 20 g/L, nitrilotriacetic acid at 50 g/L, thiourea at 2 g/L, and ethylenediaminetetraacetic acid at 7.5 g/L to 7.0 with sulfuric acid.

Moreover, as a reducing solution for tin protrusion formation, a reducing solution (F2) was prepared by adjusting the pH of a mixture containing sodium borohydride at 10 g/L and sodium hydroxide at 5 g/L to 10.0.

The gold plating solution (D2) was gradually dropped to the particle mixture (C2) at 60° C. in which a particle was dispersed to perform electroless gold plating. The electroless gold plating was performed at a dropping rate of the gold plating solution (D2) of 2 mL/min and a dropping time of 45 minutes. A particle mixture (G2) containing a particle in which a gold metal section was disposed on the surface of the base particle S1 was thus obtained.

Thereafter, the particle was taken out by filtering the particle mixture (G2) and washed with water to obtain a particle in which a gold metal section was disposed on the surface of the base particle S1. This particle was thoroughly washed with water and then added to and dispersed in 500 parts by weight of distilled water to obtain a particle mixture (H2).

Next, the tin plating solution (E2) was gradually added to the particle mixture (H2) at 60° C. in which a particle was dispersed. Thereafter, a tin protrusion nucleus was formed by gradually dropping the reducing solution (F2) to the mixture, thereby obtaining a particle mixture (I2) containing a particle in which a tin protrusion nucleus was attached to the gold metal section.

Thereafter, the particle was taken out by filtering the particle mixture (I2) and washed with water to obtain a particle in which a gold metal section was disposed on the surface of the base particle S1 and tin protrusions were formed. This particle was thoroughly washed with water and then added to and dispersed in 500 parts by weight of distilled water to obtain a particle mixture (J2).

Next, the gold plating solution (D2) was gradually dropped to the particle mixture (J2) at 60° C. in which a particle was dispersed to perform electroless gold plating. The electroless gold plating was performed at a dropping rate of the gold plating solution (D2) of 1 mL/min and a dropping time of 10 minutes. Thereafter, the particle was taken out by filtration, washed with water, and dried to obtain a metal-containing particle in which a gold metal section (the thickness of the entire metal sections at the portion not having protrusions: 0.1 μm) and protrusions were equipped on the surface of the base particle S1.

### Example 44

The suspension (A1) of Example 42 was prepared.

Next, 1 part by weight of metal tin particle slurry (average particle diameter: 150 nm) was added to the suspension (A1) over 3 minutes to obtain a particle mixture (B3) containing the base particle S1 to which a core substance was attached.

The particle mixture (B3) was placed in a solution containing gold potassium cyanide at 2 g/L, sodium citrate at 10 g/L, ethylenediaminetetraacetic acid at 0.5 g/L, and sodium hydroxide at 5 g/L to obtain a particle mixture (C3).

In addition, as an electroless gold plating solution, a gold plating solution (D3) (pH 8.0) containing gold potassium cyanide at 20 g/L, sodium citrate at 20 g/L, thallium nitrate at 5 ppm, ethylenediaminetetraacetic acid at 7.0 g/L, sodium hydroxide at 20 g/L, and dimethylamine borane at 10 g/L was prepared.

Next, the gold plating solution (D3) was gradually dropped to the particle mixture (B3) at 60° C. in which a particle was dispersed to perform electroless gold plating. The electroless gold plating was performed at a dropping rate of the gold plating solution (D3) of 2 mL/min and a dropping time of 45 minutes. Thereafter, the particle was taken out by filtration, washed with water, and dried to obtain a metal-containing particle in which a gold metal section (the thickness of the entire metal sections at the portion not having protrusions: 0.1 μm) and protrusions were equipped on the surface of the base particle S1.

### Example 45

The suspension (A1) of Example 42 was prepared.

A particle mixture (B4) containing the base particle S1 to which a core substance was attached was obtained by adding 1 part by weight of metal tin particle slurry (average particle diameter: 150 nm) to the suspension (A1) over 3 minutes.

The particle mixture (B4) was placed in a solution containing gold potassium cyanide at 2 g/L, sodium citrate at 10 g/L, ethylenediaminetetraacetic acid at 0.5 g/L, and sodium hydroxide at 5 g/L to obtain a particle mixture (C4).

In addition, as an electroless gold plating solution, a gold plating solution (D4) (pH 8.0) containing gold potassium cyanide at 10 g/L, sodium citrate at 20 g/L, thallium nitrate at 5 ppm, ethylenediaminetetraacetic acid at 3.0 g/L, sodium hydroxide at 20 g/L, and dimethylamine borane at 10 g/L was prepared.

In addition, a nickel plating solution (E4) (pH 5.5) containing nickel sulfate at 100 g/L, sodium hypophosphite at 40 g/L, sodium citrate at 15 g/L, thallium nitrate at 25 ppm, and bismuth nitrate at 10 ppm was prepared.

Next, the gold plating solution (D4) was gradually dropped to the particle mixture (B4) at 60° C. in which a particle was dispersed to perform electroless gold plating. The electroless gold plating was performed at a dropping rate of the gold plating solution (D4) of 2 mL/min and a dropping time of 45 minutes. A particle mixture (F4) containing a particle in which a gold metal section was disposed on the surface of the base particle S1 was thus obtained.

Thereafter, the particle was taken out by filtering the particle mixture (F4) and washed with water to obtain a particle in which a gold metal section was disposed on the surface of the base particle S1. This particle was thoroughly washed with water and then added to and dispersed in 500 parts by weight of distilled water to obtain a particle mixture (G4).

Next, the nickel plating solution (E4) was gradually dropped to the particle mixture (G4) at 50° C. in which a particle was dispersed to perform electroless nickel plating. The electroless nickel plating was performed at a dropping rate of the nickel plating solution (E4) of 2.5 mL/min and a dropping time of 10 minutes (Ni plating step). Thereafter, the particle was taken out by filtration, washed with water, and dried to obtain a metal-containing particle in which a gold metal section and a nickel-phosphorus alloy metal section (the thickness of the entire metal sections at the portion not having protrusions: 0.1 μm) and protrusions were equipped on the surface of the base particle S1.

### Example 46

The suspension (A1) of Example 42 was prepared.

A particle mixture (B5) containing the base particle S1 to which a core substance was attached was obtained by adding 1 part by weight of metal tin particle slurry (average particle diameter: 150 nm) to the suspension (A1) over 3 minutes.

The particle mixture (B5) was placed in a solution containing silver nitrate at 5 g/L, succinimide at 10 g/L, ethylenediaminetetraacetic acid at 0.1 g/L, and sodium hydroxide at 5 g/L to obtain a particle mixture (C5).

In addition, as an electroless silver plating solution, a silver plating solution (D5) (pH 7.0) containing silver nitrate at 30 g/L, succinimide at 100 g/L, and formaldehyde at 20 g/L was prepared.

Next, the silver plating solution (D5) was gradually dropped to the particle mixture (B5) at 55° C. in which a particle was dispersed to perform electroless silver plating. The electroless silver plating was performed at a dropping rate of the silver plating solution (D5) of 2 mL/min and a dropping time of 45 minutes. Thereafter, the particle was taken out by filtration, washed with water, and dried to obtain a metal-containing particle in which a silver metal section (the thickness of the entire metal sections at the portion not having protrusions: 0.1 μm) and protrusions were equipped on the surface of the base particle S1.

### Example 47

The suspension (A1) of Example 42 was prepared.

The suspension (A1) was placed in a solution containing nickel sulfate at 25 g/L, thallium nitrate at 15 ppm, and bismuth nitrate at 10 ppm to obtain a particle mixture (B6).

In addition, a nickel plating solution (C6) (pH 5.5) containing nickel sulfate at 100 g/L, sodium hypophosphite at 40 g/L, sodium citrate at 15 g/L, thallium nitrate at 25 ppm, and bismuth nitrate at 10 ppm was prepared.

In addition, as an electroless silver plating solution, a silver plating solution (D6) (pH 7.0) containing silver nitrate at 30 g/L, succinimide at 100 g/L, and formaldehyde at 20 g/L was prepared.

The nickel plating solution (C6) was gradually dropped to the particle mixture (B6) at 50° C. in which a particle was dispersed to perform electroless nickel plating. The electroless nickel plating was performed at a dropping rate of the nickel plating solution (C6) of 12.5 mL/min and a dropping time of 30 minutes (Ni plating step). A particle mixture (E6) containing a particle in which a nickel-phosphorus alloy metal section as the first metal section was equipped on the surface of a resin particle was thus obtained.

Thereafter, the particle was taken out by filtering the particle mixture (E6) and washed with water to obtain a particle in which a nickel-phosphorus alloy metal section was disposed on the surface of the base particle S1. This particle was thoroughly washed with water and then added to and dispersed in 500 parts by weight of distilled water to obtain a particle mixture (F6).

Next, 1 part by weight of metal tin particle slurry (average particle diameter: 150 nm) was added to the particle mixture (F6) over 3 minutes to obtain a particle mixture (G6) containing a particle in which a core substance was attached onto the nickel-phosphorus alloy metal section.

Next, the silver plating solution (D6) was gradually dropped to the particle mixture (G6) at 55° C. in which a particle was dispersed to perform electroless silver plating. The electroless silver plating was performed at a dropping rate of the silver plating solution (D6) of 2 mL/min and a dropping time of 45 minutes. Thereafter, the particle was taken out by filtration, washed with water, and dried to obtain a metal-containing particle in which a nickel-phosphorus alloy metal section and a silver metal section (the thickness of the entire metal sections at the portion not having protrusions: 0.1 μm) and protrusions were equipped on the surface of the base particle S1.

### Example 48

The suspension (A1) of Example 42 was prepared.

A particle mixture (B7) containing the base particle S1 to which a core substance was attached was obtained by adding 1 part by weight of metal tin particle slurry (average particle diameter: 150 nm) to the suspension (A1) over 3 minutes.

The particle mixture (B7) was placed in a solution containing copper sulfate at 20 g/L and ethylenediaminetetraacetic acid at 30 g/L to obtain a particle mixture (C7).

In addition, as an electroless copper plating solution, a copper plating solution (D7) was prepared by adjusting the pH of a mixture containing copper sulfate at 230 g/L, ethylenediaminetetraacetic acid at 150 g/L, sodium gluconate at 100 g/L, and formaldehyde at 35 g/L to 10.5 with ammonia.

Next, the copper plating solution (D7) was gradually dropped to the particle mixture (B7) at 55° C. in which a particle was dispersed to perform electroless copper plating. The electroless copper plating was performed at a dropping rate of the copper plating solution (D7) of 30 mL/min and a dropping time of 30 minutes. Thereafter, the particle was taken out by filtration, washed with water, and dried to obtain a metal-containing particle in which a copper metal section (the thickness of the entire metal sections at the portion not having protrusions: 0.1 μm) and protrusions were equipped on the surface of the base particle S1.

### Example 49

The suspension (A1) of Example 42 was prepared.

The suspension (A1) was placed in a solution containing nickel sulfate at 25 g/L, thallium nitrate at 15 ppm, and bismuth nitrate at 10 ppm to obtain a particle mixture (B8).

In addition, a nickel plating solution (C8) (pH 5.5) containing nickel sulfate at 100 g/L, sodium hypophosphite at 40 g/L, sodium citrate at 15 g/L, thallium nitrate at 25 ppm, and bismuth nitrate at 10 ppm was prepared.

In addition, as an electroless copper plating solution, a copper plating solution (D8) was prepared by adjusting the pH of a mixture containing copper sulfate at 130 g/L, ethylenediaminetetraacetic acid at 100 g/L, sodium gluconate at 80 g/L, and formaldehyde at 30 g/L to 10.5 with ammonia.

The nickel plating solution (C8) was gradually dropped to the particle mixture (B8) at 50° C. in which a particle was dispersed to perform electroless nickel plating. The electroless nickel plating was performed at a dropping rate of the nickel plating solution (C8) of 12.5 mL/min and a dropping time of 30 minutes (Ni plating step). A particle mixture (E8) containing a particle in which a nickel-phosphorus alloy metal section as the first metal section was equipped on the surface of a resin particle was thus obtained.

Thereafter, the particle was taken out by filtering the particle mixture (E8) and washed with water to obtain a particle in which a nickel-phosphorus alloy metal section was disposed on the surface of the base particle S1. This particle was thoroughly washed with water and then added to and dispersed in 500 parts by weight of distilled water to obtain a particle mixture (F8).

Next, 1 part by weight of metal tin particle slurry (average particle diameter: 150 nm) was added to the particle mixture (F8) over 3 minutes to obtain a particle mixture (G8) containing a particle in which a core substance was attached onto the nickel-phosphorus alloy metal section.

Next, the copper plating solution (G8) was gradually dropped to the particle mixture (D8) at 55° C. in which a particle was dispersed to perform electroless copper plating. The electroless copper plating was performed at a dropping rate of the copper plating solution (D8) of 25 mL/min and a dropping time of 15 minutes. Thereafter, the particle was taken out by filtration, washed with water, and dried to obtain a metal-containing particle in which a nickel-phosphorus alloy metal section and a copper metal section (the thickness of the entire metal sections at the portion not having protrusions: 0.1 μm) and protrusions were equipped on the surface of the base particle S1.

### Example 50

The suspension (A1) of Example 42 was prepared.

The suspension (A1) was placed in a solution containing nickel sulfate at 25 g/L, thallium nitrate at 15 ppm, and bismuth nitrate at 10 ppm to obtain a particle mixture (B9).

In addition, a nickel plating solution (C9) (pH 5.5) containing nickel sulfate at 100 g/L, sodium hypophosphite at 40 g/L, sodium citrate at 15 g/L, thallium nitrate at 25 ppm, and bismuth nitrate at 10 ppm was prepared.

In addition, as an electroless tin plating solution, a tin plating solution (D9) was prepared by adjusting the pH of a mixture containing tin chloride at 20 g/L, nitrilotriacetic acid at 50 g/L, thiourea at 2 g/L, thiomalic acid at 1 g/L, ethylenediaminetetraacetic acid at 7.5 g/L, and titanium trichloride at 15 g/L to 7.0 with sulfuric acid.

The nickel plating solution (C9) was gradually dropped to the particle mixture (B9) at 50° C. in which a particle was dispersed to perform electroless nickel plating. The electroless nickel plating was performed at a dropping rate of the nickel plating solution (C9) of 12.5 mL/min and a dropping time of 30 minutes (Ni plating step). A particle mixture (E9) containing a particle in which a nickel-phosphorus alloy metal section as the first metal section was equipped on the surface of a resin particle was thus obtained.

Thereafter, the particle was taken out by filtering the particle mixture (E9) and washed with water to obtain a particle in which a nickel-phosphorus alloy metal section was disposed on the surface of the base particle S1. This particle was thoroughly washed with water and then added to and dispersed in 500 parts by weight of distilled water to obtain a particle mixture (F9).

Next, 1 part by weight of metal tin particle slurry (average particle diameter: 150 nm) was added to the particle mixture (F9) over 3 minutes to obtain a particle mixture (G9) containing a particle in which a core substance was attached onto the nickel-phosphorus alloy metal section.

Next, the tin plating solution (D9) was gradually dropped to the particle mixture (G9) at 70° C. in which a particle was dispersed to perform electroless tin plating. The electroless tin plating was performed at a dropping rate of the tin plating solution (D9) of 30 mL/min and a dropping time of 25 minutes. Thereafter, the particle was taken out by filtration, washed with water, and dried to obtain a metal-containing particle in which a nickel-phosphorus alloy metal section and a tin metal section (the thickness of the entire metal sections at the portion not having protrusions: 0.1 μm) and protrusions were equipped on the surface of the base particle S1.

### Example 51

1. Fabrication of silicone oligomer In a 100 ml separable flask installed in a hot bath, 1 part by weight of 1,3-divinyltetramethyldisiloxane and 20 parts by weight of a 0.5% by weight aqueous solution of p-toluenesulfonic acid were placed. After the mixture was stirred at 40° C. for 1 hour, 0.05 parts by weight of sodium hydrogen carbonate was added thereto. Thereafter, 10 parts by weight of dimethoxymethylphenylsilane, 49 parts by weight of dimethyldimethoxysilane, 0.6 parts by weight of trimethylmethoxysilane, and 3.6 parts by weight of methyltrimethoxysilane were added to the mixture, and this mixture was stirred for 1 hour. Thereafter, 1.9 parts by weight of a 10% by weight aqueous solution of potassium hydroxide was added to the resultant mixture, the temperature of this mixture was raised to 85° C., and the mixture was stirred and reacted for 10 hours while the pressure was lowered using an aspirator. After completion of the reaction, the pressure was returned to normal pressure, and the reaction mixture was cooled to 40° C., 0.2 parts by weight of acetic acid was added thereto, and the mixture was allowed to stand in a separatory funnel for 12 hours or more. After separation of two layers, the lower layer was taken out and purified using an evaporator to obtain a silicone oligomer.

2. Fabrication of silicone particle material (containing organic polymer)

A solution A was prepared by dissolving 0.5 parts by weight of tert-butyl 2-ethylperoxyhexanoate (polymerization initiator, “PERBUTYL 0” manufactured by NOF Corporation) in 30 parts by weight of the silicone oligomer obtained. In addition, an aqueous solution B was prepared by mixing 0.8 parts by weight of a 40% by weight aqueous solution of triethanolamine lauryl sulfate (emulsifier) and 80 parts by weight of a 5% by weight aqueous solution of polyvinyl alcohol (degree of polymerization: about 2,000, degree of saponification: 86.5 to 89% by mole, “GOHSENOL GH-20” manufactured by The Nippon Synthetic Chemical Industry Co., Ltd.) in 150 parts by weight of ion-exchanged water. The solution A was placed in a separable flask installed in a hot bath, and then the aqueous solution B was added thereto. Thereafter, emulsification was performed by using a Shirasu Porous Glass (SPG) membrane (pore average diameter: about 1 Ξm). Thereafter, the temperature of the emulsion was raised to 85° C., and polymerization was performed for 9 hours. The whole particles after polymerization were washed with water by centrifugation and freeze-dried. After drying, the aggregate of particles was crushed using a ball mill until the intended ratio (average secondary particle diameter/average primary particle diameter) was attained to obtain a silicone particle (base particle S2) having a particle diameter of 3.0 μm.

A metal-containing particle was obtained by forming a metal section in the same manner as in Example 42 except that the base particle S1 was changed to the base particle S2.

### Example 52

A silicone particle (base particle S3) having a particle diameter of 3.0 μm was obtained by the same method as in Example 51 except that both terminals acrylic silicone oil (“X-22-2445” manufactured by Shin-Etsu Chemical Co., Ltd.) was used instead of the silicone oligomer.

A metal-containing particle was obtained by forming a metal section in the same manner as in Example 42 except that the base particle S1 was changed to the base particle

S3.

### Example 53

A base particle S4, which was different from the base particle S1 only in the particle diameter and had a particle diameter of 2.0 μm, was prepared.

A metal-containing particle was obtained by forming a metal section in the same manner as in Example 42 except that the base particle S1 was changed to the base particle S4.

### Example 54

A base particle S5, which was different from the base particle S1 only in the particle diameter and had a particle diameter of 10.0 μm, was prepared.

A metal-containing particle was obtained by forming a metal section in the same manner as in Example 42 except that the base particle S1 was changed to the base particle S5.

### Example 55

A base particle S6, which was different from the base particle S1 only in the particle diameter and had a particle diameter of 35.0 μm, was prepared.

A metal-containing particle was obtained by forming a metal section in the same manner as in Example 42 except that the base particle S1 was changed to the base particle S6.

### Example 56

A monomer mixture was obtained by mixing and uniformly dissolving 100 g of ethylene glycol dimethacrylate, 800 g of isobornyl acrylate, 100 g of cyclohexyl methacrylate, and 35 g of benzoyl peroxide. A 1% by weight aqueous solution of polyvinyl alcohol was prepared by 5 kg and placed in a reaction kettle. The monomer mixture was placed in this and stirred for 2 to 4 hours to adjust the particle diameter so that the droplets of monomer had a predetermined particle diameter. Thereafter, the reaction was performed in a nitrogen atmosphere at 90° C. for 9 hours to obtain particles. The particles obtained were washed with hot water several times and then classified to obtain a base material particle S7 having a particle diameter of 35.0 μm.

A metal-containing particle was obtained by forming a metal section in the same manner as in Example 42 except that the base particle S1 was changed to the base particle S7.

### Example 57

A base particle S8, which was different from the base particle S7 in Example 56 only in the particle diameter and had a particle diameter of 50.0 μm, was prepared. A metal-containing particle was obtained by forming a metal section in the same manner as in Example 42 except that the base particle S7 was changed to the base particle S8.

### Example 58

The suspension (A1) of Example 42 was prepared.

A particle mixture (B17) containing the base particle S1 to which a core substance was attached was obtained by adding 1 part by weight of metal indium particle slurry (average particle diameter: 150 nm) to the suspension (A1) over 3 minutes.

The particle mixture (B17) was placed in a solution containing gold potassium cyanide at 2 g/L, sodium citrate at 10 g/L, ethylenediaminetetraacetic acid at 0.5 g/L, and sodium hydroxide at 5 g/L to obtain a particle mixture (C17).

In addition, as an electroless gold plating solution, a gold plating solution (D17) (pH 8.0) containing gold potassium cyanide at 20 g/L, sodium citrate at 20 g/L, thallium nitrate at 5 ppm, ethylenediaminetetraacetic acid at 7.0 g/L, sodium hydroxide at 20 g/L, and dimethylamine borane at 10 g/L was prepared.

Next, the gold plating solution (D17) was gradually dropped to the particle mixture (B17) at 60° C. in which a particle was dispersed to perform electroless gold plating. The electroless gold plating was performed at a dropping rate of the gold plating solution (D17) of 2 mL/min and a dropping time of 45 minutes. Thereafter, the particle was taken out by filtration, washed with water, and dried to obtain a metal-containing particle in which a gold metal section (the thickness of the entire metal sections at the portion not having protrusions: 0.1 μm) and protrusions were equipped on the surface of the base particle S1.

### Example 59

The suspension (A1) of Example 42 was prepared.

A particle mixture (B18) containing the base particle S1 to which a core substance was attached was obtained by adding 1 part by weight of alumina particle slurry (average particle diameter: 150 nm) to the suspension (A1) over 3 minutes.

The particle mixture (B18) was placed in a solution containing gold potassium cyanide at 2 g/L, sodium citrate at 10 g/L, ethylenediaminetetraacetic acid at 0.5 g/L, and sodium hydroxide at 5 g/L to obtain a particle mixture (C18).

In addition, as an electroless gold plating solution, a gold plating solution (D18) (pH 8.0) containing gold potassium cyanide at 10 g/L, sodium citrate at 20 g/L, thallium nitrate at 5 ppm, ethylenediaminetetraacetic acid at 3.0 g/L, sodium hydroxide at 20 g/L, and dimethylamine borane at 10 g/L was prepared.

In addition, as a tin solution, a tin plating solution (E18) was prepared by adjusting the pH of a mixture containing tin chloride at 20 g/L, nitrilotriacetic acid at 50 g/L, thiourea at 2 g/L, and ethylenediaminetetraacetic acid at 7.5 g/L to 7.0 with sulfuric acid.

Moreover, as a reducing solution for tine protrusion formation, a reducing solution (F18) was prepared by adjusting the pH of a mixture containing sodium borohydride at 10 g/L and sodium hydroxide at 5 g/L to 10.0.

The gold plating solution (D18) was gradually dropped to the particle mixture (C18) at 60° C. in which a particle was dispersed to perform electroless gold plating. The electroless gold plating was performed at a dropping rate of the gold plating solution (D18) of 2 mL/min and a dropping time of 45 minutes. A particle mixture (G18) containing a particle in which a gold metal section was disposed on the surface of the base particle S1 was thus obtained.

Thereafter, the particle was taken out by filtering the particle mixture (G18) and washed with water to obtain a particle in which a gold metal section was disposed on the surface of the base particle S1. This particle was thoroughly washed with water and then added to and dispersed in 500 parts by weight of distilled water to obtain a particle mixture (H18).

Next, the tin plating solution (E18) was gradually added to the particle mixture (H18) at 60° C. in which a particle was dispersed. Thereafter, a tin protrusion nucleus was formed by gradually dropping the reducing solution (F18) to the mixture, thereby obtaining a particle mixture (I18) containing a particle in which the tin protrusion nucleus was attached onto the gold metal section.

Thereafter, the particle was taken out by filtering the particle mixture (I18) and washed with water to obtain a particle in which a gold metal section was disposed on the surface of the base particle S1 and tin protrusions were formed. This particle was thoroughly washed with water and then added to and dispersed in 500 parts by weight of distilled water to obtain a particle mixture (J18).

Next, the gold plating solution (D18) was gradually dropped to the particle mixture (J18) at 60° C. in which a particle was dispersed to perform electroless gold plating. The electroless gold plating was performed at a dropping rate of the gold plating solution (D18) of 1 mL/min and a dropping time of 10 minutes. Thereafter, the particle was taken out by filtration, washed with water, and dried to obtain a metal-containing particle in which a gold metal section (the thickness of the entire metal sections at the portion not having protrusions: 0.1 μm) and protrusions were equipped on the surface of the base particle S1.

### Example 60

A titanium oxide particle slurry (average particle diameter: 150 nm) was prepared.

A metal-containing particle was obtained by forming a metal section in the same manner as in Example 59 except that the alumina particle slurry was changed to a titanium oxide particle slurry.

### Example 61

A metal nickel particle slurry (average particle diameter: 150 nm) was prepared.

A metal-containing particle was obtained by forming a metal section in the same manner as in Example 59 except that the alumina particle slurry was changed to a metal nickel particle slurry.

### Example 62

A 1,000 mL separable flask equipped with a four-neck separable cover, a stirrer, a three-way cock, a condenser, and a temperature probe was prepared. A monomer composition containing 100 mmol of methyl methacrylate, 1 mmol of N,N,N-trimethyl-N-2-methacryloyloxyethylammonium chloride, and 1 mmol of 2,2′-azobis(2-amidinopropane) dihydrochloride was weighed and placed in ion-exchanged water in the separable flask so as to have a solid content of 5% by weight. Thereafter, the mixture was stirred at 200 rpm, and polymerization was performed at 70° C. for 24 hours in a nitrogen atmosphere. After completion of the reaction, the resultant was freeze-dried to obtain insulating particles having an ammonium group on the surface, an average particle diameter of 220 nm, and a CV value of 10%.

The insulating particles were dispersed in ion-exchanged water under ultrasonic irradiation to obtain a 10% by weight aqueous dispersion of insulating particles.

In 500 mL of ion-exchanged water, 10 g of the conductive particles obtained in Example 42 was dispersed, 4 g of the aqueous dispersion of insulating particle was added thereto, and the mixture was stirred at room temperature for 6 hours. After filtration through a 3 μm mesh filter, the resultant was further washed with methanol and dried to obtain a conductive particle to which an insulating particle was attached.

As a result of observation under a scanning electron microscope (SEM), only one covering layer composed of an insulating particle was formed on the surface of the conductive particle. The coverage factor was 30% when the area covered with the insulating particle (namely, the projected area of the particle diameter of insulating particle) with respect to the area of the portion from the center of the conductive particle to 2.5 μm was calculated by image analysis.

### Comparative Example 3

The base particle S1 of Example 42 was prepared.

In 100 parts by weight of an alkaline solution containing a palladium catalyst solution at 5% by weight, 10 parts by weight of the base particle S1 was dispersed using an ultrasonic disperser, and then the solution was filtered to take out the base particle S1. Subsequently, the base particle S1 was added to 100 parts by weight of a 1% by weight solution of dimethylamine borane to activate the surface of the base particle S1. The surface-activated base particle S1 was thoroughly washed with water and then added to and dispersed in 500 parts by weight of distilled water to obtain a suspension (al).

The suspension (al) was placed in a solution containing nickel sulfate at 50 g/L, thallium nitrate at 30 ppm, and bismuth nitrate at 20 ppm to obtain a particle mixture (b1).

In addition, a nickel plating solution (c1) (pH 6.5) containing nickel sulfate at 200 g/L, sodium hypophosphite at 85 g/L, sodium citrate at 30 g/L, thallium nitrate at 50 ppm, and bismuth nitrate at 20 ppm was prepared.

The nickel plating solution (c1) was gradually dropped to the particle mixture (b1) at 50° C. in which a particle was dispersed to perform electroless nickel plating. The electroless nickel plating was performed at a dropping rate of the nickel plating solution (c1) of 25 mL/min and a dropping time of 60 minutes (Ni plating step). Thereafter, the particle was taken out by filtration, washed with water, and dried to obtain a metal-containing particle (the thickness of the entire metal section: 0.1 μm) in which a nickel-phosphorus alloy metal section was disposed on the surface of the base particle S1 and a metal section was equipped.

### Comparative Example 4

A particle mixture (b2) containing the base particle S1 to which a core substance was attached was obtained by adding 1 g of metal nickel particle slurry (“2020SUS” manufactured by Mitsui Mining & Smelting Co., Ltd., average particle diameter: 150 nm) to the suspension (al) the same as that in Comparative Example 1 over 3 minutes.

The suspension (b2) was placed in a solution containing nickel sulfate at 50 g/L, thallium nitrate at 30 ppm, and bismuth nitrate at 20 ppm to obtain a particle mixture (c2).

In addition, a nickel plating solution (d2) (pH 6.5) containing nickel sulfate at 200 g/L, sodium hypophosphite at 85 g/L, sodium citrate at 30 g/L, thallium nitrate at 50 ppm, and bismuth nitrate at 20 ppm was prepared.

The nickel plating solution (d2) was gradually dropped to the particle mixture (c2) at 50° C. in which a particle was dispersed to perform electroless nickel plating. The electroless nickel plating was performed at a dropping rate of the electroless nickel plating solution (d2) of 25 mL/min and a dropping time of 60 minutes (Ni plating step). Thereafter, the particle was taken out by filtration, washed with water, and dried to obtain a metal-containing particle (the thickness of the entire metal sections at the portion not having protrusions: 0.1 μm) in which a nickel-phosphorus alloy metal section was disposed on the surface of the base particle S1 and a metal section having protrusions on the metal section was equipped on the surface.

### Evaluation

Examples 42 to 62 and Comparative Examples 3 and 4 were subjected to the following evaluations.

(1) Measurement of Average Height of Protrusion

The metal-containing particles obtained were added to and dispersed in “Technovit 4000” manufactured by Kulzer BmbH so as to have a content of 30% by weight, thereby fabricating an embedded resin body for metal-containing particle inspection. The cross section of the metal-containing particle was cut out so as to pass near the center of the metal-containing particle dispersed in the embedded resin for inspection using an ion milling apparatus (“IM 4000” manufactured by Hitachi High-Technologies Corporation).

Thereafter, using a field emission transmission electron microscope (FE-TEM) (“JEM-ARM200F” manufactured by JEOL Ltd.), the image magnification was set to 50,000-fold, 20 metal-containing particles were randomly selected, and the protrusions in each metal-containing particle were observed. The heights of the protrusions in the metal-containing particles obtained were measured, and the values measured were arithmetically averaged to take as the average height (a) of the protrusions.

(2) Measurement of Average Diameter of Base of Protrusion

The metal-containing particles obtained were added to and dispersed in “Technovit 4000” manufactured by Kulzer BmbH so as to have a content of 30% by weight, thereby fabricating an embedded resin body for metal-containing particle inspection. The cross section of the metal-containing particle was cut out so as to pass near the center of the metal-containing particle dispersed in the embedded resin for inspection using an ion milling apparatus (“IM 4000” manufactured by Hitachi High-Technologies Corporation).

Thereafter, using a field emission transmission electron microscope (FE-TEM) (“JEM-ARM200F” manufactured by JEOL Ltd.), the image magnification was set to 50,000-fold, 20 metal-containing particles were randomly selected, and the protrusions in each metal-containing particle were observed. The base diameters of the protrusions in the metal-containing particles obtained were measured, and the values measured were arithmetically averaged to take as the average diameter (b) of the bases of the protrusions.

(3) Measurement of Area Proportion Occupied by Protrusion Portion (Proportion of Surface Area of Portion Having Protrusion) with Respect to Area of Metal-Containing Particle

Using a field emission scanning electron microscope (FE-SEM), the image magnification was set to 6,000-fold, 20 metal-containing particles were randomly selected, and each metal-containing particle was photographed. Thereafter, FE-SEM photographs were analyzed by commercially available image analysis software.

After image processing such as flattening was performed, the area of the protrusion portion was determined, and the proportion of the surface area of the portion having protrusions in 100% of the entire surface area of the outer surface of the metal section was determined. The area occupied by protrusions with respect to the outer surface of the metal section was determined for the 20 metal-containing particles, and the average value thereof was adopted.

(4) Measurement of Thickness of Entire Metal Section

The metal-containing particles obtained were added to and dispersed in “Technovit 4000” manufactured by Kulzer BmbH so as to have a content of 30% by weight, thereby fabricating an embedded resin body for metal-containing particle inspection. The cross section of the metal-containing particle was cut out so as to pass near the center of the metal-containing particle dispersed in the embedded resin for inspection using an ion milling apparatus (“IM 4000” manufactured by Hitachi High-Technologies Corporation).

Thereafter, using a field emission transmission electron microscope (FE-TEM) (“JEM-ARM200F” manufactured by JEOL Ltd.), the image magnification was set to 50,000-fold, 20 metal-containing particles were randomly selected, and the metal sections in each metal-containing particle were observed. The thickness of the entire metal sections in the metal-containing particles obtained were measured, and the values measured were arithmetically averaged to take as the thickness of the metal section.

(5) Compressive Elastic Modulus of Metal-Containing Particle (10% K Value)

The compressive elastic modulus (10% K value) of the metal-containing particles obtained was measured under a condition of 23° C. by the method described above using a micro compression testing machine (“Fisher Scope H-100” manufactured by Helmut Fisher GmbH). The 10% K value was determined.

(6) Melt-Deformed and Solidified State of Protrusion of Metal Section in Connection Structure A

The metal-containing particles obtained were added to and dispersed in “STRUCT BOND XN-5A” manufactured by Mitsui Chemicals, Inc. so as to have a content of 10% by weight, thereby fabricating an anisotropic conductive paste.

A transparent glass substrate having a copper electrode pattern with L/S of 30 μm/30 μm on the upper surface was prepared. In addition, a semiconductor chip having a gold electrode pattern with L/S of 30 μm/30 μm on the lower surface was prepared.

The transparent glass substrate was coated with the anisotropic conductive paste immediately after being fabricated in a thickness of 30 μm to form an anisotropic conductive paste layer. Next, the semiconductor chip was layered on the anisotropic conductive paste layer so that the electrodes faced each other. Thereafter, while adjusting the temperature of the head so that the temperature of the anisotropic conductive paste layer was 250° C., a pressure heating head was put on the upper surface of the semiconductor chip, a pressure of 0.5 MPa was applied, and the anisotropic conductive paste layer was cured at 250° C. to obtain a connection structure A. In order to obtain the connection structure A, the electrodes were connected to each other at a low pressure of 0.5 MPa.

The connection structure A obtained was put into “Technovit 4000” manufactured by Kulzer BmbH and cured to fabricate an embedded resin body for connection structure inspection. The cross section of the metal-containing particle was cut out so as to pass near the center of connection structure in the embedded resin for inspection using an ion milling apparatus (“IM 4000” manufactured by Hitachi High-Technologies Corporation).

Thereafter, it was judged whether or not the protrusion of the metal section in the metal-containing particle was solidified after being melt-deformed by observing the cross section of the connection structure A obtained using a field emission scanning electron microscope (FE-SEM).

### [Criteria for Judging Melt-Deformed and Solidified State of Protrusion of Metal Section]

A: Protrusion of metal section is solidified after being melt-deformed

B: Protrusion of metal section is not solidified after being melt-deformed

(7) Bonded State of Protrusion of Metal Section in Connection Structure A

In the connection structure A obtained in the evaluation of (6), the bonded state of the protrusion of the metal section was judged by observing the cross section of the connection structure A.

### [Criteria for Judging Bonded State of Protrusion of Metal Section]

A: Protrusion of metal section in metal-containing particle is solidified after being melt-deformed and bonded to electrode and another metal-containing particle in connection section

B: Protrusion of metal section in metal-containing particle is not solidified after being melt-deformed and not bonded to electrode and another metal-containing particle in connection section

(8) Metal Diffusion State of Protrusion of Metal Section in Connection Structure A

In the connection structure A obtained in the evaluation of (6), the metal diffusion state of the protrusion of the metal section was judged by observing the cross section of the connection structure A.

The diffusion state of the protrusion of the metal section was observed by line analysis or elemental mapping of the contact portion between the metal-containing particle and the copper electrode pattern and gold electrode pattern using a field emission transmission electron microscope FE-TEM and an energy dispersive X-ray analyzer (EDS).

### [Criteria for Judging Diffusion State of Protrusion of Metal Section]

A: Protrusion of metal section in metal-containing particle is metal-diffused with copper electrode pattern and gold electrode pattern in connection section

B: Protrusion of metal section in metal-containing particle is not metal-diffused with copper electrode pattern and gold electrode pattern in connection section

(9) Connection Reliability in Connection Structure A

The connection resistances between the upper and lower electrodes in the 15 connection structures A obtained in the evaluation of (6) were measured by a four-terminal method. The average value of connection resistance was calculated. Incidentally, the connection resistance can be determined by measuring the voltage when a constant current flows from the relation of voltage=current×resistance. The connection reliability was judged according to the following criteria.

### [Criteria for Judging Connection Reliability]

∘∘∘: Connection resistance is 1.0Ω or less

∘∘: Connection resistance is more than 1.0Ω and 2.0Ω or less

∘: Connection resistance is more than 2.0Ω and 3.0Ω or less

Δ: Connection resistance is more than 3.0Ω and 5.0Ω or less

x: Connection resistance is more than 5.0 Ω

(10) Melt-Deformed and Solidified State of Protrusion of Metal Section in Connection Structure B

The metal-containing particles obtained were added to and dispersed in “ANP-1” (containing metal atom-containing particle) manufactured by Nihon Superior Co., Ltd. so as to have a content of 5% by weight, thereby fabricating a sintered silver paste.

As a first connection target member, a power semiconductor element in which the connection surface was plated with Ni/Au was prepared. As a second connection target member, an aluminum nitride substrate in which the connection surface was plated with Cu was prepared.

The second connection target member was coated with the sintered silver paste in a thickness of about 70 μm to form a silver paste layer for connection. Thereafter, the first connection target member was layered on the silver paste layer for connection to obtain a layered body.

The layered body obtained was preheated for 60 seconds on a hot plate at 130° C. Thereafter, a pressure of 10 MPa was applied to the layered body and the layered body was heated at 300° C. for 3 minutes to sinter the metal atom-containing particle contained in the sintered silver paste, a connection section containing a sintered product and a metal atom-containing particle was formed, and the first and second connection target members were bonded to each other via the sintered product to obtain a connection structure B.

The connection structure B obtained was put into “Technovit 4000” manufactured by Kulzer BmbH and cured to fabricate an embedded resin body for connection structure inspection. The cross section of the metal-containing particle was cut out so as to pass near the center of connection structure in the embedded resin for inspection using an ion milling apparatus (“IM 4000” manufactured by Hitachi High-Technologies Corporation).

Thereafter, it was judged whether or not the protrusion of the metal section in the metal-containing particle was solidified after being melt-deformed by observing the cross section of the connection structure B obtained using a field emission scanning electron microscope (FE-SEM).

### [Criteria for Judging Melt-Deformed and Solidified State of Protrusion of Metal Section]

A: Protrusion of metal section is solidified after being melt-deformed

B: Protrusion of metal section is not solidified after being melt-deformed

(11) Bonded State of Protrusion of Metal Section in Connection Structure B

In the connection structure B obtained in the evaluation of (10), the bonded state of the protrusion of the metal section was judged by observing the cross section of the connection structure B.

### [Criteria for Judging Bonded State of Protrusion of Metal Section]

A: Protrusion of metal section in metal-containing particle is solidified after being melt-deformed and bonded to electrode and another metal-containing particle in connection section

B: Protrusion of metal section in metal-containing particle is not solidified after being melt-deformed and not sbonded to electrode and another metal-containing particle in connection section

(12) Connection Reliability in Connection Structure B

The connection structure B obtained in the evaluation of (10) was put into a thermal shock testing machine (TSA-101S-W manufactured by ESPEC CORP.) and subjected to a 3,000 cycle test, in which treatment conditions of a retention time of 30 minutes at a minimum temperature of −40° C. and a retention time of 30 minutes at a maximum temperature of 200° C. were taken as one cycle, and then the bonding strength was measured using a shear strength testing machine (STR-1000 manufactured by RHESCA CO., LTD.).

### [Criteria for Judging Connection Reliability]

∘∘∘: Bonding strength is 50 MPa or more

∘∘: Bonding strength is more than 40 MPa and 50 MPa or less

∘: Bonding strength is more than 30 MPa and 40 MPa or less

Δ: Bonding strength is more than 20 MPa and 30 MPa or less

x: Bonding strength is 20 MPa or less

(13) Flatness of Power Semiconductor Element in Connection Structure B

With regard to the flatness of the power semiconductor element in the connection structure B obtained in the evaluation of (10), the maximum displacement and the minimum displacement were measured using a high accuracy laser displacement meter (“LK-G5000” manufactured by KEYENCE CORPORATION). The flatness was determined from the measured values attained by the following equation.

Flatness (μm)=maximum displacement (μm)−minimum displacement (μm)

### [Criteria for Judging Flatness]

∘∘∘: Flatness is 0.5 μm or less

∘∘: Flatness is more than 0.5 μm and 1 μm or less

∘: Flatness is more than 1 μm and 5 μm or less

Δ: Flatness is more than 5 μm and 10 μm or less

x: Flatness is more than 10 μm

The details and the results are presented in Tables 11 to 13.

TABLE 11

| | | | | | Content of |
|---|---|---|---|---|---|
| | | | | | solder in |
| | | | | Content of | portion not |
| | Kind of metal | | | solder in | having |
| | First metal | Second metal | | protrusion | protrusion |
| | section | section | Kind of solder | (% by weight) | (% by weight) |
| Example 42 | Nickel-phosphorus | Gold | Gold-tin alloy | 75 | 12 |
| | alloy | | solder | | |
| Example 43 | Gold | — | Gold-tin alloy | 95 | 22 |
| | | | solder | | |
| Example 44 | Gold | — | Gold-tin alloy | 75 | 16 |
| | | | solder | | |
| Example 45 | Gold | Nickel-phosphorus | Gold-tin alloy | 55 | 8 |
| | | alloy | solder | | |
| Example 46 | Silver | — | Tin-silver alloy | 92 | 23 |
| | | | solder | | |
| Example 47 | Nickel-phosphorus | Silver | Tin-silver alloy | 72 | 10 |
| | alloy | | solder | | |
| Example 48 | Copper | — | Tin-copper alloy | 94 | 26 |
| | | | solder | | |
| Example 49 | Nickel-phosphorus | Copper | Tin-copper alloy | 74 | 9 |
| | alloy | | solder | | |
| Example 50 | Nickel-phosphorus | Tin | Tin | 99 | 37 |
| | alloy | | | | |
| Example 51 | Nickel-phosphorus | Gold | Gold-tin alloy | 75 | 12 |
| | alloy | | solder | | |
| Example 52 | Nickel-phosphorus | Gold | Gold-tin alloy | 75 | 12 |
| | alloy | | solder | | |
| Example 53 | Nickel-phosphorus | Gold | Gold-tin alloy | 75 | 12 |
| | alloy | | solder | | |
| Example 54 | Nickel-phosphorus | Gold | Gold-tin alloy | 75 | 12 |
| | alloy | | solder | | |
| Example 55 | Nickel-phosphorus | Gold | Gold-tin alloy | 75 | 12 |
| | alloy | | solder | | |
| Example 56 | Nickel-phosphorus | Gold | Gold-tin alloy | 75 | 12 |
| | alloy | | solder | | |
| Example 57 | Nickel-phosphorus | Gold | Gold-tin alloy | 75 | 12 |
| | alloy | | solder | | |
| Example 58 | Gold | — | Gold-indium alloy | 71 | 12 |
| | | | solder | | |
| Example 59 | Gold | — | Gold-tin alloy | 95 | 28 |
| | | | solder | | |
| Example 60 | Gold | — | Gold-tin alloy | 95 | 28 |
| | | | solder | | |
| Example 61 | Gold | — | Gold-tin alloy | 95 | 28 |
| | | | solder | | |
| Example 62 | Nickel-phosphorus | Gold | Gold-tin alloy | 75 | 12 |
| | alloy | | solder | | |
| Comparative | Nickel-phosphorus | — | — | — | — |
| Example 3 | alloy | | | | |
| Comparative | Nickel-phosphorus | — | — | — | — |
| Example 4 | alloy | | | | |

TABLE 12

| | | Particle | 10% K value | | | | Average | |
|---|---|---|---|---|---|---|---|---|
| | | diameter of | of metal- | Presence or | Proportion of | Average height | diameter (b) | Ratio (average |
| | | metal-containing | containing | absence of | surface area of | (a) of | of base of | height |
| | Kind of base | particle | particle | insulating | portion having | protrusion | protrusion | (a)/average |
| | particle | (μm) | (N/mm²) | particle | protrusion (%) | (nm) | (nm) | diameter (b)) |
| Example 42 | S1 | 3.3 | 5250 | Absence | 65 | 81 | 95 | 0.85 |
| Example 43 | S1 | 3.3 | 4800 | Absence | 64 | 83 | 98 | 0.85 |
| Example 44 | S1 | 3.3 | 4850 | Absence | 42 | 86 | 132 | 0.65 |
| Example 45 | S1 | 3.3 | 5050 | Absence | 65 | 82 | 93 | 0.88 |
| Example 46 | S1 | 3.3 | 4800 | Absence | 66 | 82 | 96 | 0.85 |
| Example 47 | S1 | 3.3 | 5300 | Absence | 65 | 83 | 95 | 0.87 |
| Example 48 | S1 | 3.3 | 4700 | Absence | 64 | 81 | 93 | 0.87 |
| Example 49 | S1 | 3.3 | 5350 | Absence | 66 | 81 | 94 | 0.86 |
| Example 50 | S1 | 3.3 | 5150 | Absence | 68 | 80 | 94 | 0.85 |
| Example 51 | S2 | 3.3 | 135 | Absence | 65 | 81 | 95 | 0.85 |
| Example 52 | S3 | 3.3 | 120 | Absence | 65 | 81 | 95 | 0.85 |
| Example 53 | S4 | 2.3 | 5900 | Absence | 65 | 81 | 95 | 0.85 |
| Example 54 | S5 | 10.3 | 4100 | Absence | 65 | 81 | 95 | 0.85 |
| Example 55 | S6 | 35.3 | 3480 | Absence | 65 | 81 | 95 | 0.85 |
| Example 56 | S7 | 35.3 | 2200 | Absence | 64 | 81 | 95 | 0.85 |
| Example 57 | S8 | 50.2 | 3900 | Absence | 65 | 81 | 95 | 0.85 |
| Example 58 | S1 | 3.3 | 4680 | Absence | 38 | 82 | 128 | 0.64 |
| Example 59 | S1 | 3.3 | 4920 | Absence | 69 | 84 | 98 | 0.86 |
| Example 60 | S1 | 3.3 | 4960 | Absence | 71 | 85 | 98 | 0.87 |
| Example 61 | S1 | 3.3 | 4770 | Absence | 66 | 81 | 98 | 0.83 |
| Example 62 | S1 | 3.3 | 5250 | Presence | 65 | 81 | 95 | 0.85 |
| Comparative | S1 | 3.3 | 7900 | Absence | — | — | — | — |
| Example 3 | | | | | | | | |
| Comparative | S1 | 3.3 | 8000 | Absence | 42 | 120 | 156 | 0.77 |
| Example 4 | | | | | | | | |

TABLE 13

| | Connection structure A | | | | Connection structure B | | | |
|---|---|---|---|---|---|---|---|---|
| | Melt- | | | | Melt- | | | |
| | deformed | | | | deformed | | | |
| | and | | Metal- | | and | | | |
| | solidified | Bonded | diffusion | Connection | solidified | Bonded | Connection | |
| | state | state | state | reliability | state | state | reliability | Flatness |
| Example 42 | A | A | A | ∘∘ | A | A | ∘∘ | ∘ |
| Example 43 | A | A | A | ∘∘∘ | A | A | ∘∘∘ | ∘ |
| Example 44 | A | A | A | ∘∘∘ | A | A | ∘∘∘ | ∘ |
| Example 45 | A | A | A | ∘ | A | A | ∘ | ∘ |
| Example 46 | A | A | A | ∘∘∘ | A | A | ∘∘∘ | ∘ |
| Example 47 | A | A | A | ∘∘ | A | A | ∘∘ | ∘ |
| Example 48 | A | A | A | ∘∘ | A | A | ∘∘ | ∘ |
| Example 49 | A | A | A | ∘ | A | A | ∘ | ∘ |
| Example 50 | A | A | A | ∘∘∘ | A | A | ∘∘∘ | ∘ |
| Example 51 | A | A | A | ∘∘ | A | A | ∘∘ | ∘ |
| Example 52 | A | A | A | ∘∘ | A | A | ∘∘ | ∘ |
| Example 53 | A | A | A | ∘∘ | A | A | ∘∘ | Δ |
| Example 54 | A | A | A | ∘∘ | A | A | ∘ | ∘∘ |
| Example 55 | A | A | A | ∘∘ | A | A | ∘ | ∘∘ |
| Example 56 | A | A | A | ∘∘ | A | A | ∘ | ∘∘∘ |
| Example 57 | A | A | A | ∘∘ | A | A | ∘ | ∘∘∘ |
| Example 58 | A | A | A | ∘∘∘ | A | A | ∘∘∘ | ∘ |
| Example 59 | A | A | A | ∘∘∘ | A | A | ∘∘∘ | ∘ |
| Example 60 | A | A | A | ∘∘∘ | A | A | ∘∘∘ | ∘ |
| Example 61 | A | A | A | ∘∘ | A | A | ∘∘∘ | ∘ |
| Example 62 | A | A | A | ∘ | A | A | ∘ | ∘ |
| Comparative | B | B | B | x | B | B | x | x |
| Example 3 | | | | | | | | |
| Comparative | B | B | B | Δ | B | B | x | x |
| Example 4 | | | | | | | | |

Incidentally, the spherical shape of the protrusion includes a shape of a part of a sphere. Incidentally, in Comparative Example 4, it has been confirmed that the components of protrusion do not undergo metal diffusion and the protrusion is not melt-deformed even when being heated to 400° C.

Incidentally, in the metal-containing particles of Examples 42 to 62 in which a metal section containing solder was formed, the solder and the materials of the electrodes were alloyed and the portion in contact with the electrode of the metal atom-containing particle contained a solder alloy in the connection structures.

### EXPLANATION OF SYMBOLS

1, 1A, 1B, 10, 1D, 1E, 1F, 1G: Metal-containing particle
1a, 1Aa, 1Ba, 1Ca, 1Da, 1Ea, 1Fa, 1Ga: Protrusion
2: Base particle
3, 3A, 3B, 3C, 3D, 3E, 3F, 3G: Metal section (metal
layer)
3a, 3Aa, 3Ba, 3Ca, 3Da, 3Ea, 3Fa, 3Ga: Protrusion
3BX: Metal particle
3CA, 3GA: First metal section
3CB, 3GB: Second metal section
3Da, 3Ea, 3Fa, 3Ga: Convex
3Db, 3Eb, 3Fb, 3Gb: Protrusion
4E: Core substance
5, 5A, 5B, 5C, 5D, 5E, 5F, 5G: Metal film
11, 11A, 11B, 11C, 11D, 11E: Metal-containing particle
11a, 11Aa, 11Ba, 11Ca, 11Da, 11Ea: Protrusion
13, 13A, 13B, 13C, 13D, 13E: Metal section (metal
layer)
13a, 13Aa, 13Ba, 13Ca, 13Da, 13Ea: Protrusion
13X, 13AX, 13BX, 13CX, 13DX, 13EX: First metal
section
13Y, 13AY, 13BY, 13CY, 13DY, 13EY: Second metal
section
13AZ, 13BZ: Third metal section
21: Conduction inspection member
22: Base body
22a: Through hole
23: Conductive section
31: BGA substrate
31A: Multilayer substrate
31B: Solder ball
32: Ammeter
41: Conduction inspection member
42: Base body
42a: Through hole
43: Conductive section
51: Connection structure
52: First connection target member
52a: First electrode
53: Second connection target member
53a: Second electrode
54: Connection section
61: Connection structure
62: First connection target member
63, 64: Second connection target member
65, 66: Connection section
67: Another metal-containing particle
68, 69: Heat sink

1. A metal-containing particle, an outer surface of which has a plurality of protrusions, the metal-containing particle comprising:
a base particle;
a metal section which is disposed on a surface of the base particle, an outer surface of the metal section having a plurality of protrusions; and
a metal film covering the outer surface of the metal section,
each of the protrusions in the metal-containing particle having a tip meltable at 400° C. or less.

2. The metal-containing particle according to claim 1, wherein the metal film covers the tips of the protrusions of the metal section.

3. The metal-containing particle according to claim 1, wherein a portion covering the tips of the protrusions of the metal section in the metal film is meltable at 400° C. or less.

4. The metal-containing particle according to claim 1, wherein a thickness of the metal film is 0.1 nm or more and 50 nm or less.

5. The metal-containing particle according to claim 1, wherein a material of the metal film contains gold, palladium, platinum, rhodium, ruthenium, or iridium.

6. The metal-containing particle according to claim 1, wherein
the outer surface of the metal-containing particle has a plurality of convexes, and
an outer surface of the convexes of the metal-containing particle has the protrusions.

7. The metal-containing particle according to claim 6, wherein a ratio of an average height of the convexes to an average height of the protrusions in the metal-containing particle is 5 or more and 1,000 or less.

8. The metal-containing particle according to claim 6, wherein an average diameter of bases of the convexes is 3 nm or more and 5,000 nm or less.

9. The metal-containing particle according to claim 6, wherein a proportion of a surface area of a portion having the plurality of convexes is 10% or more in 100% of a surface area of the outer surface of the metal-containing particle.

10. The metal-containing particle according to claim 6, wherein a shape of each of the plurality of convexes is a needle shape or a shape of a part of a sphere.

11. The metal-containing particle according to claim 1, wherein a material of the protrusions in the metal-containing particle contains silver, copper, gold, palladium, tin, indium, or zinc.

12. The metal-containing particle according to claim 1, wherein a material of the metal section is not solder.

13. A metal-containing particle comprising:
a base particle; and
a metal section disposed on a surface of the base particle,
an outer surface of the metal section having a plurality of protrusions,
the protrusions of the metal section containing a component capable of metal-diffusing at 400° C. or less or being melt-deformable at 400° C. or less, and
a portion not having the protrusions in the metal section having a melting point of more than 400° C.

14. The metal-containing particle according to claim 13, wherein the protrusions of the metal section contain a component capable of metal-diffusing at 400° C. or less.

15. The metal-containing particle according to claim 13, wherein the protrusions of the metal section are melt-deformable at 400° C. or less.

16. The metal-containing particle according to claim 13, wherein the protrusions of the metal section contain solder.

17. The metal-containing particle according to claim 16, wherein a content of solder in the protrusions of the metal section is 50% by weight or more.

18. The metal-containing particle according to claim 13, wherein a portion not having the protrusions in the metal section does not contain solder or contains solder at 40% by weight or less.

19. The metal-containing particle according to claim 13, wherein a surface area of a portion having the protrusions is 10% or more in 100% of an entire surface area of the outer surface of the metal section.

20. The metal-containing particle according to claim 1, wherein an average of vertical angles of the protrusions in the metal-containing particle is 10° or more and 60° or less.

21. The metal-containing particle according to claim 1, wherein an average height of the protrusions in the metal-containing particle is 3 nm or more and 5,000 nm or less.

22. The metal-containing particle according to claim 1, wherein an average diameter of bases of the plurality of protrusions in the metal-containing particle is 3 nm or more and 1,000 nm or less.

23. The metal-containing particle according to claim 1, wherein a ratio of an average height of the protrusions in the metal-containing particle to an average diameter of bases of the protrusions in the metal-containing particle is 0.5 or more and 10 or less.

24. The metal-containing particle according to claim 1, wherein a shape of each of the protrusions in the metal-containing particle is a needle shape or a shape of a part of a sphere.

25. The metal-containing particle according to claim 1, wherein a material of the metal section contains silver, copper, gold, palladium, tin, indium, zinc, nickel, cobalt, iron, tungsten, molybdenum, ruthenium, platinum, rhodium, iridium, phosphorus, or boron.

26. The metal-containing particle according to claim 1, wherein a compressive elastic modulus is 100 N/mm² or more and 25,000 N/mm² or less when the metal-containing particle is compressed by 10%.

27. A connection material comprising:
the metal-containing particle according to claim 1; and a resin.

28. A connection structure comprising:
a first connection target member;
a second connection target member; and
a connection section connecting the first connection target member and the second connection target member to each other,
a material of the connection section being the metal-containing particle according to claim 1 or a connection material containing the metal-containing particle and a resin.

29. A method for manufacturing a connection structure, the method comprising:
a step of disposing the metal-containing particle according to claim 1 or a connection material containing the metal-containing particle and a resin between a first connection target member and a second connection target member; and
a step of heating the metal-containing particle to melt the tips of the protrusions of the metal section, solidifying the melt after melting, and forming a connection section connecting the first connection target member and the second connection target member to each other through the metal-containing particle or the connection material or a step of heating the metal-containing particle to metal-diffuse or melt-deform a component of the protrusions of the metal section and forming a connection section connecting the first connection target member and the second connection target member to each other through the metal-containing particle or the connection material.

30. A conduction inspection member comprising:
a base body having a through hole; and a conductive section,
a plurality of the through holes being disposed in the base body,
the conductive section being disposed in the through holes, and
the conductive section formed of a material containing the metal-containing particle according to claim 1.

31. A conduction inspection device comprising:
an ammeter; and
the conduction inspection member according to claim 30.
